(19) United States
(12) Patent Application Publication
(10) Pub. No.: US 2017/0038763 A1
(43) Pub. Date: Feb. 9, 2017

(54) Instant Message Based Event Driven Motion Systems

(71) Applicant: Automation Middleware Solutions, Inc., Marshall, TX (US)

(72) Inventors: David W. Brown, Bingen, WA (US); Jay S. Clark, Bingen, WA (US)

(21) Appl. No.: 15/332,791

(22) Filed: Oct. 24, 2016

Related U.S. Application Data
(63) Continuation of application No. 14/595,108, filed on Jan. 12, 2015.
Application No. 14/595,108 is a continuation of application No. 13/651,446, filed on Oct. 14, 2012, now abandoned.
Application No. 13/651,446 is a continuation of application No. 12/546,566, filed on Aug. 24, 2009, now abandoned.
Application No. 12/546,566 is a continuation of application No. 11/370,082, filed on Mar. 6, 2006, now abandoned.
Application No. 11/370,082 is a continuation-in-part of application No. 11/102,018, filed on Apr. 9, 2005, now Pat. No. 7,113,833.
Application No. 11/102,018 is a continuation of application No. 09/796,566, filed on Feb. 28, 2001, now Pat. No. 6,879,862.
Application No. 11/370,082 is a continuation-in-part of application No. 10/923,149, filed on Aug. 19, 2004, now Pat. No. 7,024,255.
Application No. 10/923,149 is a continuation of application No. 10/151,807, filed on May 20, 2002, now Pat. No. 6,885,898.
Application No. 11/370,082 is a continuation-in-part of application No. 10/409,393, filed on Apr. 7, 2003, now abandoned.
Application No. 11/370,082 is a continuation-in-part of application No. 10/405,883, filed on Apr. 1, 2003, now Pat. No. 8,032,605.
Application No. 10/405,883 is a continuation of application No. 09/790,401, filed on Feb. 21, 2001, now Pat. No. 6,542,925.
Application No. 09/790,401 is a continuation-in-part of application No. 09/699,132, filed on Oct. 27, 2000, now Pat. No. 6,480,896.
(60) Provisional application No. 60/185,570, filed on Feb. 28, 2000.
(60) Provisional application No. 60/291,847, filed on May 18, 2001.
(60) Provisional application No. 60/292,082, filed on May 18, 2001.
(60) Provisional application No. 60/292,083, filed on May 18, 2001.
(60) Provisional application No. 60/297,616, filed on Jun. 11, 2001.
(60) Provisional application No. 60/370,511, filed on Apr. 5, 2002.
(60) Provisional application No. 60/184,067, filed on Feb. 22, 2000.
(60) Provisional application No. 60/185,557, filed on Feb. 28, 2000.
(60) Provisional application No. 60/161,901, filed on Oct. 27, 1999.
(60) Provisional application No. 60/162,801, filed on Nov. 1, 1999.
(60) Provisional application No. 60/162,802, filed on Nov. 1, 1999.
(60) Provisional application No. 60/162,989, filed on Nov. 1, 1999.
(60) Provisional application No. 60/182,864, filed on Feb. 16, 2000.
(60) Provisional application No. 60/185,192, filed on Feb. 25, 2000.

(51) Int. Cl. G05B 19/409; G05B 17/02; G05B 19/042; G10L 15/26; G10L 15/30

(52) U.S. Cl. CPC G05B 19/409; G10L 15/26; G10L 15/30; G05B 19/042; G05B 17/02; G10L 2015/223

(57) ABSTRACT

A motion system for allowing a person to cause a desired motion operation to be performed, comprising a network, a motion machine, a speech to text converter, a message protocol generator, an instant message receiver, and a motion services system. The motion machine is capable of performing motion operations. The speech to text converter generates a digital representation of a spoken motion message spoken by the person. The message protocol generator generates a digital motion command based on the digital representation of the spoken motion message and causes the digital motion command to be transmitted over the network. The instant message receiver receives the digital motion command. The motion services system causes the motion machine to perform the desired motion operation based on the digital motion command received by the instant message receiver.

### RELATED APPLICATIONS

This application, (Attorney's Ref. No. P218956) is a continuation of U.S. patent application Ser. No. 14/595,108 filed Jan. 12, 2015, currently pending, which is a continuation of U.S. patent application Ser. No. 13/651,446 filed on Oct. 14, 2012, now abandoned, which is a continuation of U.S. patent application Ser. No. 12/546,566 filed on Aug. 24, 2009, now abandoned, which is a continuation of U.S. patent application Ser. No. 11/370,082 filed on Mar. 6, 2006, now abandoned, which is a continuation-in-part of U.S. patent application Ser. No. 11/102,018 filed on Apr. 9, 2005, now U.S. Pat. No. 7,113,833 which issued on Sep. 26, 2006, which is a continuation of U.S. patent application Ser. No. 09/796,566 filed on Feb. 28, 2001, now U.S. Pat. No. 6,879,862, which issued on Apr. 12, 2005, which claims priority of U.S. Provisional Patent Application Ser. No. 60/185,570 filed on Feb. 28, 2000, which is attached hereto as Exhibit 1.

U.S. patent application Ser. No. 11/370,082 is also a continuation-in-part of U.S. application Ser. No. 10/923,149 filed on Aug. 19, 2004, now U.S. Pat. No. 7,024,255 which issued on Apr. 4, 2006, which is a continuation of U.S. patent application Ser. No. 10/151,807 filed on May 20, 2002, now U.S. Pat. No. 6,885,898 which issued on Apr. 26, 2005, which claims priority of U.S. Provisional Patent Application Ser. No. 60/291,847 filed on May 18, 2001, which is attached hereto as Exhibit 2, 60/292,082 filed on May 18, 2001, which is attached hereto as Exhibit 3, 60/292,083 filed on May 18, 2001, which is attached hereto as Exhibit 4, and 60/297,616 filed on Jun. 11, 2001, which is attached hereto as Exhibit 5.

U.S. patent application Ser. No. 11/370,082 is also a continuation-in-part of U.S. patent application Ser. No. 10/409,393 filed on Apr. 7, 2003, now abandoned, which claims priority of U.S. Provisional Patent Application Ser. No. 60/370,511 filed on Apr. 5, 2002, which is attached hereto as Exhibit 6.

U.S. patent application Ser. No. 11/370,082 is also a continuation-in-part of U.S. patent application Ser. No. 10/405,883 filed on Apr. 1, 2003, now U.S. Pat. No. 8,032,605 which issued on Oct. 4, 2011, which is a continuation of U.S. patent application Ser. No. 09/790,401 filed on Feb. 21, 2001, now U.S. Pat. No. 6,542,925 which issued on Apr. 1, 2003, which claims priority of U.S. Provisional Patent Application Ser. No. 60/184,067 filed on Feb. 22, 2000, which is attached hereto as Exhibit 7, and 60/185,557 filed on Feb. 28, 2000, which is attached here to as Exhibit 8, and is a continuation-in-part of U.S. patent application Ser. No. 09/699,132 filed on Oct. 27, 2000, now U.S. Pat. No. 6,480,896 which issued on Nov. 12, 2002, which claims priority of U.S. Provisional Patent Application Ser. No. 60/161,901 filed on Oct. 27, 1999, which is attached hereto as Exhibit 9, 60/162,801 filed on Nov. 1, 1999, which is attached hereto as Exhibit 10, 60/162,802 filed on Nov. 1, 1999, which is attached hereto as Exhibit 11, 60/162,989 filed on Nov. 1, 1999, which is attached hereto as Exhibit 12, 60/182,864 filed on Feb. 16, 2000, which is attached hereto as Exhibit 13, and 60/185,192 filed on Feb. 25, 2000, which is attached hereto as Exhibit 14.

The contents of all related applications listed above are incorporated herein by reference.

### TECHNICAL FIELD

The present invention relates to motion systems and, more particularly, to systems and methods for causing motion based on remotely generated events.

### BACKGROUND

The present invention relates to motion systems that perform desired movements based on motion commands. A motion system comprises a motion control device capable of moving an object in a desired manner. The basic components of a motion control device are a controller and a mechanical system. The mechanical system translates signals generated by the controller into movement of an object.

While the mechanical system commonly comprises a drive and an electrical motor, a number of other systems, such as hydraulic or vibrational systems, can be used to cause movement of an object based on a control signal. Additionally, it is possible for a motion control device to comprise a plurality of drives and motors to allow multi-axis control of the movement of the object.

The present invention is of particular importance in the context of a target device or system including at least one drive and electrical motor having a rotating shaft connected in some way to the object to be moved, and that application will be described in detail herein. But the principles of the present invention are generally applicable to any target device or system that generates movement based on a control signal. The scope of the present invention should thus be determined based on the claims appended hereto and not the following detailed description.

In a mechanical system comprising a controller, a drive, and an electrical motor, the motor is physically connected to the object to be moved such that rotation of the motor shaft is translated into movement of the object. The drive is an electronic power amplifier adapted to provide power to a motor to rotate the motor shaft in a controlled manner. Based on control commands, the controller controls the drive in a predictable manner such that the object is moved in the desired manner.

These basic components are normally placed into a larger system to accomplish a specific task. For example, one controller may operate in conjunction with several drives and motors in a multi-axis system for moving a tool along a predetermined path relative to a workpiece.

Additionally, the basic components described above are often used in conjunction with a host computer or programmable logic controller (PLC). The host computer or PLC allows the use of a high-level programming language to generate control commands that are passed to the controller. Software running on the host computer is thus designed to simplify the task of programming the controller.

Companies that manufacture motion control devices are, traditionally, hardware oriented companies that manufacture software dedicated to the hardware that they manufacture. These software products may be referred to as low level programs. Low level programs usually work directly with the motion control command language specific to a given motion control device. While such low level programs offer the programmer substantially complete control over the hardware, these programs are highly hardware dependent.

In contrast to low-level programs, high-level software programs, referred to sometimes as factory automation applications, allow a factory system designer to develop application programs that combine large numbers of input/output (I/O) devices, including motion control devices, into a complex system used to automate a factory floor environment. These factory automation applications allow any number of I/O devices to be used in a given system, as long as these devices are supported by the high-level program. Custom applications, developed by other software developers, cannot be developed to take advantage of the simple motion control functionality offered by the factory automation program.

Additionally, these programs do not allow the programmer a great degree of control over the each motion control device in the system. Each program developed with a factory automation application must run within the context of that application.

In this overall context, a number of different individuals are involved with creating a motion control system dedicated to performing a particular task. Usually, these individuals have specialized backgrounds that enable them to perform a specific task in the overall process of creating a motion control system. The need thus exists for systems and methods that facilitate collaboration between individuals of disparate, complimentary backgrounds who are cooperating on the development of motion control systems.

Conventionally, the programming and customization of motion systems is very expensive and thus is limited to commercial industrial environments. However, the use of customizable motion systems may expand to the consumer level, and new systems and methods of distributing motion control software, referred to herein as motion media, are required.

Another example of a larger system incorporating motion components is a doll having sensors and motors configured to cause the doll to mimic human behaviors such as dancing, blinking, clapping, and the like. Such dolls are pre-programmed at the factory to move in response to stimulus such as sound, internal timers, heat, light, and touch. Programming such dolls requires knowledge of hardware dependent low-level programming languages and is also beyond the abilities of an average consumer.

### RELATED ART

A number of software programs currently exist for programming individual motion control devices or for aiding in the development of systems containing a number of motion control devices.

The following is a list of documents disclosing presently commercially available high-level software programs: (a) Software Products For Industrial Automation, iconics 1993; (b) The complete, computer-based automation tool (IGSS), Seven Technologies A/S; (c) OpenBatch Product Brief, PID, Inc.; (d) FIX Product Brochure, Intellution (1994); (e) Paragon TNT Product Brochure, Intec Controls Corp.; (f) WEB 3.0 Product Brochure, Trihedral Engineering Ltd. (1994); and (g) AIMAX-WIN Product Brochure, TA Engineering Co., Inc. The following documents disclose simulation software: (a) ExperTune PID Tuning Software, Gerry Engineering Software; and (b) XANALOG Model NL-SIM Product Brochure, XANALOG.

The following list identifies documents related to low-level programs: (a) Compumotor Digiplan 1993-94 catalog, pages 10-11; (b) Aerotech Motion Control Product Guide, pages 233-34; (c) PMAC Product Catalog, page 43; (d) PC/DSP-Series Motion Controller C Programming Guide, pages 1-3; (e) Oregon Micro Systems Product Guide, page 17; (f) Precision Microcontrol Product Guide.

The Applicants are also aware of a software model referred to as WOSA that has been defined by Microsoft for use in the Windows programming environment. The WOSA model is discussed in the book Inside Windows 95, on pages 348-351. WOSA is also discussed in the paper entitled WOSA Backgrounder: Delivering Enterprise Services to the Windows-based Desktop. The WOSA model isolates application programmers from the complexities of programming to different service providers by providing an API layer that is independent of an underlying hardware or service and an SPI layer that is hardware independent but service dependent. The WOSA model has no relation to motion control devices.

The Applicants are also aware of the common programming practice in which drivers are provided for hardware such as printers or the like; an application program such as a word processor allows a user to select a driver associated with a given printer to allow the application program to print on that given printer.

While this approach does isolates the application programmer from the complexities of programming to each hardware configuration in existence, this approach does not provide the application programmer with the ability to control the hardware in base incremental steps. In the printer example, an application programmer will not be able to control each stepper motor in the printer using the provided printer driver; instead, the printer driver will control a number of stepper motors in the printer in a predetermined sequence as necessary to implement a group of high level commands.

The software driver model currently used for printers and the like is thus not applicable to the development of a sequence of control commands for motion control devices.

The Applicants are additionally aware of application programming interface security schemes that are used in general programming to limit access by high-level programmers to certain programming variables. For example, Microsoft Corporation's Win32 programming environment implements such a security scheme. To the Applicants' knowledge, however, no such security scheme has ever been employed in programming systems designed to generate software for use in motion control systems.

The Applicant is aware of programmable toys such as the Mindstorms® robotics system produced by The LEGO Group. Such systems simplify the process of programming motion systems such that children can design and build simple robots, but provide the user with only rudimentary control over the selection and control of motion data for operating the robot.

### SUMMARY

The present invention may be embodied as a motion system for allowing a person to cause a desired motion operation to be performed, comprising a network, a motion machine, a speech to text converter, a message protocol generator, an instant message receiver, and a motion services system. The motion machine is capable of performing motion operations. The speech to text converter generates a digital representation of a spoken motion message spoken by the person. The message protocol generator generates a digital motion command based on the digital representation of the spoken motion message and causes the digital motion command to be transmitted over the network. The instant message receiver receives the digital motion command. The motion services system causes the motion machine to perform the desired motion operation based on the digital motion command received by the instant message receiver.

The present invention may also be embodied as a method of allowing a person to cause a desired motion operation to be performed, comprising the following steps. A digital representation of a spoken motion message spoken by the person is generated. A digital motion command is generated based on the digital representation of the spoken motion message. The digital motion command is transmitted over a network. The digital motion command is received over the network. A motion machine is caused to perform the desired motion operation based on the digital motion command.

### BRIEF DESCRIPTION THE DRAWING

FIG. 1 is a scenario map depicting the interaction of the modules of a first example of the present invention;

FIG. 2 is a scenario map depicting the interaction of the modules of a second example of the present invention;

FIG. 3 is a scenario map depicting the interaction of the modules of a third example of the present invention;

FIG. 4 is a scenario map depicting the interaction of the modules of a fourth example of the present invention;

FIG. 5 is a scenario map depicting the interaction of the modules of a fifth example of the present invention;

FIG. 6 is a scenario map depicting the interaction of the modules of a sixth example of the present invention;

FIG. 7 is a scenario map depicting the interaction of the modules of a seventh example of the present invention;

FIG. 8 is a scenario map depicting the interaction of the modules of an eighth example of the present invention;

FIG. 9 is a scenario map depicting the interaction of the modules of a ninth example of the present invention; and

FIG. 10 is a scenario map depicting the interaction of the modules of a tenth example of the present invention.

FIG. 11 is a scenario map depicting the interaction of the modules of an eleventh example of the present invention;

FIG. 12 is a scenario map depicting the interaction of the modules of a twelfth example of the present invention;

FIG. 13 is a scenario map depicting the interaction of the modules of a thirteenth example of the present invention;

FIG. 14 is a scenario map depicting the interaction of the modules of a fourteenth example of the present invention;

FIG. 15 is a scenario map depicting the interaction of the modules of a fifteenth example of the present invention;

FIG. 16 is a scenario map depicting the interaction of the modules of a sixteenth example of the present invention;

FIG. 17 is a scenario map depicting the interaction of the modules of a seventeenth example of the present invention;

FIG. 18 is a scenario map illustrating details of operation of a music-to-motion engine used by the motion system of FIG. 17;

FIG. 19 is a scenario map illustrating details of operation of a music-to-motion engine used by the motion system of FIG. 17;

FIG. 20 is a schematic block diagram depicting the construction and operation of a first sensor system that may be used with the present invention;

FIG. 21 is a schematic block diagram depicting the construction and operation of a second sensor system that may be used with the present invention;

FIG. 22 is a schematic block diagram depicting the construction and operation of a third sensor system that may be used with the present invention;

FIG. 23 is a scenario map depicting the operation of a sensor system of FIG. 22;

FIG. 24 is a schematic block diagram depicting the construction and operation of a fourth sensor system that may be used with the present invention;

FIG. 25 is a scenario map depicting the operation of a sensor system of FIG. 24;

FIG. 26 is a schematic block diagram depicting the construction and operation of a fifth sensor system that may be used with the present invention;

FIG. 27 is a scenario map depicting the operation of a sensor system of FIG. 26;

FIG. 28 is a schematic block diagram depicting the construction and operation of a sixth sensor system that may be used with the present invention;

FIG. 29 is a scenario map depicting the operation of a sensor system of FIG. 28;

FIG. 30 is a schematic block diagram depicting the construction and operation of a seventh sensor system that may be used with the present invention;

FIG. 31 is a schematic block diagram depicting the construction and operation of an eighth sensor system that may be used with the present invention;

FIG. 32 is a schematic block diagram depicting the construction and operation of a ninth sensor system that may be used with the present invention;

FIG. 33 is a scenario map depicting an example motion system of the present invention that allows the processing of automatic motion events;

FIG. 34 is a scenario map depicting the processing of manual motion events as performed by the example of the present invention depicted in FIG. 33;

FIG. 35 is a scenario map depicting an alternative configuration of the motion system depicted in FIG. 33, where the example motion system of FIG. 35 allows for the processing of manual motion events;

FIG. 36 is a scenario map depicting another example of a motion system that allows for the processing of manual motion events;

FIG. 37 is a scenario map depicting the processing of automatic motion events by the example motion system of FIG. 36;

FIG. 38 is a system interaction map of another example motion system of the present invention;

FIG. 39 is a block diagram depicting how the system of FIG. 36 may communicate with clients;

FIGS. 40-45 are module interaction maps depicting how the modules of the example motion control system as depicted in FIG. 36 interact under various scenarios;

FIGS. 46-49 are diagrams depicting separate exemplary implementations of the motion system depicted in FIG. 36;

FIG. 50 is a block diagram of yet another example motion system of the present invention;

FIG. 51 depicts a first example of a user interface that may be used by the control system depicted in FIG. 50;

FIG. 52 depicts a second example of a user interface that may be used by the control system depicted in FIG. 50;

FIG. 53 depicts a third example of a user interface that may be used by the control system depicted in FIG. 50;

FIG. 54 depicts a fourth example of a user interface that may be used by the control system depicted in FIG. 50;

FIG. 55 depicts a fifth example of a user interface that may be used by the control system depicted in FIG. 50;

FIG. 56 depicts a first example of an interface layout that may be used by the control system depicted in FIG. 50;

FIG. 57 depicts a second example of an interface layout that may be used by the control system depicted in FIG. 50;

FIG. 58 depicts a third example of an interface layout that may be used by the control system depicted in FIG. 50;

FIG. 59 depicts a fourth example of an interface layout that may be used by the control system depicted in FIG. 50;

FIG. 60 depicts a fifth example of an interface layout that may be used by the control system depicted in FIG. 50;

FIG. 61 depicts a sixth example of an interface layout that may be used by the control system depicted in FIG. 50;

FIG. 62 depicts a seventh example of an interface layout that may be used by the control system depicted in FIG. 50;

FIG. 63 depicts an eighth example of an interface layout that may be used by the control system depicted in FIG. 50;

FIG. 64 depicts a ninth example of an interface layout that may be used by the control system depicted in FIG. 50; and

FIG. 65 depicts a tenth example of an interface layout that may be used by the control system depicted in FIG. 50.

### DETAILED DESCRIPTION

The present invention may be embodied in many different forms and variations. The following discussion is arranged in sections, with each containing a description of a number of similar examples of the invention.

### Instant Messenger to Industrial Machine

This section describes a system used for and method of communicating with an Instant Messenger device or software to control, configure and monitor the physical motions that occur on an industrial machine such as a CNC machine or a General Motion machine. The reference characters used herein employ a number prefix and, some cases, a letter suffix. When used without a suffix in the following description or in the drawing, the reference character indicates a function that is implemented in all of the examples in association with which that number prefix is used. When appropriate, a suffix is used to indicate a minor variation associated with a particular example, and this minor variation will be discussed in the text.

In the present application, the term Instant Messenger (IM) refers to technology that uses a combination of hardware and software to allow a first device, such as a hand-held computing device, cell phone, personal computer or other device, to instantly send messages to another such device. For example, Microsoft's Messenger Service allows one user to send a text message to another across a network, where the message is sent and received immediately, network latency notwithstanding. Typically, the messages are sent using plain text messages, but other message formats may be used.

This section describes the use of the instant messaging technology to activate, control, configure, and query motion operations on an industrial machine (ie CNC or General Motion machine). More specifically, this section contains a first sub-section that describes how the instant messenger technology is used to interact with an industrial machine and a second subsection that describes how human speech can be used to interact with an industrial machine.

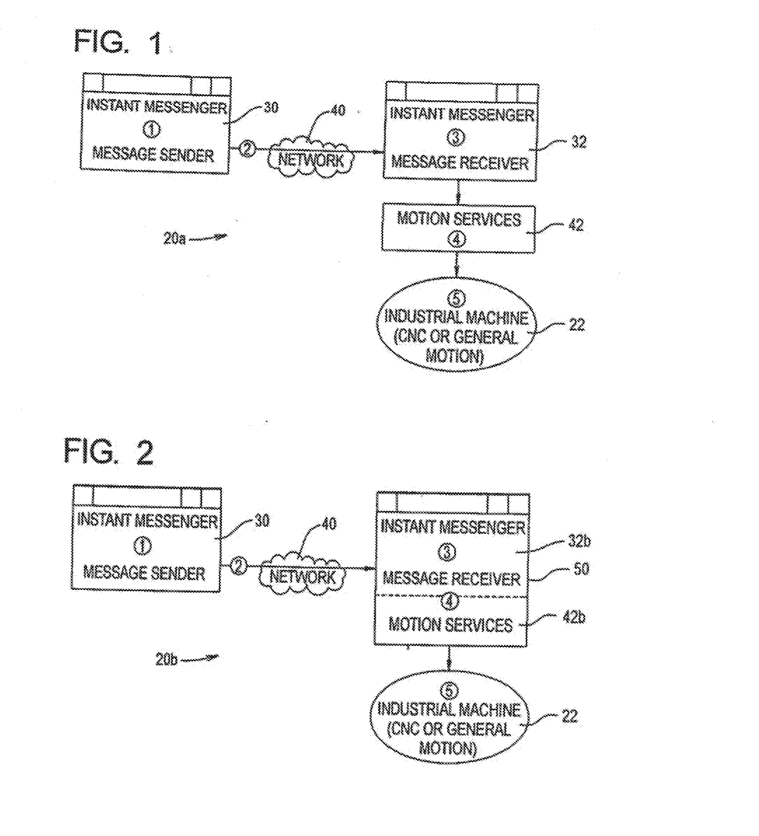

Referring now generally to FIGS. 1-6, depicted by reference character 20a-f therein are a number of motion systems that use instant messaging technology to control the actions of an industrial machine 22. Instant message interactions are typically created on a first or instant message enabled device 30 (the message sender) and are transmitted to second or other instant message enabled device 32 (the message receiver 32). IM messages are transmitted between the message sender 30 and the message receiver 32 using a network 40. In addition, the exemplary systems 20 also comprise a motion services module 42.

Referring initially to the format of the messages transmitted between the sender 30 and receiver 32, the message data is typically stored and transferred in ASCII text format, but other formats may be employed as well. For example, the message data may be in a binary format (such as raw voice data) or a formatted text format (such as XML), or a custom mix of binary and text data.

In any format, an IM message sent as described herein will typically include instructions and/or parameters corresponding to a desired motion operation or sequence of desired motion operations to be performed by the industrial machine 22. The term “desired motion operation” will thus be used herein to refer to both a single motion operation or to a plurality of such motion operations that combine to form a sequence of desired motion operations.

In addition or instead, the message may include instructions and/or parameters that change the configuration of the industrial machine 22 and/or query the industrial machine 22 to determine a current state of the toy or a portion thereof.

The message sender 30 can be an instant message enabled device such as a personal computer, a cell phone, a hand-held computing device, or a specific custom device, such as a game controller, having instant message technology built in. The message sender 30 is configured to operate using an instant messaging communication protocol compatible with that used by the message receiver 32.

The message receiver 32 is typically an instant message enabled device such as a personal computer, cell phone, hand-held computing device, or even a specific custom device, such as a toy or fantasy device, having instant message technology built into it.

The network 40 may be any Local Area (LAN) or Wide Area (WAN) network; examples of communications networks appropriate for use as the network 40 include an Ethernet based TCP/IP network, a wireless network, a fiber optic network, the Internet, an intranet, a custom proprietary network, or a combination of these networks. The network 40 may also be formed by a BlueTooth network or may be a direct connection such as an Infra-Red connection, Firewire connection, USB connection, RS232 connection, parallel connection, or the like.

The motion services module 42 maps the message to motion commands corresponding to the desired motion operation. To perform this function, the motion services module 42 may incorporate several different technologies.

First, the motion services module 42 preferably includes an event services module such as is described in U.S. patent application Ser. No. 10/074,577 filed on Feb. 11, 2002, and claiming priority of U.S. Provisional Application Ser. No. 60/267,645, filed on Feb. 9, 2001. The contents of the '577 application are incorporated herein by reference. The event services module described in the '577 application allows instructions and data contained in a message received by the message receiver 32 to be mapped to a set of motion commands appropriate for controlling the industrial machine 22.

Second, the motion services module 42 may be constructed to include a hardware-independent system for generating motion commands such as is as described in U.S. Pat. No. 5,691,897. A hardware independent motion services module can generate motion commands appropriate for a particular industrial machine 22 based on remote events generate without knowledge of the particular industrial machine 22. However, other technologies that support a single target machine 22 in a hardware dependent manner may be used to the implement the motion services module 42.

### Instant Message Interactions

Referring now to FIGS. 1-6 of the drawing, depicted therein are several exemplary motion systems constructed in accordance with, and embodying, the principles of the present invention.

IM to IM to Motion to Industrial Machine

Referring now to FIG. 1, depicted therein is a first exemplary motion system 20a of the present invention. The motion system 20a operates in a peer-to-peer manner; that is, the message sender 30 sends an instant message to the message receiver 32, which in turn uses the motion services module 42 to determine what (if any) motions to carry out on the target toy 32.

More specifically, a message is first entered into the IM message sender 30. Once the message is entered, the message sender 30 sends the message across the network 40 to the message receiver 32. After receiving the message, the IM message receiver 32 uses the motion services module 42 to determine what (if any) motions are to be run.

The motion services module 42 next directs the industrial machine 22 to run the set of motion commands. Typically, the set of motion commands sent by the motion services module 42 to the industrial machine 22 causes the industrial machine 22 to perform the desired motion operation or sequence of operations.

Further, as described above the motion commands generated by the motion services module may also change configuration settings of the industrial machine 22, or data stored at the industrial machine 22 may be queried to determine the current state of the industrial machine 22 or a portion thereof. If the motion commands query the industrial machine 22 for data indicative of status, the data is typically sent back to the message sender 30 through the motion services module 42, message receiver 32, and network 40.

IM to IM/Motion to Industrial Machine

Referring now to FIG. 2, depicted therein is a second motion system 20b of the present invention. The motion system 20b is similar to the motion system 20a described above. The primary difference between the systems 20a and 20b is that, in the system 20b, the functions of the motion services module 42b are built into the IM message receiver 32b. The combined message receiver 32b and motion services module 42b will be referred to as the receiver/motion module and identified by reference character 50.

The second motion system 20b operates basically as follows. First, a message is entered into the IM message sender 30. Once the message is entered, the message sender 30 sends the message across the network 40 to the message receiver 32b.

After receiving the message, the IM message receiver 32b uses the built-in motion services module 42b to determine what (if any) motions are to be run. The built-in motion services module 42b maps the message to the appropriate desired motion operation that is to take place on the industrial machine 22.

The motion services module 42b then directs the industrial machine 22 to run the motion commands associated with the desired motion operation. The industrial machine 22 then runs the motion commands, which allows the industrial machine 22 to “come to life” and perform the desired motion operation. In addition, configuration settings may be changed on the industrial machine 22 or data may be queried to determine the current state of the industrial machine 22 or a portion therein.

IM to IM to Industrial Machine

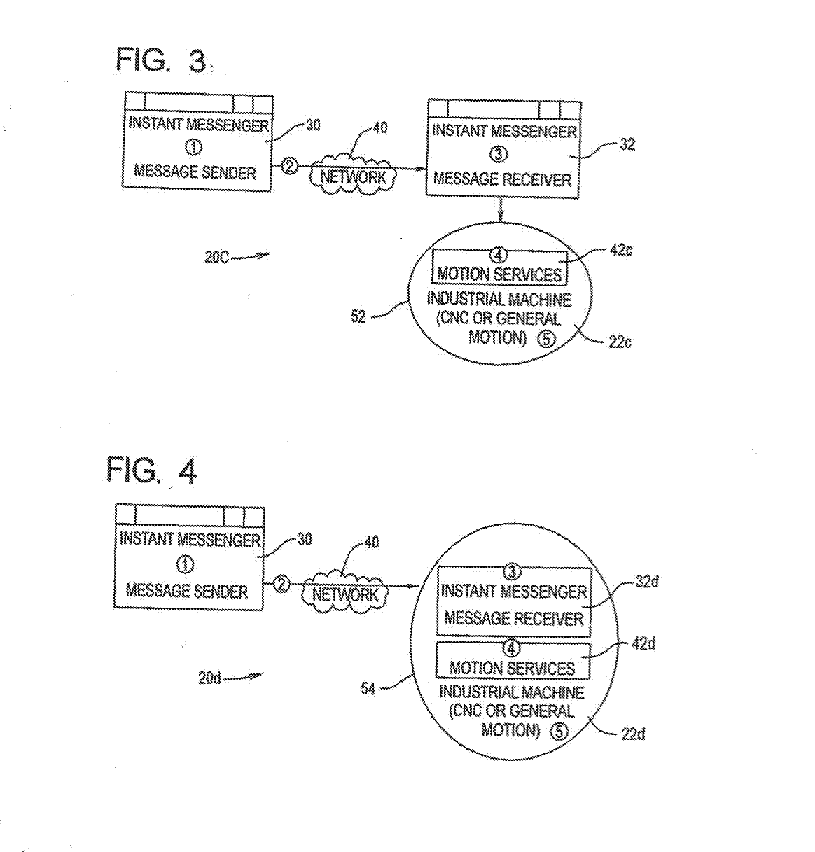

Referring now to FIG. 3, depicted therein is a third motion system 20c of the present invention. The motion system 20c is similar to the motion systems 20a and 20b described above. However, in the motion system 20c the motion services module 42c is built directly into the industrial machine 22c. The message receiver 32 receives messages and simply reflects or redirects them to the industrial machine 22c.

The industrial machine 22c, using the built-in motion services module 42c, directly processes and runs any messages that contain motion related instructions or messages that are associated with motions that the industrial machine 22c will later perform. The combination of the industrial machine 22c and the motion services module 42c will be referred to as a toy/motion module; the toy/motion module is identified by reference character 52 in FIG. 3.

In the system 20c, the following steps are performed. First, the message is entered in the IM message sender 30. Once the message is entered, the message sender 30 next sends the message across the network 40 to the message receiver 32.

After receiving the message, the IM message receiver 32 simply reflects or re-directs the message directly to the industrial machine 22c without processing the message. The communication between the IM message receiver 32 and the industrial machine 22c may occur over a network, a wireless link, a direct connection (i.e. Infra-red link, serial link, parallel link, or custom wiring), or even through sound where the industrial machine 22c recognizes the sound and translates the sound message.

Upon receiving the request, the industrial machine 22c first directs the message to the motion services module 42c, which in-turn attempts to map the message to the appropriate motion commands to the desired motion operation that is to be performed by the industrial machine 22c. The motion services module 42c then directs the industrial machine 22c to run motion commands, causing the industrial machine 22c to “come to life” and perform the desired motion operation.

Although the motion services module 42c is a part of the industrial machine 22c, the motion services module 42c need not be organized as a specific subsystem within the industrial machine 22c. Instead, the motion services module 42c may be integrally performed by the collection of software, firmware, and/or hardware used to cause the industrial machine 22c to move in a controlled manner. In addition, as described above, the control commands may simply change configuration settings on the industrial machine 22c or query data stored by the industrial machine 22c to determine the current state of the industrial machine 22c or a portion thereof.

### IM to Industrial Machine

### First Example

Referring now to FIG. 4, depicted therein is a fourth motion system 20d of the present invention. The motion system 20d is similar to the motion systems 20a, 20b, and 20c described above but comprises an advanced industrial machine 22d that directly supports an instant messenger communication protocol (i.e. a peer-to-peer communication).

In the motion system 20d, the IM message receiver 32d and the motion services module 42d are built directly into the industrial machine 22d. The industrial machine 22d, using the built-in message receiver 32d and motion services module 42d, directly receives, processes, and runs any messages that contain motion related instructions or messages that are associated with motions that the industrial machine 22d will later perform. The combination of the industrial machine 22d, the message receiver 32d, and the motion services module 42c will be referred to as the enhanced industrial machine module; the enhanced industrial machine module is identified by reference character 54 in FIG. 4.

In the motion system 20d, the following steps take place. First the message is entered into the IM message sender 30. Once the message is entered, the message sender 30 sends the message across the network 40 to the message receiver 32d. The communication to the industrial machine 22d may occur over any network, a wireless link, a direct connection (i.e. Infra-red link, serial link, parallel link, or custom wiring), or even through sound where the industrial machine 22 recognizes the sound and translates the sound message.

When receiving the message, the industrial machine 22d uses its internal instant message technology (i.e. software, firmware or hardware used to interpret instant messenger protocol) to interpret the message. In particular, the industrial machine 22d first uses the motion services module 42d to attempt to map the message to the appropriate motion command corresponding to the desired motion operation that is to be performed by the industrial machine 22d.

The motion services module 42 then directs the industrial machine 22d to run the motion command or commands, causing the industrial machine 22d to “come to life” and perform the desired motion operation.

The motion services module 42d is a part of the industrial machine 22d but need not be organized as a specific subsystem of the industrial machine 22d. Instead, the functions of the motion services module 42d may be performed by the collection of software, firmware and/or hardware used to run the motion commands (either pre-programmed or downloaded) on the industrial machine 22d. In addition, the control commands may change configuration settings on the industrial machine 22d or query data to determine the current state of the industrial machine 22d or a portion therein.

### IM to Industrial Machine

### Second Example

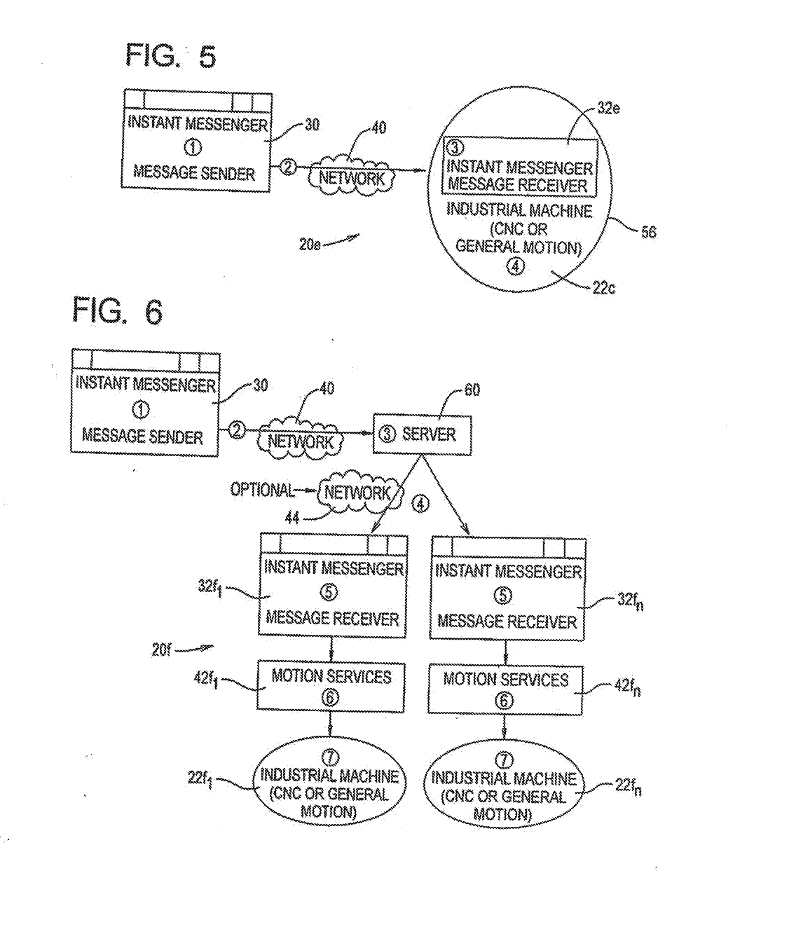

Referring now to FIG. 5, depicted therein is a fifth motion system 20e of the present invention. The motion system 20e is similar to the motion systems 20a, 20b, 20c, and 20d described above; however, in the motion system 20e the industrial machine 22e comprises instant message technology that causes the industrial machine 22e to perform non-motion functions. For example, instant message technology may be used to send messages to the industrial machine 22e that cause the industrial machine 22e to carry out other actions such as turning on/off a digital or analog input or output that causes a light to flash on the industrial machine 22 or a sound (or sounds) to be emitted by the industrial machine 22.

The motion system 20e thus comprises an advanced industrial machine 22e that directly supports an instant messenger communication protocol (i.e. a peer-to-peer communication). The motion system 20e contains a built-in IM message receiver 32e and does not include a motion services module. The industrial machine 22e, using the built-in message receiver 32e directly receives, processes, and responds to any messages that contain instructions or messages that are associated with non-motion actions to be performed by the industrial machine 22e. The combination of the industrial machine 22e and the message receiver 32e will be referred to as the non-motion industrial machine module; the non-motion industrial machine module is identified by reference character 56 in FIG. 4.

The motion system 20e performs the following steps. First, the message is entered into the IM message sender 30. Once the message is entered, the message sender 30 sends the message across the network 40 to the message receiver 32e. Again, the communication between message sender 30 and the industrial machine 22e may occur over any network, a wireless link, a direct connection (i.e. Infra-red link, serial link, parallel link, or custom wiring), or even through sound where the industrial machine 22e recognizes the sound and translates the sound message.

Upon receiving the message, the industrial machine 22e uses its internal instant message technology (i.e. software, firmware or hardware used to interpret instant messenger protocol) to interpret the message. Depending on the message contents, the industrial machine 22e performs some action such as turning on/off a digital or analog input or output or emitting a sounds or sounds. In addition, the configuration settings may be changed on the industrial machine 22e and/or data stored by the industrial machine 22e may be queried to determine the current state of the industrial machine 22e or a portion thereof.

IM to Server to IM to Industrial Machine

Depicted at 20f in FIG. 6 is yet another motion system of the present invention. The motion system 20f is similar to the motion systems 20a, 20b, 20c, 20d, and 20e described above; however, the motion system 20f comprises an IM message sender 30, a first network 40, an optional second network 44, and a server 60. The exemplary motion system 20f further comprises a plurality of toys 22f₁₋ₙ, a plurality of message receivers 32f₁₋ₙ, and a plurality of motion services modules 42f₁₋ₙ, where one of the receivers 32f and motion services modules 42f is associated with each of the toys 22f.

The first network 40 is connected to allow at least instant message communication between the IM message sender 30 and the server 60. The optional second network 44 is connected to allow data to be transferred between the server 60 and each of the plurality of receivers 32f.

The second network 44 may be an Ethernet TCP/IP network, the Internet, a wireless network, or a BlueTooth network or may be a direct connection such as an Infra-Red connection, Firewire connection, USB connection, RS232 connection, parallel connections, or the like. The second network 44 is optional in the sense that the receivers 32f may be connected to the server 60 through one or both of the first and second networks 40 and 44. In use, the message sender 30 sends a message to the server 60 which in turn routes or broadcasts the message to one or more of the IM message receivers 32f.

As shown in FIG. 6, the system 20f works in the following manner. First, a message is entered at the IM message sender 30. Once the message has been entered, the message sender 30 sends the message across the first network 40 to the server 60. The server 60 then routes or broadcasts the message to one or more of message receivers 32f.

After receiving the message, the server 60 routes or broadcasts the message to one or more instant messenger receivers 32f over the second network 44 if used. Upon receiving the request, each of the IM message receivers 32f uses the motion services module 42f associated therewith to determine how or whether the motion commands are to run on the associated industrial machine 22f.

The motion services modules 42f map the message to the motion commands required to cause the industrial machine 22f to perform the desired motion operation or sequence of operations. In addition, the motion commands may change the configuration settings on the industrial machine 22f or query data stored by the industrial machine 22f to determine the current state of the industrial machine 22f or a portion thereof.

The topologies of the second through fourth motion systems 20b, 20c, and 20d described above may be applied to the motion system 20f. In particular, the server 20f may be configured to operate in a system in which: (a) the motion services module 42f is built in to the message receiver 32f; (b) the motion services module 42f is built in to the industrial machine 22f, and the receiving messenger simply redirects the message to the industrial machine 22f; (c) the message receiver 32f is built in to the industrial machine 22f; (d) one or both of the message receiver 32f and motion services module 42f are built into the server 60; or (e) any combination of these topologies.

### Speech Interactions

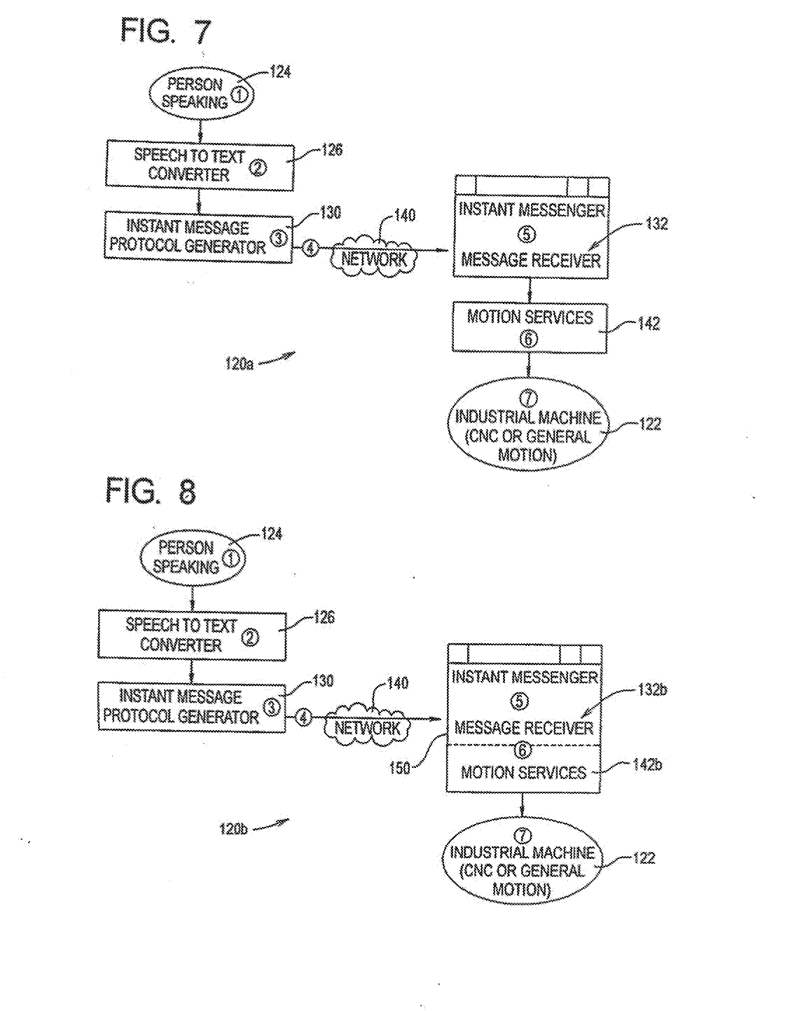

Referring now to FIGS. 7-10, depicted therein are a number of motion systems 120 in which human speech is used as a remote event that invokes actions on an industrial machine 122 using instant messenger technology as a conduit for the message. A number of possible implementations of the use of human speech as a remote event to cause motion will be discussed in the following subsections.

The motion systems 120 each comprise a person 124 as a source of spoken words, a speech-to-text converter (speech converter) 126, an IM message sender 130, an IM message receiver 132, a network 140, and a motion services module 142.

The message sender 130 and receiver 132 have capabilities similar to the message sender 30 and message receiver 32 described above. The IM message sender is preferably an instant message protocol generator formed by an instant messenger sender 30 or a hidden module that generates a text message based on the output of the speech converter 126 using the appropriate instant messenger protocol.

The network 140 and motion services module 142 are similar to the network 40 and motion services module 42 described above.

The speech converter 126 may be formed by any combination of hardware and software that allows speech sounds to be translated into a text message in one of the message formats described above. Speech converters of this type are conventional and will not be described herein in detail. One example of an appropriate speech converter is provided in the Microsoft Speech SDK 5.0 available from Microsoft Corporation.

Speech to IM to Motion to Industrial Machine

Referring now to FIG. 7, depicted therein is a motion system 120a of the present invention. The system 120a operates as follows.

First the person speaks a message. For example, the person may say ‘move left’. The speech converter 126 converts the spoken message into a digital representation (i.e. ASCII text, XML or some binary format) and sends the digital representation to the instant messenger protocol generator functioning as the message sender 130.

Next, the instant messenger protocol generator 130 takes the basic text message and converts it into instant messenger message using the appropriate protocol. The message is sent by the instant messenger protocol generator 130 across the network 140.

After receiving the message, the IM message receiver 132, uses the motion services module 142 to determine what (if any) motions are to be run. Upon receiving the request, the motion services module 142 maps the message to the appropriate motion command corresponding to the motion operation corresponding to the words spoken by the person 124. The motion services module 142 then directs the industrial machine 122 to run a selected motion operation or set of operations such that the industrial machine 122 “comes to life” and runs the desired motion operation (i.e., turn left). In addition, the motion commands may change the configuration settings on the industrial machine 122 or query data to determine the current state of the industrial machine 122 or a portion thereof.

### Speech to IM to Industrial Machine

### First Example

Depicted in FIG. 8 is another example of a motion system 120b that allows a speech-generated message to be sent to an IM message receiver 132b. The motion system 120b is similar to the motion system 120a described above. The primary difference between the systems 120a and 120b is that, in the system 120b, the functions of the motion services module 142b are built into the IM message receiver 132b. The combined message receiver 132b and motion services module 142b will be referred to as the receiver/motion module and is identified in the drawing by reference character 150.

The following steps take place when the motion system 120b operates.

First the person 124 speaks a message. For example, the person 124 may say ‘move left’. The speech-to-text converter 126 converts the spoken message into a digital representation of the spoken words and sends this digital representation to the instant messenger protocol generator 130.

Next, the instant messenger protocol generator 130 takes the basic text message and converts it into an IM message using the appropriate IM protocol. The message is sent by the instant messenger protocol generator 130 across the network 140 to the IM message receiver 132b.

After receiving the message, the IM message receiver 132b uses the built in motion services module 142b to determine what (if any) motion commands are to be run. The built-in motion services module 142b maps the message to the motion commands corresponding to the desired motion operation. The motion services module 142b then directs the industrial machine 122 to run the motion commands such that the industrial machine 122 comes to life and runs the desired motion operation (i.e., turn left). In addition, the motion commands may change the configuration settings on the industrial machine 122 or query data to determine the current state of the industrial machine 122 or a portion thereof.

### Speech to IM to Industrial Machine

### Second Example

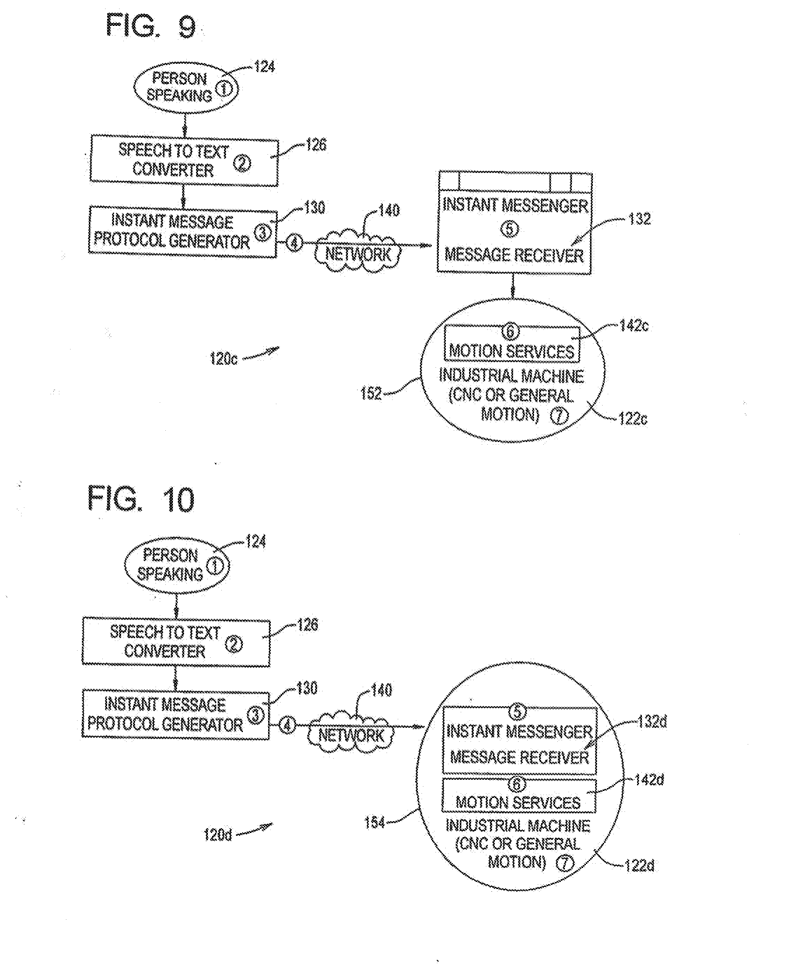

Depicted in FIG. 9 is another example of a motion system 120c that allows a speech-generated message to be sent to a industrial machine 122c. The motion system 120c is similar to the motion systems 120a and 120b described above. The primary difference between the system 120c and the systems 120a and 120b is that, in the system 120c, the functions of the motion services module 142c are built into the industrial machine 122c. The combination of the industrial machine 122c and the motion services module 142c will be referred to as the receiver/motion module and identified by reference character 152.

As shown in FIG. 9, the following steps take place when the motion system 120c operates. First, the person 124 speaks a message. For example, the person 124 may say ‘move left’. The speech-to-text converter 126 converts the spoken message into a digital representation (i.e. ASCII text, XML or some binary format) and sends the digital representation to the message sender or instant messenger protocol generator 130.

Next, the instant messenger protocol generator 130 takes the basic text message and converts it into a message format defined by the appropriate instant messenger protocol. The message is then sent by instant messenger protocol generator across the network 140.

After receiving the message, the IM message receiver 132 reflects or re-directs the message to the industrial machine 122c without processing the message. The communication to the industrial machine 122c may occur over a network, a wireless link, a direct connection (i.e. Infra-red link, serial link, parallel link, or custom wiring), or even through sound where the industrial machine 122c recognizes the sound and translates the sound message.

Upon receiving the request, the industrial machine 122c first directs the message to the motion services module 142c, which in-turn attempts to map the message to the appropriate motion command corresponding to the desired motion operation to be performed by the industrial machine 122c. The motion services module 142c direct the industrial machine 122c to run the motion commands such that the industrial machine 122c “comes to life” and performs the desired motion operation (i.e., turns left).

The motion services module 142c are a part of the industrial machine 122c but need not be organized as a specific subsystem in the industrial machine 122c. Instead, the functions of motion services module may be implemented by the collection of software, firmware, and/or hardware used to cause the industrial machine 122c to move. In addition, the motion commands may change the configuration settings on the industrial machine 122c or query data stored on the industrial machine 122c to determine the current state of the industrial machine 122c or a portion thereof.

Speech to Industrial Machine

Depicted in FIG. 10 is another example of a motion system 120d that allows a speech-generated message to be sent to a industrial machine 122d. The motion system 120d is similar to the motion systems 120a, 120b, and 120c described above. The primary difference between the system 120d and the systems 120a, 120b, and 120c is that, in the system 120d, the functions of both the message receiver 132d and the motion services module 142d are built into the industrial machine 122d. The combination of the industrial machine 122d and the motion services module 142d will be referred to as an enhanced industrial machine module and be identified by reference character 154.

In the motion system 120d, the following steps take place. First, the person 124 speaks a message. For example, the person may say ‘move left’. The speech-to-text converter 126 converts the spoken message into a digital representation (i.e. ASCII text, XML or some binary format) and sends the digital representation to the message sender or instant messenger protocol generator 130.

Next, the instant messenger protocol generator 130 takes the basic text message and converts it into the message format defined by the appropriate IM protocol. The message is then sent by the instant messenger protocol generator 130 across the network 140 to the enhanced industrial machine module 154.

Upon receiving the message, the industrial machine 122d uses the internal message receiver 132d to interpret the message. The industrial machine 122d next uses the motion services module 142d to attempt to map the message to the motion commands associated with the desired motion operation as embodied by the IM message.

The motion services module 142d then directs the industrial machine 122d to run the motion commands generated by the motion services module 142d such that the industrial machine 122d “comes to life” and performs the desired motion operation.

The motion services module 142d is a part of the industrial machine 122d but may or may not be organized as a specific subsystem of the industrial machine 122d. The collection of software, firmware, and/or hardware used to run the motion commands (either pre-programmed, or downloaded) on the industrial machine 122d may also be configured to perform the functions of the motion services module 142d. In addition, the motion commands may change the configuration settings on the industrial machine 122d or query data to determine the current state of the industrial machine 122d or a portion thereof.

### Gaming and Animation Event Driven Motion

This sub-section describes a number of motion systems 220 that employ an event system to drive physical motions based on events that occur in a number of non-motion systems. One such non-motion system is a gaming system such as a Nintendo or Xbox game. Another non-motion system that may be used by the motion systems 120 is a common animation system (such as a Shockwave animation) or movie system (analog or digital).

All of the motion systems 220 described below comprise a motion enabled device 222, an event source 230, and a motion services module 242. In the motion systems 220 described below, the motion enabled device 222 is typically a toy or other fantasy device, a consumer device, a full sized mechanical machine, or other consumer device that is capable of converting motion commands into movement.

The event source 230 differs somewhat in each of the motion systems 220, and the particulars of the different event sources 230 will be described in further detail below.

The motion services module 242 is or may be similar to the motion service modules 42 and 142 described above. In particular, the motion services module 242 maps remotely generated events to motion commands corresponding to the desired motion operation. To perform this function, the motion services module 242 may incorporate an event services module such as is described in U.S. patent application Ser. No. 10/074,577 cited above. The event services module described in the '577 application allows instructions and data contained in an event to be mapped to a set of motion commands appropriate for controlling the motion enabled device 222.

This section comprises two sub-sections. The first subsection describes four exemplary motion systems 220a, 220b, 220c, and 220d that employ an event source 230 such as common video game or computer game to drive physical motions on a motion enabled device 222. The second sub-section describes two exemplary motion systems 220e and 220f that employ an event source such as an animation, video, or movie to drive physical motions on a motion enabled device 222.

### Game Driven Motion

Computer and video games conventionally maintain a set of states that manage how characters, objects, and the game ‘world’ interact with one another. For example, in a role-playing game the main character may maintain state information such as health, strength, weapons, etc. The car in a race-car game may maintain state information such as amount of gasoline, engine temperature, travel speed, etc. In addition, some games maintain an overall world state that describes the overall environment of the game.

The term “events” will be used in this sub-section to refer user or computer similar actions that affect the states maintained by the game. More specifically, all of the states maintained by the game are affected by events that occur within the game either through the actions of the user (the player) or that occur through the computer simulation provided by the game itself. For example, the game may simulate the movements of a character or the decline of a character's health after a certain amount of time passes without eating food. Alternatively, the player may trigger events through their game play. For example, controlling a character to fire a gun or perform another action would be considered an event.

When events such as these occur, it is possible to capture the event and then trigger an associated physical motion (or motions) to occur on a physical device associated with the game. For example, when a character wins a fight in the computer game, an associated ‘celebration dance’ event may fire triggering a physical toy to perform a set of motions that cause it to sing and dance around physically.

Each event may be fired manually or automatically. When using manual events, the game environment itself (i.e. the game software, firmware or hardware) manually fires the events by calling the event manager software, firmware, or hardware. Automatic events occur when an event manager is used to detect certain events and, when detected, run associated motion operations.

The following sections describe each of these event management systems and how they are used to drive physical motion.

Manual Events

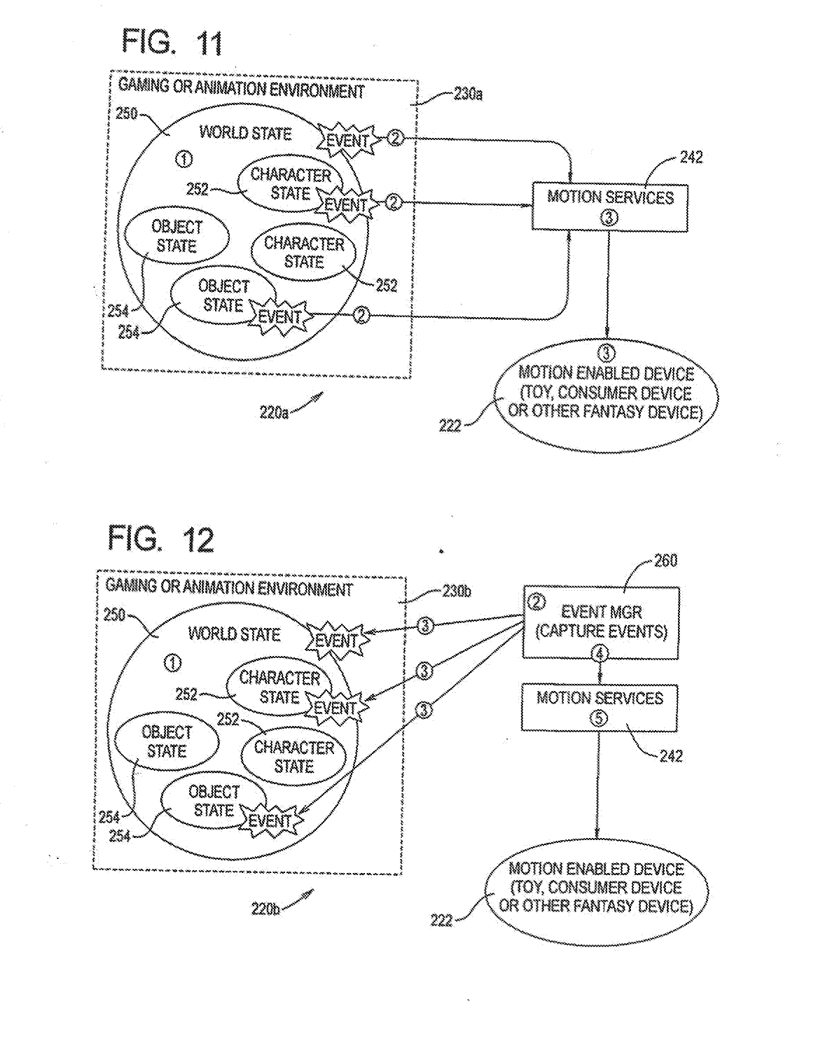

Referring initially to FIG. 11, depicted therein is a motion system 220a comprising an event source 230a, a motion services module 242, and a motion enabled device 222. The exemplary event source 230a is a gaming system comprising a combination of software, firmware, and/or hardware. As is conventional, the event source 230a defines a plurality of “states”, including one or more world states 250, one or more character states 252, and one or more object states 254.

Each of the exemplary states 250, 252, and 254 is programmed to generate or “fire” what will be referred to herein as “manual” motion services events when predetermined state changes occur. For example, one of the character states 252 includes a numerically defined energy level, and the character state 252 is configured to fire a predetermined motion services event when the energy level falls below a predetermined level. The motion services event so generated is sent to the motion services module 242, which in turn maps the motion services event to motion commands that cause a physical replication of the character to look tired.

The following steps typically occur when such manual events are fired during the playing of a game.

First, as the gaming system 230a is played the gaming system 230a continually monitors its internal states, such as the world states 250, character states 252, and/or object states 254 described above.

When the gaming system 230a detects that parameters defined by the states 250-254 enter predetermined ‘zones’, motion services events associated with these states and zones are fired.

For example, one of the character states 252 may define one or a character's health on a scale of 1 to 10, with 10 indicating optimal health. A low-health′ zone may be defined as when the energy level associated with the character state 252 is between 1 and 3. When the system 230a, or more specifically the character state 252, detects that the character's health is within the low-health′ zone, the low-health′ motion services event is fired to the motion services module 242.

As an alternative to firing an event, the gaming system 230a may be programmed to call the motion services module 242 and direct it to run the program or motion operation associated with the detected state zone.

After the event is filed or the motion services module 242 is programmatically called, the motion services module 242 directs the motion enabled device 222 to carry out the desired motion operation.

### Automatic Events

### First Example

Referring now to FIG. 12, depicted therein is a motion system 220b comprising an event source or gaming system 230b, a motion services module 242, a motion enabled device 222, and an event manager 260.

The exemplary event source 230b is similar to the event source 230a and defines a plurality of “states”, including one or more world states 250, one or more character states 252, and one or more object states 254. However, the event source 230b is not programmed to generate or “fire” the motion services events. Instead, the event manager 260 monitors the gaming system 230b for the occurrence of predetermined state changes or state zones. The use of a separate event manager 260 allows the system 220b to operate without modification to the gaming system 230b.

When the event manager 260 detects the occurrence of such state changes or state zones, the event manager 260 sends a motion services event message to the motion services module 242. The motion services module 242 in turn sends appropriate motion commands to the motion enabled device 222 to cause the device 222 to perform the desired motion sequence.

The following steps occur when automatic events are used. First, the world states 250, character states 252, and object states 254 of the gaming system 230b continually change as the system 230b operates.

The event manager 260 is configured to monitor the gaming system 230b and detect the occurrence of predetermined events such as a state changes or a state moving into a state zone within the game environment. The event manager 260 may be constructed as described in U.S. Patent Application Ser. No. 60/267,645 cited above.

When such an event is detected, the event manager 260 prepares to run motion operations and/or programs associated with those events. In particular, when the event manager 260 detects one of the predetermined events, the event manager 260 sends a motion services message to the motion services module 242. The motion services module 242 then causes the motion enabled device 222 to run the desired motion operation associated with the detected event.

### Automatic Events

### Second Example

Referring now to FIG. 13, depicted therein is a motion system 220c comprising an event source or gaming system 230c, a motion services module 242, a motion enabled device 222, and an event manager 260c.

The exemplary event source 230c is similar to the event source 230a and defines a plurality of “states”, including one or more world states 250, one or more character states 252, and one or more object states 254.

While the event source 230c itself is not programmed to generate or “fire” the motion services events, the event manager 260c is built-in to the event source 230c. The built-in event manager 260c monitors the gaming system 230c for the occurrence of predetermined state changes or state zones. The built-in event manager 260c allows the system 220c to operate without substantial modification to the gaming system 230c.

When the event manager 260c detects the occurrence of such state changes or state zones, the event manager 260c sends a motion services event message to the motion services module 242. The motion services module 242 in turn sends appropriate motion commands to the motion enabled device 222 to cause the device 222 to perform the desired motion sequence.

The following steps occur when automatic events are used. First, the world states 250, character states 252, and object states 254 of the gaming system 230c continually change as the system 230c operates.

The event manager 260c is configured to monitor the gaming system 230c and detect the occurrence of predetermined events such as a state changes or a state moving into a state zone within the game environment.

When such an event is detected, the event manager 260c prepares to run motion operations and/or programs associated with those events. In particular, when the event manager 260c detects one of the predetermined events, the event manager 260 sends a motion services message or event to the motion services module 242. The motion services module 242 then causes the motion enabled device 222 to run the desired motion operation associated with the detected event.

### Animation Driven Motion

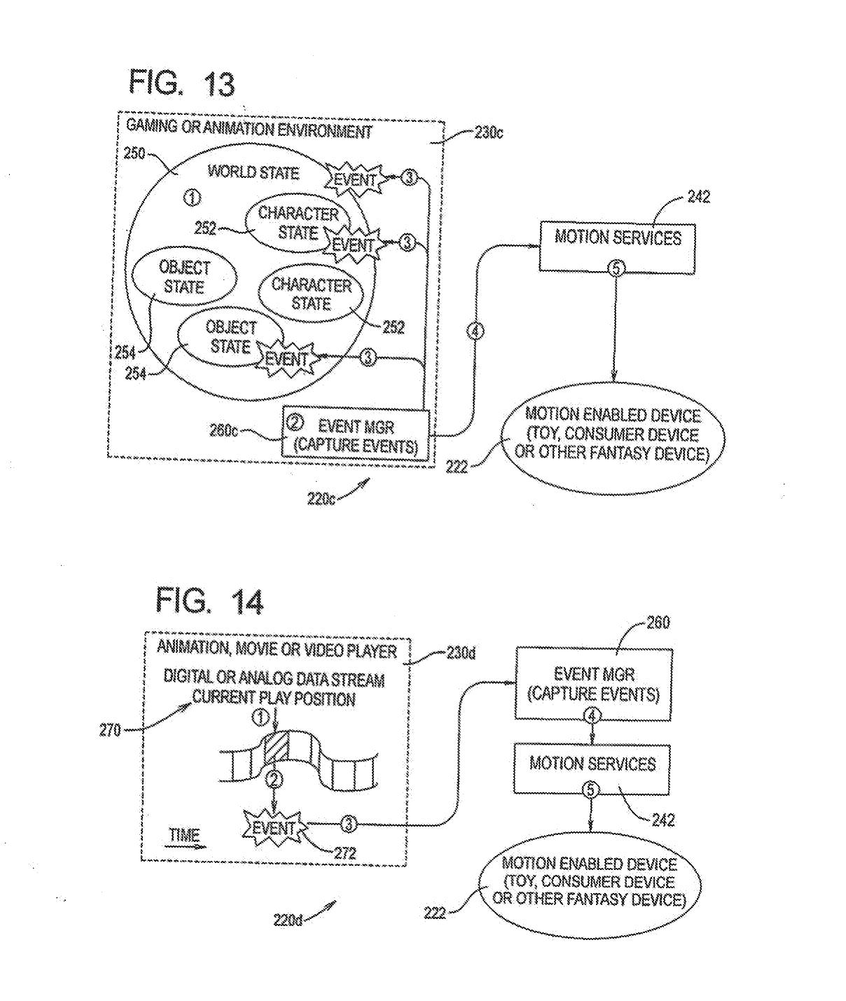

The term “animation” is used herein to refer to a sequence of discrete images that are displayed sequentially. An animation is represented by a digital or analog data stream that is converted into the discrete images at a predetermined rate. The data stream is typically converted to visual images using a display system comprising a combination of software, firmware, and/or hardware. The display system forms the event source 230 for the motion systems shown in FIGS. 14-16.

Animation events may be used to cause a target motion enabled device 222 to perform a desired motion operation. In a first scenario, an animation motion event may be formed by a special marking or code in the stream of data associated with a particular animation. For example, a digital movie may comprise one or more data items or triggers embedded at one or more points within the movie data stream. When the predetermined data item or trigger is detected, an animation motion event is triggered that causes physical motion on an associated physical device.

In a second scenario, a programmed animation (e.g., Flash or Shockwave) may itself be programmed to fire an event at certain times within the animation. For example, as a cartoon character bends over to pick-up something, the programmed animation may fire a ‘bend-over’ event that causes a physical toy to move in a manner that imitates the cartoon character.

Animations can be used to cause motion using both manual and automatic events as described below.

Manual Events

Referring now to FIG. 14, depicted therein is a motion system 220d comprising an event source or display system 230d, a motion services module 242, a motion enabled device 222, and an event manager 260.

To support a manual event, the display system 230d used to play the data must be configured to detect an animation event by detecting a predetermined data element in the data stream associated with the animation. For example, on an analog 8-mm film a special ‘registration’ hash mark may be used to trigger the event. In a digital animation, the animation software may be programmed to fire an event associated with motion or a special data element may be embedded into the digital data to the later fire the event when detected. The predetermined data element corresponds to a predetermined animation event and thus to a desired motion operation to be performed by the target device 222.

The following steps describe how an animation system generates a manual event to cause physical motion.

First the animation display system 230d displays a data stream 270 on a computer, video screen, movie screen, or the like. When external event manager 260 detects the event data or programmed event, the event manager 260 generates an animation motion message. In the case of a digital movie, the event data or programmed event will typically be a special digital code or marker in the data stream. In the case of an analog film, the event data or programmed event will typically be a hash mark or other visible indicator.

The external event manager 260 then sends the animation motion message to the motion services module 242. The motion services module 242 maps the motion message to motion commands for causing the target device 222 to run the desired motion operation. The motion services module 242 sends these motion commands to the target device 222. The motion services module 242 controls the target device to run, thereby performing the desired motion operation associated with the detected animation event.

In particular, the motion services module 242 generates motion commands and sends these commands to the target device 222. The motion services module 242 controls the target device to run, thereby performing the desired motion operation associated with the animation event 272.

Automatic Events

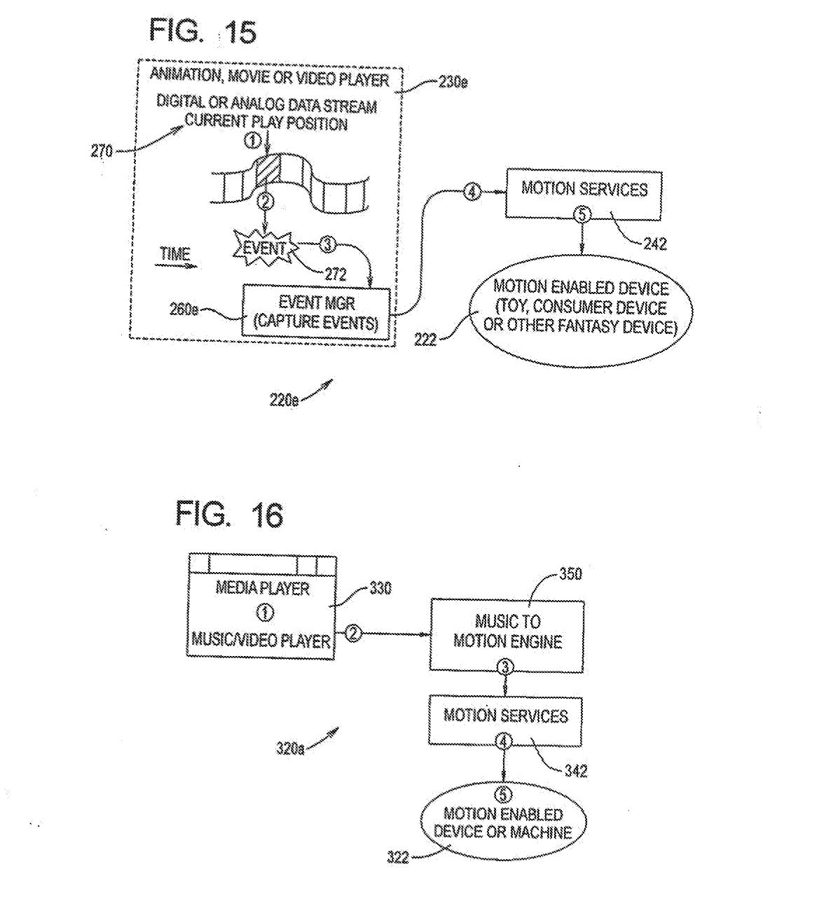

Referring now to FIG. 15, depicted therein is a motion system 220e comprising an event source or display system 230d, a motion services module 242, a motion enabled device 222, and an event manager 260e. In the motion system 220e, the event manager 260e is built into the display system 230e such that the system 230e automatically generates the animation events.

The following steps describe how an animation generates automatic animation events to cause physical motion.

First, the animation display system 230e displays a data stream 270 on a computer, video screen, movie screen, or the like. When built-in event manager 260e detects the animation event by analyzing the data stream 270 for predetermined event data or programmed event, the event manager 260e generates the animation event 272.

The internal event manager 260 then sends an appropriate motion message to the motion services module 242. The motion services module maps the motion message to motion commands for causing the target device 222 to run the desired motion operation. The motion services module 242 sends these motion commands to the target device 222. The motion services module 242 controls the target device to run, thereby performing the desired motion operation associated with the animation event 272.

### Music Driven Motion

Numerous media players are available on the market for playing pre-recorded or broadcast music. Depicted at 320 in FIGS. 16-19 of the drawing are motion systems capable of translating sound waves generated by such medial player systems into motion. In particular, the motion systems 320 described herein comprise a motion enabled device or machine 322, a media player 330, a motion services module 342, and a music-to-motion engine 350.

The motion-enabled device 322 may be a toy, a consumer device, a full sized machine for simulating movement of an animal or human or other machine capable of controlled movement.

The media player 330 forms an event source for playing music. The media player 330 typically reproduces music from an analog or digital data source conforming to an existing recording standard such as a music MP3, a compact disk, movie media, or other media that produced a sound-wave. The music may be derived from other sources such as a live performance or broadcast.

The music-to-motion engine 350 maps sound elements that occur when the player 330 plays the music to motion messages corresponding to desired motion operations. The music-to-motion engine 350 is used in conjunction with a media player such as the Microsoft® Media Player 7. The music-to-motion engine 350 sends the motion messages to the motion services module 342.

The motion services module 342 in turn maps the motion messages to motion commands. The motion services module 342 may be similar to the motion services modules 42, 142, and 242 described above. The motion commands control the motion-enabled device 322 to perform the motion operation associated with the motion message generated by the music-to-motion machine 350.

### Module Layout

The music driven motion system 320 may be embodied in several forms as set forth below.

Music to Motion

Referring now to FIG. 16, depicted therein is one exemplary example of a music-driven motion system 320a of the present invention. The system 320a comprises a motion enabled device or machine 322, a media player 330, a motion services module 342, and a music-to-motion engine 350.

When using the system 320a to cause physical motion, the following steps occur. First the media player 330 plays the media that produces the sound and sends the sound wave to the music-to-motion engine 350. As will be described in further detail below, the music-to-motion engine 350 converts sound waves in electronic or audible form to motion messages corresponding to motion operations and/or programs that are to be run on the target device 322.

The music-to-motion engine 350 sends the motion messages to the motion services module 342. The motion services module 342 translates or maps the motion messages into motion commands appropriate for controlling the motion enabled device 322. The motion services module 342 sends the motion commands to the target device 322 and causes the device 322 to run the motion commands and thereby perform the desired motion operation.

Built-in Motion to Music

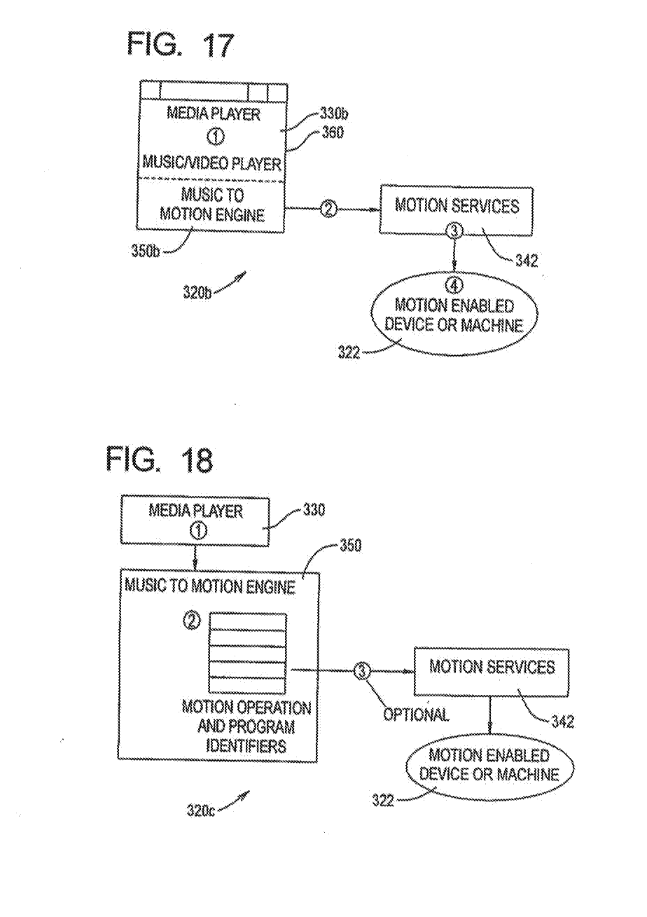

Referring now to FIG. 17, depicted therein is another exemplary example of a music-driven motion system 320b of the present invention. The system 320b comprises a motion enabled device or machine 322, a media player 330b, a motion services module 342, and a music-to-motion engine 350b. The exemplary media player 330b and music-to-motion engine 350b are combined in a player/motion unit 360 such that the music-to-motion engine functions are built in to the player/motion unit 360.

When using the system 320b to cause physical motion, the following steps occur. First the media player 330b plays the media that produces the sound and sends the sound wave to the music-to-motion engine 350. The music-to-motion engine 350 converts the sound-wave to motion messages corresponding to motion operations and/or programs that are to be run on the target device.

The music-to-motion engine 350 sends the motion messages to the motion services module 342. The motion services module 342 translates or maps the motion messages into motion commands appropriate for controlling the motion enabled device 322. The motion services module 342 sends the motion commands to the target device 322 and causes the device 322 to run the motion commands and thereby perform the desired motion operation.

### Music-to-Motion General Algorithm

This chapter describes the general algorithms used by the music-to-motion engine 350 to map sound-waves to physical motions.

Configuration

Before the systems 320a or 320b are used, the music-to-motion engine 350 is configured to map certain sounds or combinations of sounds or sound frequencies occur to desired motion operations. The exemplary music-to-motion engine 350 may be configured to map a set of motion operations (and the axes on which the operations will be performed) to predetermined frequency zones in the sound wave. For example, the low frequency sounds may be mapped to an up/down motion operation on both first and second axes which corresponds to the left and right arm on a toy device. In addition or instead, the high frequency sounds be mapped to a certain motion program, where the motion program is only triggered to run when the frequency zone reaches a certain predetermined level.

Referring now to FIG. 18, graphically depicted at 320c therein are the steps of one of exemplary method of configuring the systems 320a and 320b. In particular, the media player 330 and/or the music-to-motion engine 350 itself opens up a user interface or supplies initialization data used to configure the music-to-motion engine 350.

In the exemplary system 320c, the frequency ranges are mapped to motion operations. The frequency ranges may also be mapped to non-motion related operations such as turning on/off digital or analog input/output lines.

Optionally, the music-to-motion engine 350 may query the motion services module 342 for the motion operations and/or programs that are available for mapping.

Mapping Methods

The following types of mappings may be used when configuring the music-to-motion engine 350.

The first mapping method is frequency zone to motion operation. This method maps a frequency zone to a motion operation (or set of motion operations) and a set of axes. The current level of frequency is used to specify the intensity of the motion operation (i.e. the velocity or distance of a move) and the frequency rate of change (and change direction) are used to specify the direction of the move. For example, if the frequency level is high and moving higher, an associated axis of motion may be directed to move at a faster rate in the same direction that it is moving. If the frequency decreases below a certain threshold, the direction of the motor may change. Thresholds at the top and bottom of the frequency range may be used to change direction of the motor movement. For example, if the top frequency level threshold is hit, the motor direction would reverse. And again when the bottom frequency level was hit the direction would reverse again.

The second mapping technique is frequency zone to motion program. A motion program is a combination of discrete motion operations. As described above, the term “motion operation” is generally used herein for simplicity to include both discrete motion operations and sequences of motion operations that form a motion program.

When this second mapping technique is used, a frequency zone is mapped to a specific motion program. In addition, a frequency threshold may be used to determine when to run the program. For example, if the frequency in the zone rises above a threshold level, the program would be directed to run. Or if the threshold drops below a certain level, any program running would be directed to stop, etc.

Once configured, the music-to-motion engine 350 is ready to run.

Music to Motion

When running the music-to-motion engine 350, the engine 350 may be programmed to convert sound waves to motion operations by breaking the sound wave into a histogram that represents the frequency zones previously specified when configuring the system. The level of each bar in the histogram can be determined in several ways such as taking the average of all frequencies in the zone (or using the minimum frequency, the maximum, the median value, etc). Once the histogram is constructed, the frequency zones are compared against any thresholds previously set for each zone. The motions associated with each zone are triggered depending on how they were configured.

For example, if thresholds are used for the specific zone, and those threshold are passed, the motion is triggered (i.e. the motion operation or program for the zone is run). Or if no threshold is used, any detected occurrence of sound of a particular frequency (including its rate of change and direction of change) may be used to trigger and/or change the motion operation.

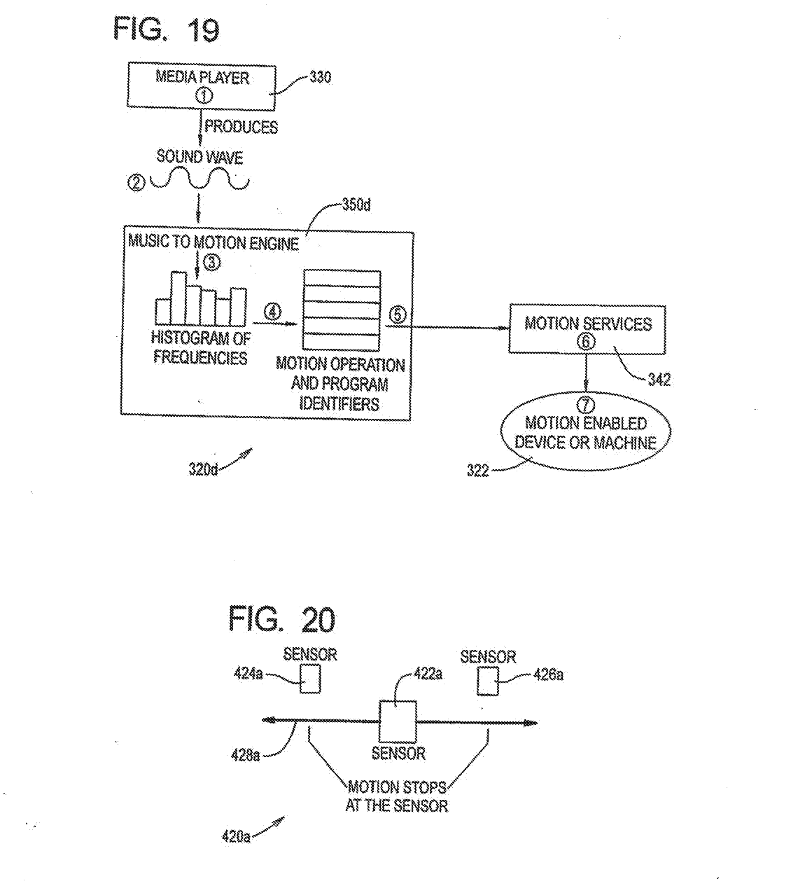

Referring now to FIG. 19, depicted therein is an exemplary motion system 320d using a music-to-motion engine 350d that generates a histogram of frequencies to map music events to motion. The following steps occur when running the exemplary music-to-motion engine 350d.

First the media player 330 plays the media and produces a sound-wave. The sound-wave produced is sent to the music-to-motion engine 350. The music-to-motion engine 350 then constructs a histogram for the sound wave, where the histogram is constructed to match the frequency zones previously specified when configuring the system.

Next, the music-to-motion engine 350 compares the levels of each bar in the histogram to the rules specified when configuring the system; as discussed above, these rules may include crossing certain thresholds in the frequency zone level etc. In addition, the rules may specify to run the motion operation at all times yet use the histogram bar level as a ratio to the speed for the axes associated with the frequency zone.

When a rule or set of rules are triggered for one or more frequency zones represented by the histogram, an associated lookup table of motion operations and/or programs is used to determine which of the group of available motion operations is the desired motion operation. Again, the term “motion operation” includes both discrete motion operations and sequences of motion operations combined into a motion program.

Next, a motion message corresponding to the desired motion operation is sent to the motion services module 342, which maps the motion message to motion commands as necessary to control the target device 322 to perform the desired motion operation.

The target motion enabled device 322 then runs the motion commands to perform desired motion operation and/or to perform related actions such as turning on/off digital or analog inputs or outputs.

### Motion Proximity Sensors

This document describes a system and/or method of using sensors or contact points to facilitate simple motion proximity sensors in a very low cost toy or other fantasy device. Typically within Industrial Applications very high priced, accurate sensors are used to control the homing position and the boundaries of motion taking place on an industrial machine. Because of the high prices (due to the high precision and robustness required by industrial machines) such sensors are not suitable for use on low-cost toys and/or fantasy devices.

### Basic Movements

Toy and fantasy devices can use linear motion, rotational motion, or a combination of the two. Regardless of the type of motion used, quite often it is very useful to control the boundaries of motion available on each axis of motion. Doing so allows software and hardware motion control to perform more repeatable motions. Repeatable motions are important when causing a toy or fantasy device to run a set of motions over and over again.

Linear Motion

Linear motion takes place in a straight direction. Simple motion proximity sensors are used to bound the area of motion into what is called a motion envelope where the axis is able to move the end-piece left and right, up and down, or the like.

Referring to FIG. 20, schematically depicted therein is a sensor system 420a comprising first, second, and third sensor parts 422a, 424a, and 426a. The first sensor part 422a is mounted on a moving object, while the second and third sensor parts 424a and 426a are end limit sensor parts that define the ends of a travel path 428a that in turn defines the motion envelope. The exemplary travel path 428a is a straight line.

The sensor parts 422, 424, and 426 may be implemented using any sensor type that signals that the moving part has hit (or is in the proximity of) one motion limit location or another. Examples of sensors that may be used as the sensors 422 include electrical contact sensors, light sensors, and magnetic sensors.

An electrical contact sensor generates a signal when the moving sensor part comes into contact with one of the fixed end limit sensor parts and closes an electrical circuit. The signal signifies the location of the moving part.

With a light sensor, the moving sensor part emits a beam of light. The end or motion limit sensor parts comprise light sensors that detect the beam of light emitted by the moving sensor part. Upon detecting the beam of light, the motion limit sensor sends a signal indicating that a change of state that signifies the location of the moving object on which the moving sensor part is mounted. The sensor parts may be reversed such that the motion limit sensor parts each emit a beam of light and the moving target sensor part is a reflective material used to bounce the light back to the motion limit sensor which then in-turn detects the reflection.

With a magnetic sensor, a magnet forms the moving sensor part on the moving object. The motion limit sensor parts detect the magnetic charge as the magnet moves over a metal (or magnetic) material. When detected, the motion limit sensor sends a signal indicative of the location of the moving object.

Rotational Moves

Rotational motion occurs when a motor moves in a rotating manner. For example, a rotational move may be used to move the arm or head on an action figure, or turn the wheel of a car, or swing the boom of a crane, etc.

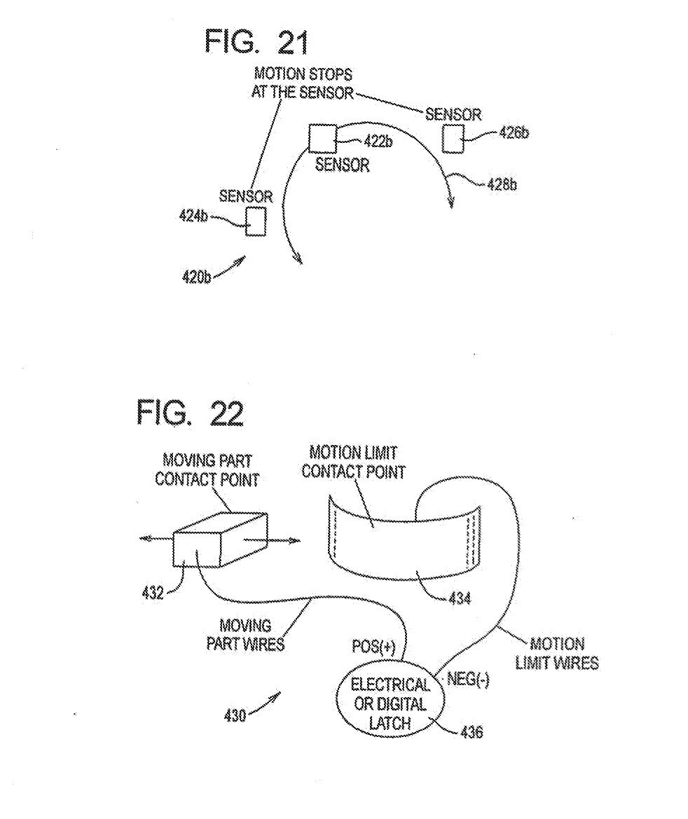

Referring to FIG. 21, schematically depicted therein is a sensor system 420b comprising first, second, and third sensor parts 422b, 424b, and 426b. The first sensor part 422b is mounted on a moving object, while the second and third sensor parts 424b and 426b are end limit sensor parts that define the ends of a travel path 428b that in turn defines the motion envelope. The exemplary travel path 428b is a curved line.

The sensor parts 422, 424, and 426 may be implemented using any sensor type that signals that the moving part has hit (or is in the proximity of) one motion limit location or another. Examples of sensors that may be used as the sensors 422 include electrical contact sensors, light sensors, and magnetic sensors as described above.

### Hard Wire Proximity Sensor

Motion limit sensors can be configured in many different ways. This sub-section describes a sensor system 430 that employs hard wired limit configurations using physical wires to complete an electrical circuit that indicates whether a physical motion limit is hit or not.

Simple Contact Limit

A simple contact limit configuration uses two sensors that may be as simple as two pieces of flat metal (or other conductive material). When the two materials touch, the electrical circuit is closed causing the signal that indicates the motion limit side is hit (or touched) by the moving part side.

Referring now to FIG. 22, depicted therein is an exemplary sensor system 430 using a simple contact limit system. The sensor system 430 employs a moving part contact point 432, a motion limit contact point 434, and an electronic or digital latch 436.

The moving part contact point 432 contains conductive material (for example a form of metal) that is connected to by moving part wires to the latch 436. The motion limit contact point 434 contains conductive material (for example a form of metal) that is also connected by motion limit wires to the latch 436.

The electrical or digital latch 436 stores the state of the electrical circuit. In particular, the electrical circuit is either closed or open, with the closed state indicating that the moving part contact point 432 and the motion limit contact point 434 are in physical contact. The latch 436 may be formed by any one of various existing latch technologies such as a D flip-flop, some other clock edge, one-shot latch, or a timer processor unit common in many Motorola chips capable of storing the state of the electrical circuit.

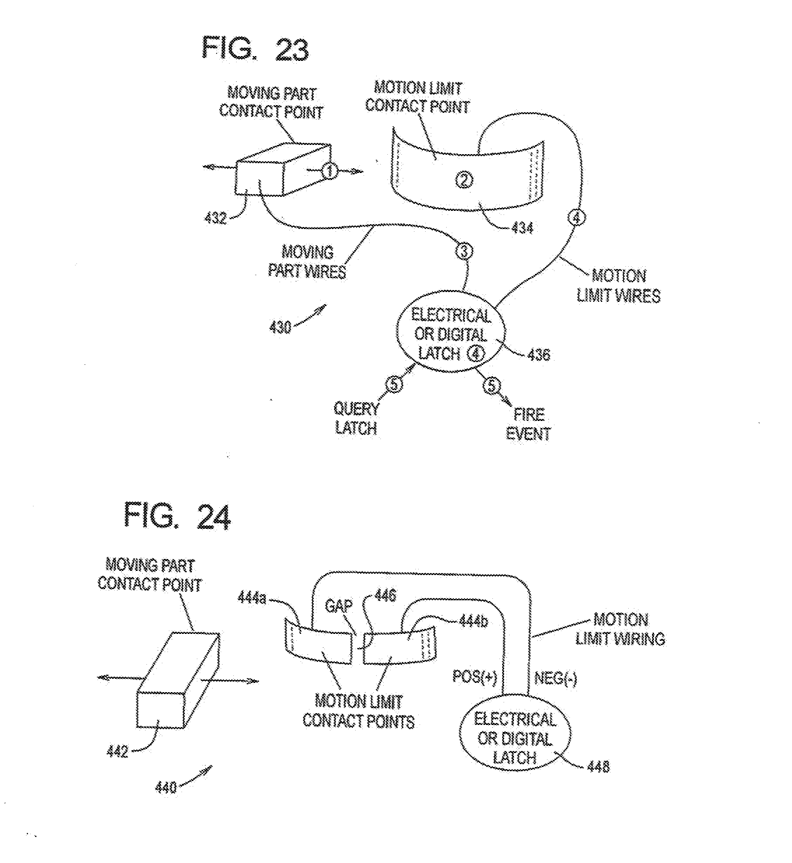

Referring now to FIG. 23, depicted therein is scenario map depicting how the system 430 operates. During use, the simple contact limit circuit is considered closed when the moving part contact point 432 touches the motion limit contact point 434. Upon contact, electricity travels between the contact points 432 and 434, thereby changing the electrical or digital latch 436 from an open to a closed state. The change of state of the latch 436 signifies that the limit is hit.

During operation of the system 430, the following steps occur. First, the moving object on which the contact point 432 is mounted must move toward the motion limit contact point 434. When these contact points 432 and 434 touch, an electrical circuit is formed, thereby allowing electricity to flow between the contact points 432 and 434. Electricity thus flows between the two contact points 432 and 434 to the electrical or digital latch 436 through the moving part and motion limit wires.

The electrical or digital latch 436 then detects the state change from the open state (where the two contact points are not touching) to the closed state (where the two contact points are touching). The latch stores this state.

At any time other hardware or software components may query the state of the electrical or digital latch to determine whether or not the motion limit has been hit or not. In addition a general purpose processor, special chip, special firmware, or software associated with the latch may optionally send an interrupt or other event when the latch is deemed as closed (i.e. signifying that the limit was hit). The motion limit sensor system 430 may thus form an event source of a motion system as generally described above.

A pair of such motion proximity sensor systems may be used to place boundaries around the movements of a certain axis of motion to create a motion envelope for the axis. In addition, a single proximity sensor may be used to specify a homing position used to initialize the axis by placing the axis at the known home location.

Dumb Moving Part Sensor Contact

Referring now to FIG. 24, depicted therein is another exemplary sensor circuit 440. The sensor circuit 440 comprises a moving contact point 442, first and second motion limit contact points 444a and 444b separated by a gap 446, and a latch 448. In the circuit 440, the positive and negative terminals of the latch 448 are connected to the motion limit contact points 444a and 444b. The sensor circuit 440 eliminates moving part wires to improve internal wiring and also potentially reduce costs. The moving part sensor system 440 thus acts as a dumb sensor requiring no direct wiring.

More specifically, the dumb moving part sensor contact point 442 is a simple piece of conductive material designed to close the gap 446 separating two contact points 444a and 444b. When closed, electrical current flows from one motion limit contact point 444a through the moving part contact point 442 to the other motion limit contact point 446, thus closing the electrical circuit and signaling that the motion limit has been reached.

The moving part contact point 442 is attached to or an integral part of the moving object. The moving part contact point 442 contains a conductive material that allows the flow of electricity between the two contact points 444a and 444b when the contact point 442 touches both of the contact points 444a and 444b.

The motion limit contact points 444a and 444b comprise two conductive members that are preferably separated by a non-conductive material defining the gap 446. Each contact point 444 is connected to a separate wire that is in turn connected one side of the electrical or digital latch 448.

The latch component 448 is used to store the state of the electrical circuit (i.e. either open or closed) and is thus similar to the latch component 436 described above. The latch 448 can thus be queried by other hardware or software components to determine whether or not the latch is open or closed. In addition, when coupled with additional electrical circuitry (or other processor, or other firmware, or other software) a detected closed state may trigger an interrupt or other event.

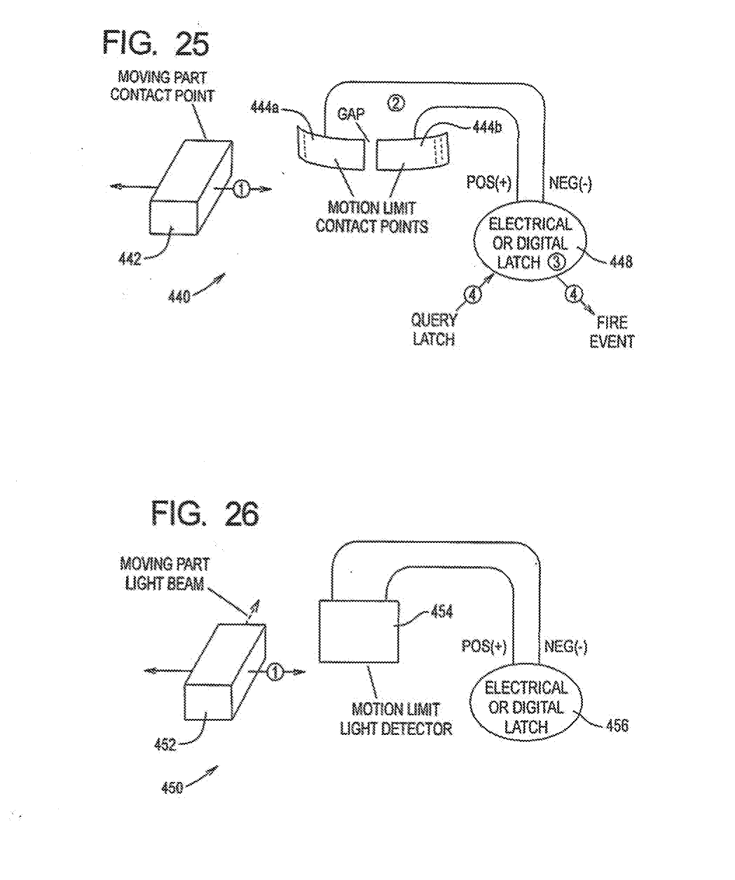

FIG. 25 depicts a scenario map depicting the use of the sensor system 440. In particular, the dumb moving part sensor circuit 440 operates as follows. First, the moving part contact point 442 must move towards the motion limit contact points 444a and 444b. Upon touching both of the motion limit contact points 444a and 444b, the moving part contact point 442 closes the electrical circuit thus creating a “limit hit” signal. The electrical or digital latch 448 retains the limit hit signal.

The open (or closed) state of the limit stored by the electrical or digital latch 448 can then be queried by an external source. Or, when coupled with more additional logic (hardware, firmware, and/or software) an interrupt or other event may be fired to an external source (either hardware, firmware or software) that the limit has been reached.

Light Sensors

In addition to using a physical contact to determine whether or not a moving part is within the proximity of a motion limit or not, a light beam and light detector may also be used to determine proximity.

Referring to FIG. 26, depicted at 450 therein is a light sensor circuit of the present invention. The light sensor circuit uses a moving part light beam device 452, a light detector 454, and a latch 456. The moving part light beam device 452 emits a beam of light. When the light detector 454 detects the light beam generated by the light beam device 452, the light detector 454 senses the light beam and closes the electrical circuit, thereby setting the latch 456.

The moving part light beam device 452 comprises any light beam source such as a simple LED, filament lamp, or other electrical component that emits a beam of light. The motion limit light detector 454 is a light sensor that, when hit with an appropriate beam of light, closes an electrical circuit. The electrical or digital latch 456 may be the same as the latches 436 and 448 described above.

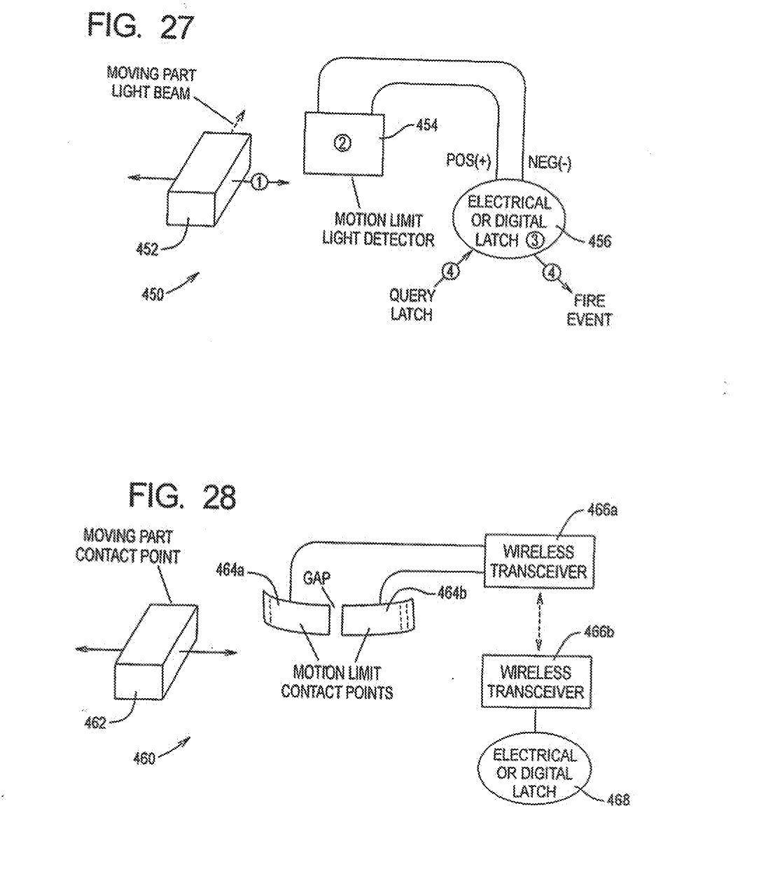

FIG. 27 illustrates the process of using the sensor circuit 450. First, the moving object to which the light beam device 452 is attached moves into a position where the light beam impinges upon the light detector 454. The light detector 454 then closes the electrical circuit.

When the state of the electrical circuit changes, the electrical or digital latch 456 stores the new state in a way that allows a motion system comprising hardware, firmware and/or software to query the state. At that point, motion system may query the state of the latch to determine whether or not the limit has been reached. In addition, additional logic (either implemented in hardware, software or firmware) may be used to fire an interrupt or other event when the circuit changes from the open to closed state and/or vise versa.

### Wireless Proximity Sensor

In addition to the hard-wired proximity sensors, sensors may be configured to use wireless transceivers to transfer the state of the sensors to the latch hardware. The following sections describe a number of sensor systems that use wireless transceivers to transfer circuit state.

Wireless Detectors

Referring now to FIG. 28, depicted therein is a wireless sensor circuit 460. The sensor circuit 460 comprises a moving contact point 462 attached to the moving object, first and second motion limit contact points 464a and 464b, first and second wireless units 466a and 466b, and a latch component 468. The sensor circuit 460 uses the wireless units 466a and 466b to transfer the state of the circuit (and thus the contacts 464 and 466) to the latch component 468.

The moving part contact point 462 is fixed to or a part of the moving object. The moving part contact point 462 is at least partly made of a conductive material that allows the transfer of electricity between the two contact points 464a and 464b when the contact point 462 comes into contact with both of the contact points 464a and 464b.

The motion limit contact points 464a and 464b are similar to the contact points 444a and 444b described above and will not be described herein in further detail.

The wireless units 466a and 466b may be full duplex transceivers that allow bidirectional data flow between the contact points 464a and 464b and the latch 468. Optionally, the first wireless unit 466a may be a transmitter and the second unit 466b will be a receiver. In either case, the wireless units 466a and 466b are used to transfer data from the local limit circuit (which implicitly uses an electrical or digital latch) to the remote electrical or digital latch thus making the remote latch appear like it is actually the local latch.

The latch component 468 may be the same as the latches 436, 446, and 456 described above. Optionally, the latch component 468 may be built into the wireless unit 466b.

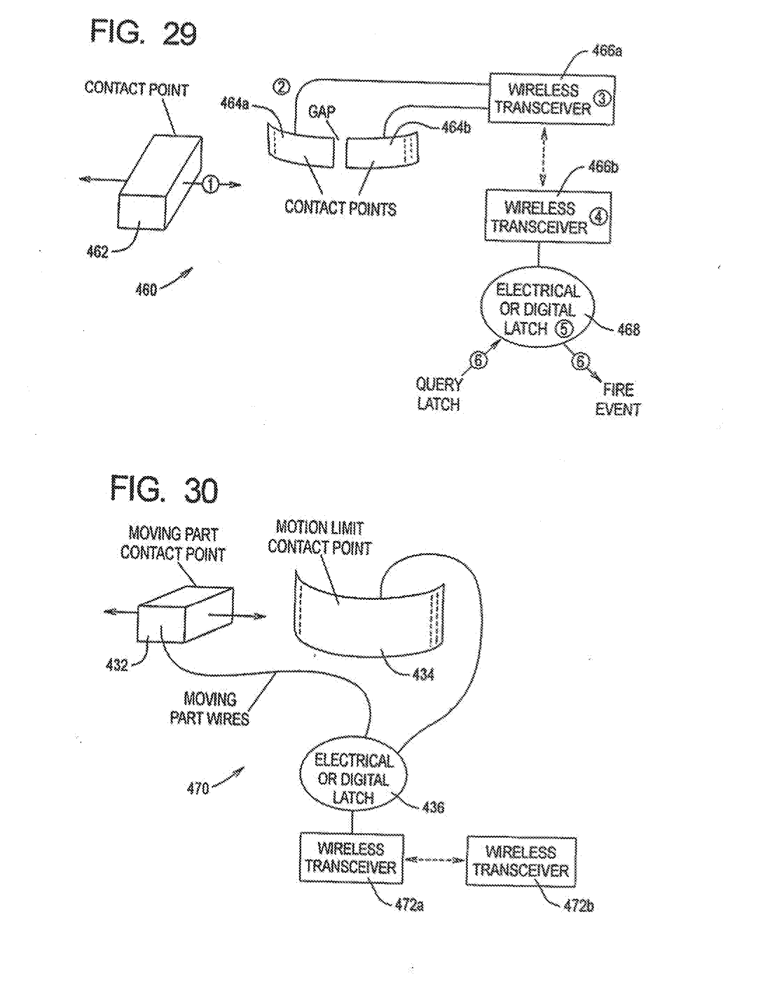

Referring now to FIG. 29, depicted therein is a scenario map depicting the operation of the sensor circuit 460. The sensor circuit 460 operate basically as follows. First, the moving part contact point 462 come into contact with both of the motion limit contact points 464a and 464b. When this occurs, the moving part contact point 462 closes the electrical circuit, thus creating a “limit hit” signal. A local electrical or digital latch built into or connected to the wireless unit 466a retains the limit hit signal. On each state change, the first wireless unit 466a transfers the new state to the remote wireless unit 466b.

Upon receiving the state change, the remote unit 466b updates the electrical or digital latch 468 with the new state. The external latch component 468 stores the latest state makes the latest state available for an external motion system. To the external motion system, the remote latch 468 appears as if it is directly connected to the motion limit contact points 464a and 464b.

The open (or closed) state of the limit stored by the remote electrical or digital latch 468 can then be queried by an external source or when coupled with more additional logic (either hardware, firmware or software) an interrupt or other event may be generated and sent to an external source (either hardware, firmware or software), indicating that the limit has been hit.

Wireless Latches

Each of the latch systems described in this document may also be connected to wireless units to transfer the data to a remote latch, or other hardware, software, or firmware system. The following sections describe a number of these configurations.

FIG. 30 depicts the use of a simple contact proximity sensor system 470 having a contact arrangement similar to that depicted at 430 in FIGS. 22 and 23 above. The system 470 includes, in addition to the components of the system 430, local and remote wireless units 472a and 472b similar to the wireless units 466a and 466b described above. The local wireless unit 472a is configured to send a signal to the remote wireless unit 472b each time the latch state changes. In addition, the remote wireless unit 472b may query the local unit 472a at any time for the current latch state or to configure the latch state to be used when the circuit opens or closes.

FIG. 31 depicts a sensor system 480 having a contact arrangement similar to that depicted at 440 in FIGS. 24 and 25 above. The system 480 includes, in addition to the components of the system 440, local and remote wireless units 482a and 482b similar to the wireless units 466a and 466b described above. The local wireless unit 482a is configured to send a signal to the remote wireless unit 482b each time the latch state changes. In addition, the remote wireless unit 482b may query the local unit 482a at any time for the current latch state or to configure the latch state to be used when the circuit opens or closes.

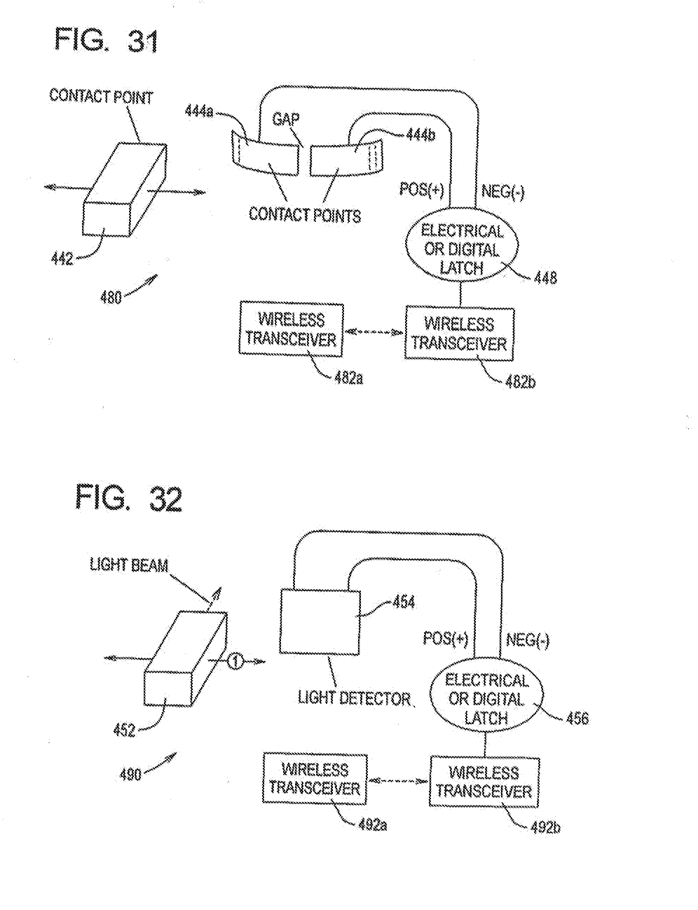

Depicted at 490 in FIG. 32 is a sensor system 490 having a light detection arrangement similar to that used by the circuit depicted at 450 in FIGS. 26 and 27 above. The system 490 includes, in addition to the components of the system 450, local and remote wireless units 492a and 492b similar to the wireless units 466a and 466b described above. The local wireless unit 492a is configured to send a signal to the remote wireless unit 492b each time the latch state changes. In addition, the remote wireless unit 492b may query the local unit 492a at any time for the current latch state or to configure the latch state to be used when the circuit opens or closes.

From the foregoing, it should be clear that the present invention can be implemented in a number of different examples. The scope of the present invention should thus include examples of the invention other than those disclosed herein.

The present invention may also be embodied as a system for driving or altering actions or states within a software system based on motion related events. The software system may be gaming system such as a Nintendo or Xbox game or a media system such as an animation (e.g., Shockwave animation) or a movie (analog or digital) system. The motion may occur in a physical motion device such as a toy, a consumer device, a full sized mechanical machine, or other consumer device capable of movement.

One example of the present invention will first be described below in the context of a common video game, or computer game being driven, altered, or otherwise affected by motion events caused in a physical motion device. Another example of the present invention will then be described in the context of an animation, video, movie, or other media player being driven, altered or otherwise affected by motion events occurring in a physical motion device.

### Motion Event Driven Gaming System

Typically the events affecting the game occur within a software environment that defines the game. However, using the principles of the present invention, motion events triggered by or within a physical device may be included within the overall gaming environment. For example, a physical device such as an action figure may be configured to generate an electric signal when its hands are clapped together and/or when its head turns a certain distance in a given direction. The electric signal is then brought into the gaming environment and treated as an event which then drives or alters internal game actions or states within the software environment of the gaming system.

Physical motion events can be brought into a gaming system in many ways. For example, certain physical states may be sensed by a motion services component of the physical motion device and then treated as an event by the software environment of the gaming system. For example, if the left arm of an action figure is up in the air and the right arm is down by the side, a ‘raised hand’ event would be fired. At a lower level an electronic signal could be used to ‘interrupt’ the computing platform on which the gaming system resides, captured by an event system, and then used as an event that drives or alters the gaming environment or internal states. The term “computing platform” as used herein refers to a processor or combination of a processor and the firmware and/or operating system used by the gaming system or the motion based device.

Each event may be fired manually or automatically. When using automatic motion events, the physical device itself (i.e. the toy, fantasy device, machine or device) fires an electronic signal that interrupts the computing platform on which the gaming environment runs. When fired, the interrupt is captured by the event manager, which then in-turn fires an associated event into the gaming environment. Manual motion events occur when the event manager uses the motion services component to detect certain hardware device states (such as a raised arm or tilted head). Once detected, the event manager fires an event into the gaming environment.

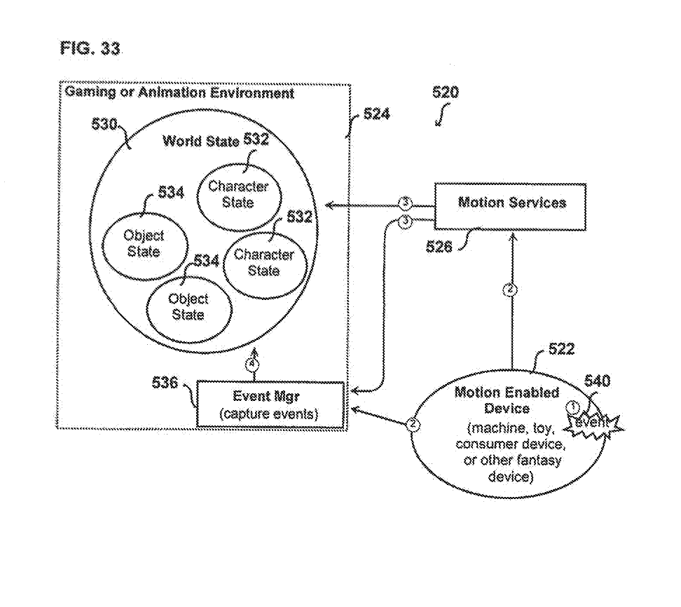

Referring to FIGS. 33-35 of the drawing, depicted therein is a motion event driven gaming system 520 constructed in accordance with, and embodying, the principles of the present invention.

Referring initially to FIG. 33 of the drawing, that figure illustrates that the motion event driven gaming system 520 comprises a motion enabled device 522 (the motion device 522), a gaming or animation environment 524 (the gaming environment 524), and a motion services component 526. The gaming environment 524 comprises a world state 530, one or more character states 532, and one or more object states 534. The gaming environment 524 may optionally further comprise an event manager 536. The motion device 522 is capable of generating a motion event 540.

FIG. 33 is a scenario map that illustrates the process by which the motion event driven gaming system 520 accepts automatic motion events 540. The automatic motion events 540 are triggered by the motion services component 526 residing on the motion device 522. When an electronic signal is fired from the motion device 522, an interrupt occurs on the computing platform on which the gaming environment 524 resides.

If the interrupt is captured on the motion device 522, the interrupt is captured and either directly sent as the motion event 540 to the gaming environment 524 or to the event manager 536 in the gaming environment 524. If the interrupt occurs in the gaming environment 524 (i.e. in the case that the motion device directly communicates to the computerized device that runs the gaming environment 524) the event manager 536 would capture the interrupt directly and send the motion event 540 to the gaming environment 524.

For example, in the case where the motion device 522 is an action figure, when an arm of the action figure is moved in a downward motion, the physical arm may be configured to fire an electronic signal that interrupts either a computing platform on which either the action figure or the gaming environment 524 runs. In the case where the computing platform of the action figure detects the interrupt, the motion services component 526 running on the action figure send an ‘arm down’ event to the gaming environment 524. In the case where computing platform of the gaming environment 524 is interrupted, the event manager 536 running on the gaming environment 524 captures the interrupt and then sends an ‘arm-down’ event to the gaming environment 524. In this example, the gaming environment 524 could be a car racing game and the cars would start to race upon receipt of the ‘arm-down’ event.

As shown in FIG. 33, the following steps occur when detecting automatic motion events 540 that alter or drive the gaming environment 524.

1. First the motion event 540 indicating an action or state change occurs in or is generated by the motion device 522.

2. Next, the computing platform of either the gaming environment 524 or of the motion device 522 is interrupted with the motion event 540. When the gaming environment 524 computing platform is interrupted, which occurs when the device directly communicates with the gaming environment 524, (i.e. it is tethered, talking over a wire-less link, or otherwise connected to the gaming environment 524), either the motion services component 526 or event manager 136 running on the gaming environment 524 captures the event. Alternatively, if the motion device 522 uses a computing platform and it is interrupted, the motion services component 526 captures the interrupt.

3. When the motion services component 526 captures the interrupt, they then send a message, event or make a function call to the gaming environment 524. This communication may go to the event manager 536 or directly to the gaming environment 524.

4. When receiving the event from either the event manager or the motion services component 126 the gaming environment 124 is able to optionally react to the event. For example in the case where an action figure sends an ‘arm down’ event, a car racing game may use the signal as the start of the car race, etc.

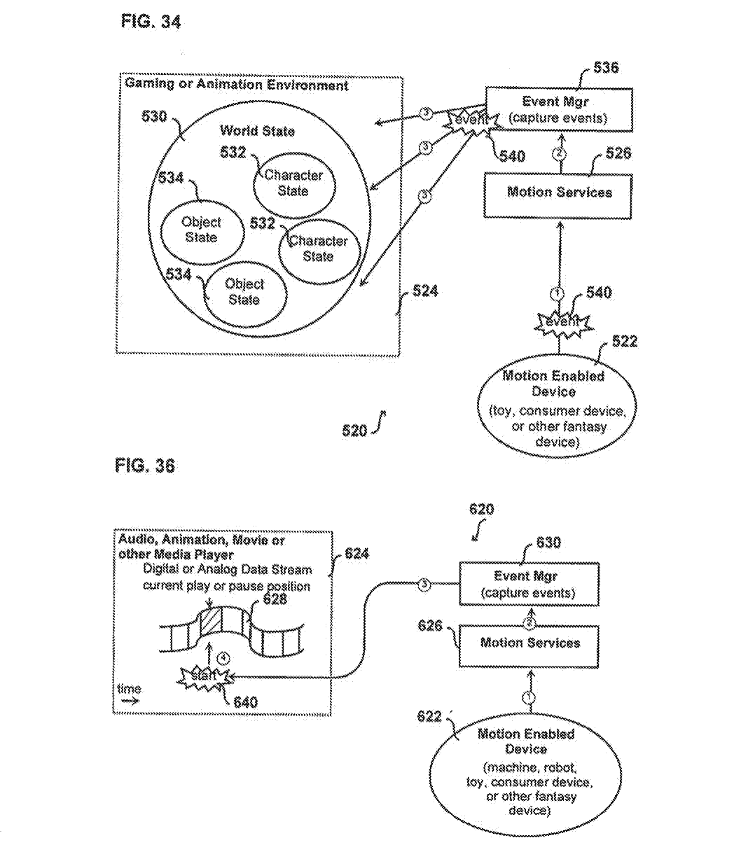

The process of detecting manual events will now be described with reference to FIG. 34. Unlike automatic motion events 540, manual motion events 540 can occur on the device causing an interrupt on any computing platform. Instead, the event manager 536 is configured to detect certain states on the motion device 522. Once detected, the event manager 536 sends the motion event 540 to the gaming environment. For example, if the event manager 536 detects that an action figure's arm has moved from the up position to the down position, the event manager 536 would send the motion event 540 to the gaming environment 524 notifying it that the ‘arm down’ action had occurred.

Either the motion services component 526 or the event manager 536 could run on a computing platform based motion device 522 or on the computing platform where the gaming environment 524 resides. In any case, the computing platform where on which both reside would need to have the ability to communicate with the motion device 522 to determine its states.

The following steps occur when manual motion events 540 are used.

1. A state change occurs in the motion device 522.

2. The motion services component 526 either detects through an interrupt the state change or via a polling method where several states are periodically queried from the physical device 522.

3. The event manager 536 is either directly notified of the state change or it is configured to poll the motion services component 526 by periodically querying it for stage change. If the state changes match certain motion events 640 configured in the event manager 536 then the appropriate event is fired to the gaming environment 524. See U.S. Patent Application No. 60/267,645, filed on Feb. 9, 2001, (Event Management Systems and Methods for Motion Control) for more information on how motion events 540 may be detected. The contents of the '645 application are incorporated herein by reference.

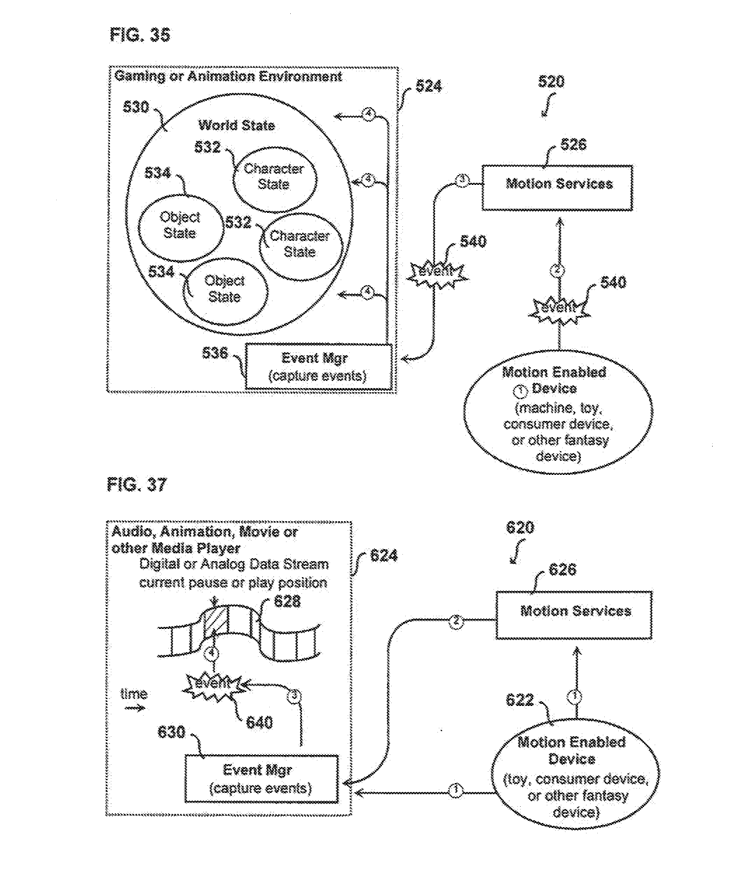

As shown in FIG. 35, another way of supporting manual motion events 540 is to build the event manager 536 technology into the gaming environment 524. The following steps occur when built-in manual motion events 540 are used.

1. The physical device 522 has a state change.

2. On the state change, either the physical device 522 causes an interrupt that is caught by the motion services component 526, or the motion services component 526 polls the device (or machine) for state change.

3. Upon detecting a state change, the motion services component 526 notifies the event manager 536. Alternatively the event manager 536 may poll the motion services component 526 for state changes by periodically querying it for stage change.

4. Upon receiving a state change that matches a configured event, the event manager 536 fires the motion event 540 associated with the state change to the gaming environment 524. See Event Management Systems and Methods for Motion Control, Ser. No. 60/267,645, filed on Feb. 9, 2001, for more information on how motion events 540 may be detected.

### Motion Event Driven Media System

As shown in FIGS. 36 and 37, physical motion events may be used in a similar manner to that of a gaming environment to alter or drive the way a media environment runs. The term “media environment” will be used herein to refer to audio, video, or other non-motion media (i.e. Flash). Upon receiving certain motion events, the media stream may be stopped, fast forwarded, reversed, run, paused, or otherwise changed.

For example, a digital movie may be in the pause position until an animatronic toy moves its head up and down at which point the state changes would cause the motion event directing the media player to start the movie. As with a gaming environment, a media system can support both manual and automatic motion events.

Referring initially to FIG. 36 of the drawing, that figure illustrates that the motion event driven media system 620 comprises a motion enabled device 622 (the motion device 622), an audio, animation, movie, or other media player environment 624 (the media player environment 624), and a motion services component 626. The media player environment 624 plays back a digital or analog media data stream 628. The system 620 may optionally further comprise an event manager 630. The motion device 622 is capable of generating a motion event 640.

To support a manual event, state changes are detected by the motion services component 626 associated with the motion device 622. Once the motion services component 626 detects a state change, the event manager 636 is notified; the event manager 636 in turn sends the motion event 640 to the media player environment 624 so that it may optionally change the way the media data stream 628 is played.

FIG. 36 depicts the steps that are performed when a motion device 622 fires a manual event to cause physical motion.

1. First, a state change occurs in the motion device 622 which is either signaled to the motion services component 626 through an interrupt or detected by the motion services component 626 via polling.

2. Next the event manager 636 is either interrupted by the motion services component 626 of the state change or the event manager 636 polls for the state change. (see Event Management Systems and Methods for Motion Control, Ser. No. 60/267,645, filed on Feb. 9, 2001) The event manager 636 captures the motion events 640 and run associated motion operations and/or programs on the media player environment 624.

3. When detecting a state change, the event manager 636 fires the motion event 640 associated with the state change to the media player environment 624.

4. When receiving the event, the media player environment 624 may optionally alter the way the media data stream 628 is played.

Referring now to FIG. 37, depicted therein is the process of detecting automatic motion events. Automatic motion events are similar to manual events. In the case of automatic events, the event manager 636 is built into the media player environment 624, and the media player environment 624 may optionally be directly notified of each event 640.

The following steps describe how a physical motion state change cause changes in the way media data stream 628 is played.

1. First the physical device 622 has a state change and fires an interrupt or other type of event to either the motion services component 626 or the event manager 636 directly.

2. If the motion services component 626 captures the interrupt or event describing the state change, the signal is passed to the event manager 636.

3. The internal event manager 636 is used to map the motion event 640 to an associated event that is to be sent to the media player environment 624. This process is described in more detail in U.S. Patent Application Ser. No. 60/267,645 (Event Management Systems and Methods for Motion Control) filed Feb. 9, 2001, which is incorporated herein by reference.

4. When received, the media player environment 624 optionally alters how the media data stream 628 is played.

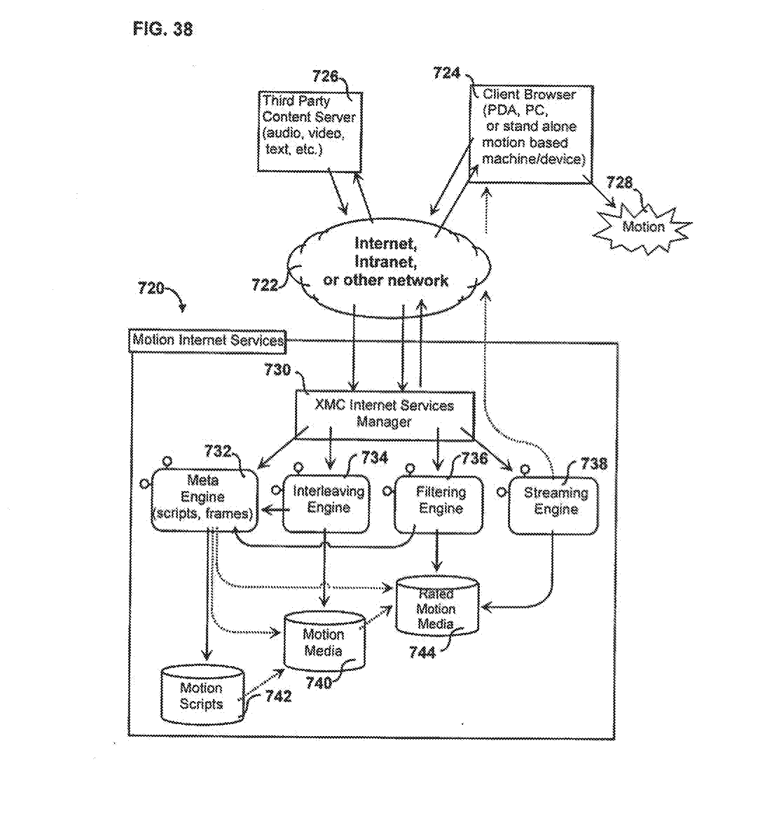

Referring to FIG. 38 of the drawing, shown at 720 therein is another example control software system that is adapted to generate, distribute, and collect motion content in the form of motion media over a distributed network 722 from and to a client browser 724 and a content server 726.

The distributed network 722 can be any conventional computer network such as a private intranet, the Internet, or other specialized or proprietary network configuration such as those found in the industrial automation market (e.g., CAN bus, DeviceNet, FieldBus, ProfiBus, Ethernet, Deterministic Ethernet, etc). The distributed network 722 serves as a communications link that allows data to flow among the control software system 720, the client browser 724, and the content server 726.

The client browsers 724 are associated with motion systems or devices that are owned and/or operated by end users. The client browser 24 includes or is connected to what will be referred to herein as the target device. The target device may be a hand-held PDA used to control a motion system, a personal computer used to control a motion system, an industrial machine, an electronic toy or any other type of motion based system that, at a minimum, causes physical motion. The client browser 724 is capable of playing motion media from any number of sources and also responds to requests for motion data from other sources such as the control software system 720. The exemplary client browser 724 receives motion data from the control software system 720.

The target device forming part of or connected to the client browser 724 is a machine or other system that, at a minimum, receives motion content instructions to run (control and configuration content) and query requests (query content). Each content type causes an action to occur on the client browser 724 such as changing the client browser's state, causing physical motion, and/or querying values from the client browser. In addition, the target device at the client browser 724 may perform other functions such as playing audio and/or displaying video or animated graphics.

The term “motion media” will be used herein to refer to a data set that describes the target device settings or actions currently taking place and/or directs the client browser 724 to perform a motion-related operation. The client browser 724 is usually considered a client of the host control software system 720; while one client browser 724 is shown, multiple client browsers will commonly be supported by the system 720. In the following discussion and incorporated materials, the roles of the system 720 and client browser 724 may be reversed such that the client browser functions as the host and the system 720 is the client.

Often, but not necessarily, the end users will not have the expertise or facilities necessary to develop motion media. In this case, motion media may be generated based on a motion program developed by the content providers operating the content servers 726. The content server systems 726 thus provides motion content in the form of a motion program from which the control software system 720 produces motion media that is supplied to the client browser 724.

The content server systems 726 are also considered clients of the control software system 720, and many such server systems 726 will commonly be supported by the system 720. The content server 726 may be, but is not necessarily, operated by the same party that operates the control software system 720.

One of the exhibits attached hereto further describes the use of the content server systems 726 in communications networks. As described in more detail in the attached exhibit, the content server system 726 synchronizes and schedules the generation and distribution of motion media.

Synchronization may be implemented using host to device synchronization or device to device synchronization; in either case, synchronization ensures that movement associated with one client browser 724 is coordinated in time with movement controlled by another client browser 724.

Scheduling refers to the communication of motion media at a particular point in time. In host scheduling and broadcasting, a host machine is configured to broadcast motion media at scheduled points in time in a manner similar to television programming. With target scheduling, the target device requests and runs content from the host at a predetermined time, with the predetermined time being controlled and stored at the target device.

As briefly discussed above, the motion media used by the client browser 724 may be created and distributed by other systems and methods, but the control software system 720 described herein makes creation and distribution of such motion media practical and economically feasible.

Motion media comprises several content forms or data types, including query content, configuration content, control content, and/or combinations thereof. Configuration content refers to data used to configure the client browser 724. Query content refers to data read from the client browser 724. Control content refers to data used to control the client browser 724 to perform a desired motion task as schematically indicated at 728 in FIG. 38.

Content providers may provide non-motion data such as one or more of audio, video, Shockwave or Flash animated graphics, and various other types of data. In a preferred example, the control software system 720 is capable of merging motion data with such non-motion data to obtain a special form of motion media; in particular, motion media that includes non-motion data will be referred to herein as enhanced motion media.

The present invention is of particular significance when the motion media is generated from the motion program using a hardware independent model such as that disclosed in U.S. Pat. Nos. 5,691,897 and 5,867,385 issued to the present Applicant, and the disclosure in these patents is incorporated herein by reference. However, the present invention also has application when the motion media is generated, in a conventional manner, from a motion program specifically written for a particular hardware device.

As will be described in further detail below, the control software system 720 performs one or more of the following functions. The control software system 720 initiates a data connection between the control software system 720 and the client browser 724. The control software system 720 also creates motion media based on input, in the form of a motion program, from the content server system 726. The control software system 720 further delivers motion media to the client browser 724 as either dynamic motion media or static motion media. Dynamic motion media is created by the system 720 as and when requested, while static motion media is created and then stored in a persistent storage location for later retrieval.

Referring again to FIG. 38, the exemplary control software system 720 comprises a services manager 730, a meta engine 732, an interleaving engine 734, a filtering engine 736, and a streaming engine 738. In the exemplary system 720, the motion media is stored at a location 740, motion scripts are stored at a location 742, while rated motion data is stored at a location 744. The storage locations may be one physical device or even one location if only one type of storage is required.

Not all of these components are required in a given control software system constructed in accordance with the present invention. For example, if a given control software system is intended to deliver only motion media and not enhanced motion media, the interleaving engine 734 may be omitted or disabled. Or if the system designer is not concerned with controlling the distribution of motion media based on content rules, the filtering engine 736 and rated motion storage location 744 may be omitted or disabled.

The services manager 730 is a software module that is responsible for coordinating all other modules comprising the control software system 720. The services manager 730 is also the main interface to all clients across the network.

The meta engine 732 is responsible for arranging all motion data, including queries, configuration, and control actions, into discrete motion packets. The meta engine 732 further groups motion packets into motion frames that make up the smallest number of motion packets that must execute together to ensure reliable operation. If reliability is not a concern, each motion frame may contain only one packet of motion data—i.e. one motion instruction. The meta engine 732 still further groups motion frames into motion scripts that make up a sequence of motion operations to be carried out by the target motion system. These motion packets and motion scripts form the motion media described above. The process of forming motion frames and motion scripts is described in more detail in an exhibit attached hereto.

The interleaving engine 734 is responsible for merging motion media, which includes motion frames comprising motion packets, with non-motion data. The merging of motion media with non-motion data is described in further detail in an exhibit attached hereto.

Motion frames are mixed with other non-motion data either on a time basis, a packet or data size basis, or a packet count basis. When mixing frames of motion with other media on a time basis, motion frames are synchronized with other data so that motion operations appear to occur in sync with the other media. For example, when playing a motion/audio mix, the target motion system may be controlled to move in sync with the audio sounds.

After merging data related to non-motion data (e.g., audio, video, etc) with data related to motion, a new data set is created. As discussed above, this new data set combining motion media with non-motion data will be referred to herein as enhanced motion media.

More specifically, the interleaving engine 734 forms enhanced motion media in one of two ways depending upon the capabilities of the target device at the client browser 722. When requested to use a non-motion format (as the default format) by either a third party content site or even the target device itself, motion frames are injected into the non-motion media. Otherwise, the interleaving engine 734 injects the non-motion media into the motion media as a special motion command of ‘raw data’ or specifies the non-motion data type (ie ‘audio-data’, or ‘video-data’). By default, the interleaving engine 734 creates enhanced motion media by injecting motion data into non-motion data.

The filtering engine 736 injects rating data into the motion media data sets. The rating data, which is stored at the rating data storage location 744, is preferably injected at the beginning of each script or frame that comprises the motion media. The client browser 722 may contain rating rules and, if desired, filters all received motion media based on these rules to obtain filtered motion media.

In particular, client browser 722 compares the rating data contained in the received motion media with the ratings rules stored at the browser 722. The client browser 722 will accept motion media on a frame by frame or script basis when the ratings data falls within the parameters embodied by the ratings rules. The client browser will reject, wholly or in part, media on a frame by frame or script basis when the ratings data is outside the parameters embodied by the ratings rules.

In another example, the filtering engine 736 may be configured to dynamically filter motion media when broadcasting rated motion data. The modification or suppression of inappropriate motion content in the motion media is thus performed at the filtering engine 736. In particular, the filtering engine 736 either prevents transmission of or downgrades the rating of the transmitted motion media such that the motion media that reaches the client browser 722 matches the rating rules at the browser 722.

Motion media is downgraded by substituting frames that fall within the target system rating rules for frames that do not fall within the target system's rating. The filtering engine 736 thus produces a data set that will be referred to herein as the rated motion media, or rated enhanced motion media if the motion media includes non-motion data.

The streaming engine 738 takes the final data set (whether raw motion scripts, enhanced motion media, rated motion media, or rated enhanced motion media) and transmits this final data set to the client browser 722. In particular, in a live-update session, the final data set is sent in its entirety to the client browser 722 and thus to the target device associated therewith. When streaming the data to the target device, the data set is sent continually to the target device.

Optionally, the target system will buffer data until there is enough data to play ahead of the remaining motion stream received in order to maintain continuous media play. This is optional for the target device may also choose to play each frame as it is received yet network speeds may degrade the ability to play media in a continuous manner. This process may continue until the motion media data set ends, or, when dynamically generated, the motion media may play indefinitely.

One method of implementing the filtering engine 736 is depicted in an exhibit attached hereto. Another exhibit attached hereto describes the target and host filtering models and the target key and content type content filtering models.

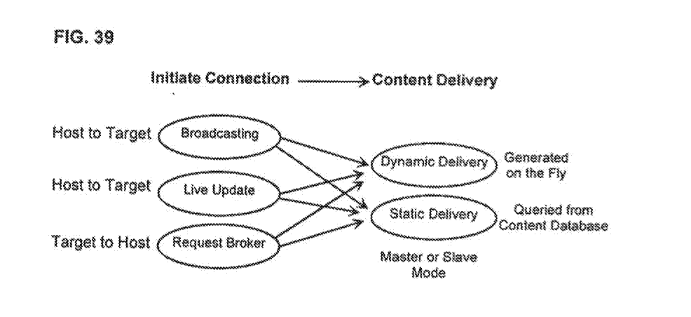

Referring now to FIG. 39, depicted therein is a block diagram illustrating the various forms in which data may be communicated among the host system software 720 and the target device at the client browser 722. Before any data can be sent between the host and the target, the network connection between the two must be initiated. There are several ways in which this initiation process takes place. As shown in FIG. 39, this initiation process may be accomplished by broadcasting, live update, and request broker.

In addition, FIG. 39 also shows that, once the connection is initiated between the host and target systems, the content delivery may occur dynamically or via a static pool of already created content. When delivering dynamic content, the content may be sent via requests from a third party content site in a slave mode, where the third party requests motion media from the host on behalf of the target system. Or the dynamic content may be delivered in a master mode where the target system makes direct requests for motion media from the host where the motion services reside.

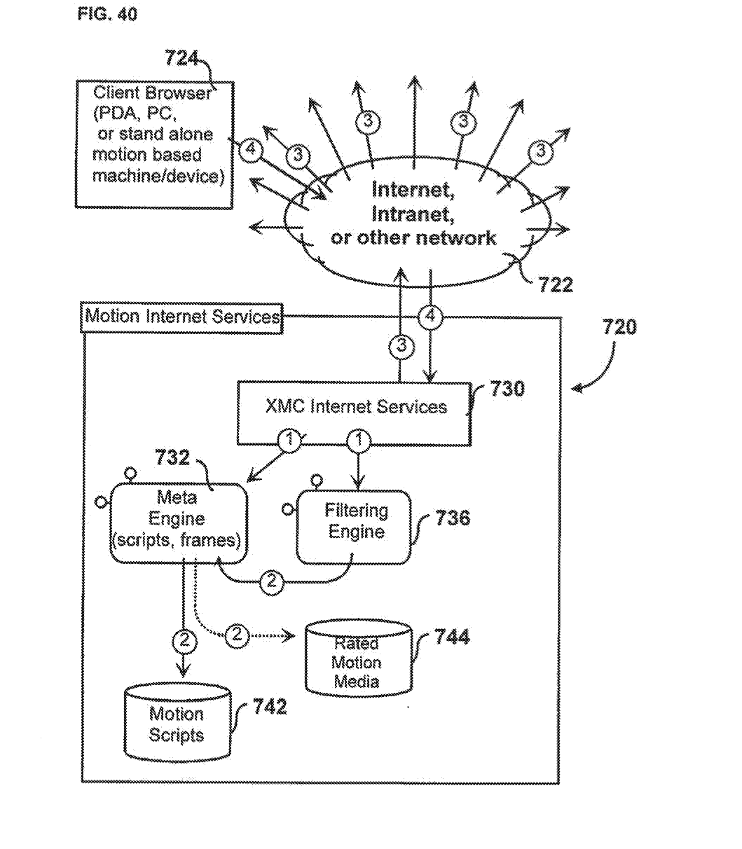

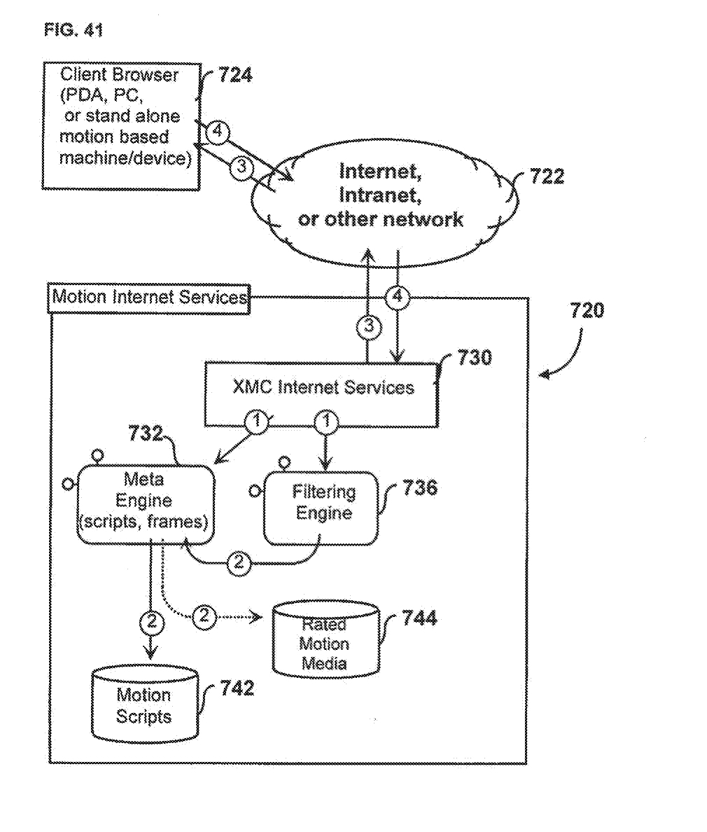

In the following discussion, the scenario maps depicted in FIGS. 40-45 will be explained in further detail. These scenario maps depict a number of scenarios in which the control software system 720 may operate.

Referring initially to FIG. 40, depicted therein is a scenario map that describes the broadcasting process in which the host sends information across the network to all targets possible, notifying each that the host is ready to initiate a connection to transmit motion media. Broadcasting consists of initiating a connection with a client by notifying all clients of the host's existence via a connectionless protocol by sending data via the User Diagram Protocol (or UDP). The UDP is a connectionless protocol standard that is part of the standard TCP/IP family of Internet protocols. Once notified that the host has motion media to serve, each target can then respond with an acceptance to complete the connection. The broadcasting process is also disclosed in exhibits attached hereto.

The following steps occur when initiating a connection via broadcasting.

First, before broadcasting any data, the services manager 730 queries the meta engine 732 and the filter engine 736 for the content available and its rating information.

Second, when queried, the filter engine 736 gains access to the enhanced or non-enhanced motion media via the meta engine 732. The filtering engine 736 extracts the rating data and serves this up to the internet services manager 730.

Third, a motion media descriptor is built and sent out across the network. The media descriptor may contain data as simple as a list of ratings for the rated media served. Or the descriptor may contain more extensive data such as the type of media categories supported (i.e., medias for two legged and four legged toys available). This information is blindly sent across the network using a connectionless protocol. There is no guarantee that any of the targets will receive the broadcast. As discussed above, rating data is optional and, if not used, only header information is sent to the target.

Fourth, if a target receives the broadcast, the content rating meets the target rating criteria, and the target is open for a connection, the connection is completed when the target sends an acknowledgement message to the host. Upon receiving the acknowledgement message, the connection is made between host and target and the host begins preparing for dynamic or static content delivery.

Referring now to FIG. 41, depicted therein is a scenario map illustrating the process of live update connection initiation. A live update connection is a connection based on pre-defined criteria between a host and a target in which the target is previously registered or “known” and the host sends a notification message directly to the known target. The process of live update connection initiation is also disclosed in exhibits attached to this application.

The following steps take place when performing a live-update.

First, the internet services manager 730 collects the motion media and rating information. The motion media information collected is based on information previously registered by a known or pre-registered target. For example, say the target registers itself as a two-legged toy—in such a case the host would only collect data on two-legged motion media and ignore all other categories of motion media.

Second, when queried, the filtering engine 736 in turn queries the meta engine 732 for the raw rating information. In addition, the meta engine 732 queries header information on the motion media to be sent via the live update.

Third, the motion media header information along and its associated rating information are sent to the target system. If rating information is not used, only the header information is sent to the target.

Fourth, the target system either accepts or rejects the motion media based on its rating or other circumstances, such as the target system is already busy running motion media.

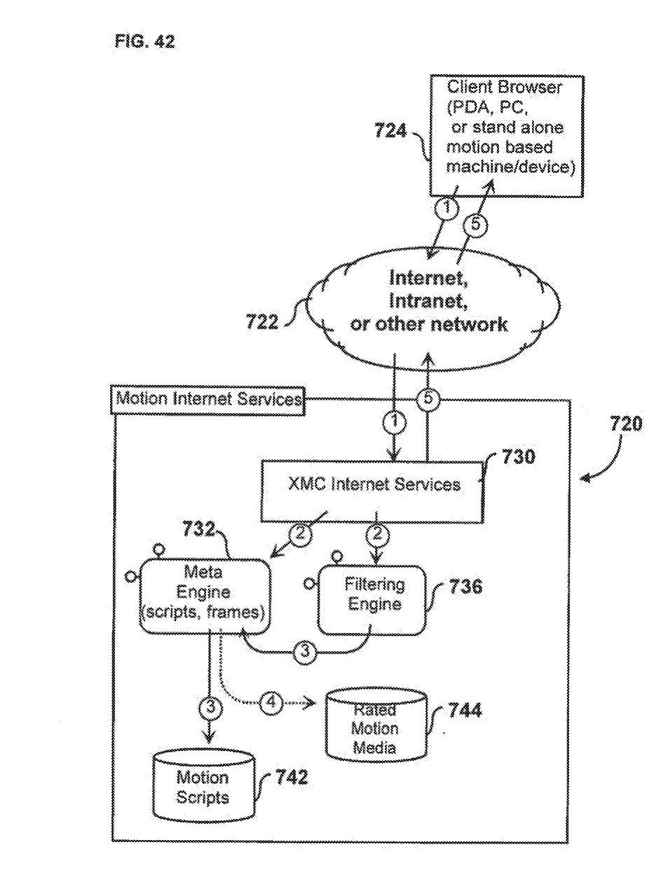

FIG. 42 describes the process of request brokering in master mode in which the target initiates a connection with the host by requesting motion media from the host.

First, to initiate the request broker connection, the target notifies the host that it would like to have a motion media data set delivered. If the target supports content filtering, it also sends the highest rating that it can accept (or the highest that it would like to accept based on the target system's operator input or other parameters) and whether or not to reject or downgrade the media based on the rating.

Second, the services manager 730 queries the meta engine 732 for the requested media and then queries the filter engine 736 to compare the requested rating with that of the content. If the rating does not meet the criteria of the rating rules, the Filter Engine uses the content header downsizing support info to perform Rating Content Downsizing.

Third, the meta engine 732 collects all header information for the requested motion media and returns it to the services manager 730.

Fourth, if ratings are supported, the meta engine 732 also queries all raw rating information from the rated motion media 744. When ratings are used, the rated motion media 744 is used exclusively if available. If the media is already rated, the rated media is sent out. If filtering is not supported on the content server the rating information is ignored and the Raw Motion Scripts or Motion Media data are used.

Fifth, the motion media header information and rating information (if available) are sent back to the requesting target device, which in turn either accepts the connection or rejects it. If accepted, a notice is sent back to the services manager 730 directing it to start preparing for a content delivery session.

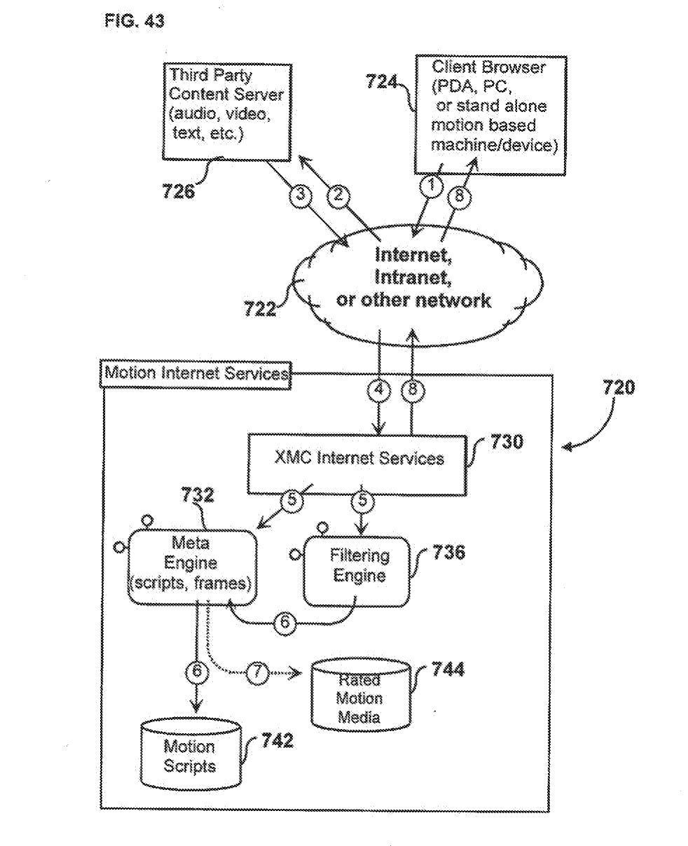

FIG. 43 describes request broker connection initiation in slave mode. In slave mode connection initiation, the target initiates a connection with the third party content server 726, which in turn initiates a connection with the host on behalf of the target system. Request brokering in slave mode is similar to request brokering in master mode, except that the target system communicates directly with a third party content server 726 instead of with the host system.

Slave mode is of particular significance when the third party content site is used to drive the motion content generation. For example, motion media may be generated based on non-motion data generated by the third party content site. A music site may send audio sounds to the host system, which in turn generates motions based on the audio sounds.

The following steps occur when request brokering in slave mode.

First, the target system requests content from the third party content server (e.g., requests a song to play on the toy connected to, or part of the target system).

Second, upon receiving the request, the third party content server locates the song requested.

Third, the third party content server 726 then sends the song name, and possibly the requested associated motion script(s), to the host system 720 where the motion internet service manager 730 resides.

Fourth, upon receiving the content headers from the third party content server 726, the services manager 730 locates the rating information (if any) and requested motion scripts.

Fifth, rating information is sent to the filtering engine 736 to verify that the motion media is appropriate and the requested motion script information is sent to the meta engine 732.

Sixth, the filtering engine 736 extracts the rating information from the requested motion media and compares it against the rating requirements of the target system obtained via the third party content server 726. The meta engine also collects motion media header information.

Seventh, the meta engine 732 extracts rating information from the rated motion media on behalf of the filtering engine 736.

Eighth, either the third party content server is notified, or the target system is notified directly, whether or not the content is available and whether or not it meets the rating requirements of the target. The target either accepts or rejects the connection based on the response. If accepted, the motion internet services begin preparing for content delivery.

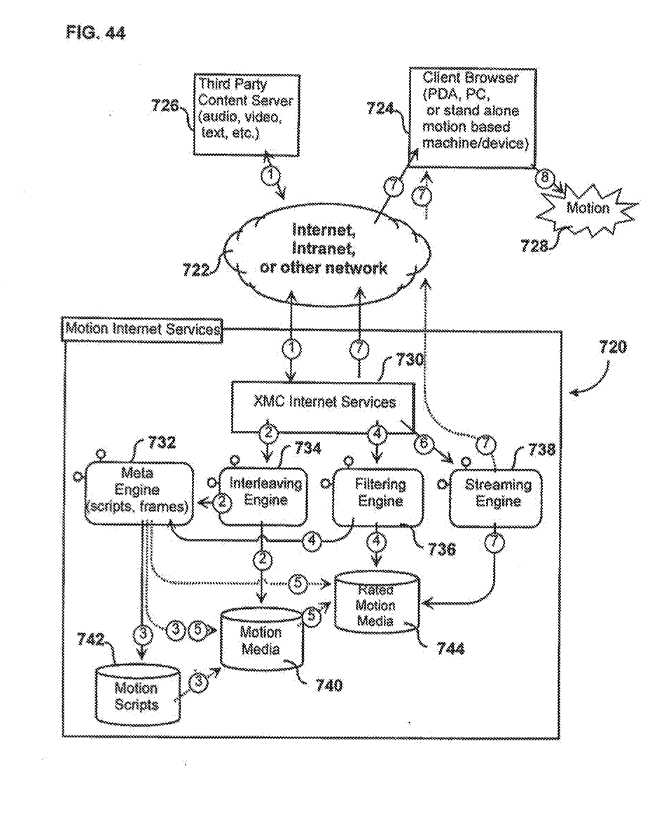

FIG. 44 describes how the host dynamically creates motion media and serves it up to the target system. Once a connection is initiated between host and target, the content delivery begins. Dynamic content delivery involves actually creating the enhanced motion media in real time by mixing motion scripts (either pre-created scripts or dynamically generated scripts) with external media (ie audio, video, etc). In addition, if rating downgrading is requested, the media is adjusted to meet the rating requirements of the target system.

The following steps occur when delivering dynamic content from the host to the target.

In the first step, either content from the third party content server is sent to the host or the host is requested to inject motion media into content managed by the third party content server. The remaining steps are specifically directed to the situation in which content from the third party content server is sent to the host, but the same general logic may be applied to the other situation.

Second, upon receiving the content connection with the third party content server, the services manager 730 directs the interleaving engine 734 to begin mixing the non-motion data (ie audio, video, flash graphics, etc) with the motion scripts.

Third, the interleaving engine 734 uses the meta engine 732 to access the motion scripts. As directed by the interleaving engine 734, the meta engine 732 injects all non-motion data between scripts and/or frames of motion based on the interleaving algorithm (ie time based, data size based or packet count based interleaving) used by the interleaving engine 734. This transforms the motion media data set into the enhanced motion media data set.

Fourth, if ratings are used and downgrading based on the target rating criteria is requested, the filtering engine 736 requests the meta engine 732 to select and replace rejected content based on rating with an equal operation with a lower rating. For example, a less violent move having a lower rating may be substituted for a more violent move having a higher rating. The rated enhanced data set is stored as the rated motion media at the location 744. As discussed above, this step is optional because the service manager 730 may not support content rating.

Fifth, the meta engine 732 generates a final motion media data set as requested by the filtering engine 36.

Sixth, the resulting final motion media data set (containing either enhanced motion media or rated enhanced motion media) is passed to the streaming engine 738. The streaming engine 738 in turn transmits the final data set to the target system.

Seventh, in the case of a small data set, the data may be sent in its entirety before actually played by the target system. For larger data sets (or continually created infinite data sets) the streaming engine sends all data to the target as a data stream.

Eighth, the target buffers all data up to a point where playing the data does not catch up to the buffering of new data, thus allowing the target to continually run motion media.

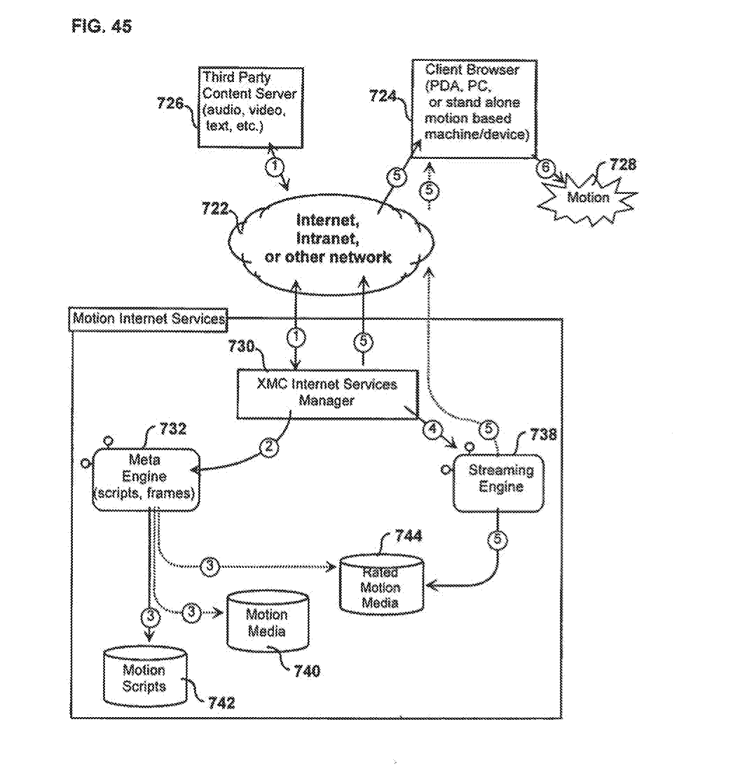

FIG. 45 describes how the host serves up pre-created or static motion media to the target system. Static content delivery is similar to dynamic delivery except that all data is prepared before the request is received from the target. Content is not created on the fly, or in real time, with static content.

The following steps occur when delivering static content from the host to the target.

In the first step, either motion media from the third party content server 726 is sent to the host or the host is requested to retrieve already created motion media. The remaining steps are specifically to the situation in which the host is requested to retrieve already created motion media, but the same general logic may be applied to the other situation.

Second, upon receiving the content connection with the third party content server, the services manager 730 directs the meta engine 732 to retrieve the motion media.

Third, the meta engine 732 retrieves the final motion media data set and returns the location to the services manager 730. Again, the final motion set may include motion scripts, enhanced motion media, rated motion media, or enhanced rated motion media.

Fourth, the final data motion media data set is passed to the streaming engine 738, which in turn feeds the data to the target system.

Fifth, again in the case of a small data set, the data may be sent in its entirety before actually played by the target system. For larger data sets (or continually created infinite data sets) the streaming engine sends all data to the target as a data stream.

Sixth, the target buffers all data up to a point where playing the data does not catch up to the buffering of new data, thus allowing the target to continually run motion media.

The control software system 720 described herein can be used in a wide variety of environments. The following discussion will describe how this system 720 may be used in accordance with several operating models and in several exemplary environments. In particular, the software system 720 may be implemented in the broadcasting model, request brokering model, or the autonomous distribution model. Examples of how each of these models applies in a number of different environments will be set forth below.

The broadcast model, in which a host machine is used to create and store a large collection of data sets that are then deployed out to a set of many target devices that may or may not be listening, may be used in a number of environments. The broadcast model is similar to a radio station that broadcasts data out to a set of radios used to hear the data transmitted by the radio station.

The broadcasting model may be implemented in the several areas of industrial automation. For example, the host machine may be used to generate data sets that are used to control machines on the factory floor. Each data set may be created by the host machine by translating engineering drawings from a known format (such as the data formats supported by AutoCad or other popular CAD packages) into the data sets that are then stored and eventually broadcast to a set of target devices. Each target device may be the same type of machine. Broadcasting data sets to all machines of the same type allows the factory to produce a larger set of products. For example, each target device may be a milling machine. Data sets sent to the group of milling machines would cause each machine to simultaneously manufacture the same part thus producing more than one of the same part simultaneously thus boosting productivity.

Also, industrial automation often involves program distribution, in which data sets are translated from an engineering drawing that is sent to the host machine via an Internet (or other network) link. Once received the host would translate the data into the type of machine run at one of many machine shops selected by the end user. After translation completes, the data set would then be sent across the data link to the target device at the designated machine shop, where the target device may be a milling machine or lathe. Upon receiving the data set, the target device would create the mechanical part by executing the sequence of motions defined by the data set. Once created the machine shop would send the part via mail to the user who originally sent their engineering drawing to the host. This model has the benefit of giving the end user an infinite number of machine shops to choose from to create their drawing. On the other hand, this model also gives the machine shops a very large source of business that sends them data sets tailored specifically for the machines that they run in their shop.

The broadcasting model of the present invention may also be of particular significance during environmental monitoring and sampling. For example, in the environmental market, a large set of target devices may be used in either the monitoring or collection processes related to environmental clean up. In this example, a set of devices may be used to stir a pool of water along different points on a river, where the stirring process may be a key element in improving the data collection at each point. A host machine may generate a data set that is used to both stir the water and then read from a set of sensors in a very precise manner. Once created the data set is broadcast by the host machine to all devices along the river at the same time to make a simultaneous reading from all devices along the river thus giving a more accurate picture in time on what the actual waste levels are in the river.

The broadcasting model may also be of significance in the agriculture industry. For example, a farmer may own five different crop fields that each requires a different farming method. The host machine is used to create each data set specific to the field farmed. Once created, the host machine would broadcast each data set to a target device assigned to each field. Each target device would be configured to only listen to a specific data channel assigned to it. Upon receiving data sets across its assigned data channel, the target device would execute the data set by running each meta command to perform the tilling or other farming methods used to harvest or maintain the field. Target devices in this case may be in the form of standard farming equipment retrofitted with motors, drives, a motion controller, and an software kernel (such as the XMC real-time kernel) used to control each by executing each meta command. The farming operations that may be implemented using the principles of the present invention include watering, inspecting crops, fertilizing crops and/or harvesting crops.

The broadcasting model may also be used in the retail sales industry. For example, the target devices may be a set of mannequins that are employ simple motors, drives, a motion controller, and a software kernel used to run meta commands. The host machine may create data sets (or use ones that have already been created) that are synchronized with music selections that are about to play in the area of the target mannequins. The host machine is then used to broadcast the data sets in a manner that will allow the target device to dance (or move) in a manner that is in sync with the music playing thus giving the illusion that the target device is dancing to the music. This example is useful for the retailer for this form of entertainment attracts attention toward the mannequin and eventually the clothes that it wears. The host machine may send data sets to the target mannequin either over a hard wire network (such as Ethernet), across a wireless link, or some other data link. Wireless links would allow the mannequins to receive updates while still maintaining easy relocation.

The broadcasting model may also be used in the entertainment industry. One example is to use the present invention as part of a biofeedback system. The target devices may be in the form of a person, animal or even a normally inanimate object. The host machine may create data sets in a manner that creates a feedback loop. For example a band may be playing music that the host machine detects and translates into a sequence of coordinated meta commands that make up a stream (or live update) of data. The data stream would then be broadcast to a set of target devices that would in-turn move in rhythm to the music. Other forms of input that may be used to generate sequences of meta commands may be some of the following: music from a standard sound system; heat detected from a group of people (such as a group of people dancing on a dance floor); and/or the level of noise generated from a group of people (such as an audience listening to a rock band).

The broadcasting model may also have direct application to consumers. In particular, the present invention may form part of a security system. The target device may be something as simple as a set of home furniture that has been retrofitted with a set of small motion system that is capable of running meta commands. The host machine would be used to detect external events that are construed to be compromising of the residence security. When detected motion sequences would be generated and transmitted to the target furniture, thus giving the intruder the impression that the residence is occupied thus reducing the chance of theft. Another target device may be a set of curtains. Adding a sequence of motion that mimics that of a person repeatedly pulling on a line to draw the curtains could give the illusion that a person was occupying the residence.

The broadcasting model may also be applied to toys and games. For example, the target device may be in the form of an action figures (such as GI Joe, Barbie and/or Start Wars figures). The host machine in this case would be used to generate sequences of motion that are sent to each target device and then played by the end user of the toy. Since the data sets can be hardware independent, a particular data set may work with a wide range of toys built by many different manufacturers. For example, GI Joe may be build with hardware that implements motion in a manner that is very different from the way that Barbie implements or uses motion hardware. Using the motion kernel to translate all data from hardware independent meta commands to hardware specific logic use to control each motor, both toys could run off the same data set. Combining this model with the live updates and streaming technology each toy could receive and run the same data set from a centralized host.

The request brokering model also allows the present invention to be employed in a number of environments. Request brokering is the process of the target device requesting data sets from the host who in turn performs a live update or streaming of the data requested to the target device.

Request brokering may also be applied to industrial automation. For example, the present invention implemented using the request brokering model may be used to perform interactive maintenance. In this case, the target device may be a lathe, milling machine, or custom device using motion on the factory floor. When running data sets already broadcast to the device, the target device may be configured to detect situations that may eventually cause mechanical breakdown of internal parts or burnout of electronic parts such as motors. When such situations are detected, the target device may request for the host to update the device with a different data set that does not stress the parts as much as those currently being executed. Such a model could improve the lifetime of each target device on the factory floor.

Another example of the request brokering model in the industrial automation environment is to the material flow process. The target device in this example may be a custom device using motion on the factory floor to move different types of materials into a complicated process performed by the device that also uses motion. Upon detecting the type of material the target device may optionally request a new live update or streaming of data that performs the operations special to the specific type of material. Once requested, the host would transmit the new data set to the device that would in turn execute the new meta commands thus processing the material properly. This model would extend the usability of each target device for each could be used on more than one type of material and/or part and/or process.

The request brokering model may also be applied to the retail industry. In one example, the target device would be a mannequin or other target device use to display or draw attention to wares sold by a retailer. Using a sensor to detect location within a building or other space (i.e. a global positioning system), the target device could detect when it is moved from location to location. Based on the location of the device, it would request for data sets that pertain to its current location by sending a data request to the host pertaining to the current location. The host machine would then transmit the data requested. Upon receiving the new data, the device would execute it and appear to be location aware by changing its behavior according to its location.

The request brokering model may also be applied to toys and games or entertainment industry. Toys and entertainment devices may also be made location aware. Other devices may be similar to toys or even a blend between a toy and a mannequin but used in a more adult setting where the device interacts with adults in a manner based on the device's location. Also biofeedback aware toys and entertainment devices may detect the tone of voice used or sense the amount of pressure applied to the toy by the user and then use this information to request a new data set (or group of data sets) to alter its behavior thus appearing situation aware. Entertainment devices may be similar to toys or even mannequins but used in a manner to interact with adults based on biofeedback, noise, music, etc.

The autonomous distribution model may also be applied to a number of environments. The autonomous distribution model is where each device performs both host and target device tasks. Each device can create, store and transmit data like a host machine yet also receive and execute data like a target device.

In industrial automation, the autonomous distribution model may be implemented to divide and conquer a problem. In this application, a set of devices is initially configured with data sets specific to different areas making up the overall solution of the problem. The host machine would assign each device a specific data channel and perform the initial setup across it. Once configured with its initial data sets, each device would begin performing their portion of the overall solution. Using situation aware technologies such as location detection and other sensor input, each target device would collaborate with one another where their solution spaces cross or otherwise overlap. Each device would not only execute its initial data set but also learn from its current situation (location, progress, etc) and generate new data sets that may either apply to itself or transmitted to other devices to run.

In addition, based on the devices situation, the device may request new data sets from other devices in its vicinity in a manner that helps each device collaborate and learn from one another. For example, in an auto plant there may be one device that is used to weld the doors on a car and another device used to install the windows. Once the welding device completes welding it may transmit a small data set to the window installer device thus directing it to start installing the windows. At this point the welding device may start welding a door on a new car.

The autonomous distribution model may also be applied to environmental monitor and control systems. For example, in the context of flow management, each device may be a waste detection device that as a set are deployed at various points along a river. In this example, an up-stream device may detect a certain level of waste that prompts it to create and transmit a data set to a down-stream device thus preparing it for any special operations that need to take place when the new waste stream passes by. For example, a certain type of waste may be difficult to detect and must use a high precision and complex procedure for full detection. An upstream device may detect small traces of the waste type using a less precise method of detection that may be more appropriate for general detection. Once detecting the waste trace, the upstream device would transmit a data set directing the downstream device to change to its more precise detection method for the waste type.

In agriculture, the autonomous distribution model has a number of uses. In one example, the device may be an existing piece of farm equipment used to detect the quality of a certain crop. During detection, the device may detect that the crop needs more water or more fertilizer in a certain area of the field. Upon making this detection, the device may create a new data set for the area that directs another device (the device used for watering or fertilization) to change it's watering and/or fertilization method. Once created the new data set would be transmitted to the target device.

The autonomous distribution model may also be applied to the retail sales environments. Again, a dancing mannequin may be incorporated into the system of the present invention. As the mannequin dances, it may send data requests from mannequins in its area and alter its own meta commands sets so that it dances in better sync with the other mannequins.

Toys and games can also be used with the autonomous distribution model. Toys may work as groups by coordinating their actions with one another. For example, several Barbie dolls may interact with one another in a manner where they dance in sequence or play house.

The following discussion describes several applications that make use of the various technologies disclosed above. In particular, the following examples implement one or more of the following technologies: content type, content options, delivery options, distribution models, and player technologies.

Content type used defines whether the set of data packets are made up of a script of packets consisting of a finite set of packets that are played from start to finish or a stream of packets that are sent to the end device (the player) as a continuous stream of data.

Content options are used to alter the content for special functions that are desired on the end player. For example, content options may be used to interleave motion data packets with other media data packets such as audio, video or analysis data. Other options may be inserted directly into each data packet or added to a stream or script as an additional option data packet. For example, synchronization packets may be inserted into the content directing the player device to synchronize with the content source or even another player device. Other options may be used to define the content type and filtering rules used to allow/disallow playing the content for certain audiences where the content is appropriate.

Delivery options define how the content is sent to the target player device. For example, the user may opt to immediately download the data from an Internet web site (or other network) community for immediate play, or they may choose to schedule a download to their player for immediate play, or they may choose to schedule a download and then schedule a playtime when the data is to be played.

Distribution models define how the data is sent to the end player device that includes how the initial data connection is made. For example, the data source might broadcast the data much in the same way a radio station broadcasts its audio data out to an unknown number of radios that play the data, or the end player device may request the data source to download data in an live-update fashion, or a device may act as a content source and broadcast or serve live requests from other devices.

Player technologies define the technologies used by the player to run and make use of the content data to cause events and actions inside and around the device thus interacting with other devices or the end user. For example, each player may use hardware independent motion or hardware dependent motion to cause movement of arms, legs, or any other type of extrusion on the device. Optionally, the device may use language driver and/or register-map technology in the hardware dependent drivers that it uses in its hardware independent model. In addition, the device may exercise a secure-API technology that only allows the device to perform certain actions within certain user defined (or even device defined) set of boundaries. The player may also support interleaved content data (such as motion and audio) where each content type is played by a subsystem on the device. The device may also support content filtering and/or synchronization.

Referring now to FIG. 45, depicted therein is a diagram illustrating one exemplary configuration for distributing motion data over a computer network such as the World Wide Web. The configuration illustrated in FIG. 45 depicts an interactive application in which the user selects from a set of pre-generated (or generated on the fly) content data sets provided by the content provider on an Internet web site (or other network server).

Users select content from a web site community of users where users collaborate, discuss, and/or trade or sell content. A community is not required, for content may alternatively be selected from a general content listing. Both scripts and streams of content may be selected by the user and immediately downloaded or scheduled to be used at a later point in time by the target player device.

The user may opt to select from several content options that alter the content by mixing it with other content media and/or adding special attribute information that determines how the content is played. For example, the user may choose to mix motion content with audio content, specify to synchronize the content with other players, and/or select the filter criteria for the content that is appropriate for the audience for which it is to be played.

Next, if the content site provides the option, the user may be required to select the delivery method to use when channeling the content to the end device. For example, the user may ‘tune’ into a content broadcast stream where the content options are merged into the content in a live manner as it is broadcast. Or in a more direct use scenario, the user may opt to grab the content as a live update, where the content is sent directly from the data source to the player. A particular content may not give the delivery method as an option and instead provide only one delivery method.

Once on the player, the user may optionally schedule the content play start time. If not scheduled, the data is played immediately. For data that is interleaved, synchronized, or filtered the player performs each of these operations when playing the content. If the instructions within the content data are hardware independent (i.e. velocity and point data) then a hardware independent software model must be employed while playing the data, which can involve the use of a language driver and/or register-map to generify the actual hardware platform.

The device may employ a security mechanism that defines how certain features on the device may be used. For example, if swinging an arm on the toy is not to be allowed or the speed of the arm swing is to be bound to a pre-determined velocity range on a certain toy, the secure api would be setup to disallow such operations.

The following are specific examples of the interactive use model described above.

The first example is that of a moon-walking dog. The moonwalk dance is either a content script or a continuous stream of motion (and optionally audio) that when played on a robotic dog causes the toy dog to move in a manner where it appears to dance “The Moonwalk”. When run with audio, the dog dances to the music played and may even bark or make scratching sounds as it moves its legs, wags its tail and swings its head to the music.

To get the moonwalk dance data, the user must first go the content site (presumably the web site of the toy manufacturer). At the content site, the user is presented with a choice of data types (i.e. a dance script that can be played over and over while disconnected to the content site, or a content stream that is sent to the toy and played as it is received).

A moon-walk stream may contain slight variations of the moon-walk dance that change periodically as the stream is played thus giving the toy dog a more life-like appearance—for its dance would not appear exact and would not repeat itself. Downloading and running a moon-walk script on the other hand would cause the toy dog to always play the exact same dance every time that it was run.

Next, the user optionally selects the content options used to control how the content is to be played. For example, the user may choose to mix the content for the moon-walk dance ‘moves’ with the content containing a certain song. When played, the user sees and hears the dog dance. The user may also configure the toy dog to only play the G-rated versions of the dance so that a child could only download and run those versions and not run dances that were more adult in nature. If the user purchased the moonwalk dance, a required copyright protection key is inserted into the data stream or script at that time. When playing the moonwalk dance, the toy dog first verifies the key making sure that the data indeed has been purchased. This verification is performed on the toy dog using the security key filtering.

If available as an option, the user may select the method of delivery to be used to send data to the device. For example, when using a stream, the user may ‘tune’ into a moonwalk data stream that is already broadcasting using a multi-cast mechanism across the web, or the user may simply connect to a stream that contains the moonwalk dance. To run a moonwalk script, the user performs a live-update to download the script onto the toy dog. The content site can optionally force one delivery method or another merely by what it exposes to the user.

Depending on the level of sophistication of hardware and software in the toy dog, certain content options may be used or ignored. If such support does not exist on the dog, it is ignored. For example, if the dog does not support audio, only motion moves are be played and all audio data are ignored. If audio and motion are both supported, the embedded software on the dog separates the data as needed and plays each data type in sequence thus giving the appearance that both were running at the same time and in sync with one another.

Very sophisticated dogs may run both the audio and motion data using the same or separate modules depending on the implementation of the dog. In addition, depending on the level of hardware sophistication, the toy dog may run each packet immediately as it is received, it may buffer each command and then run as appropriate or store all data received and run at a later scheduled time.

When running data, the dog may be developed using a hardware independent model for running each motion instruction. Hardware independence allows each toy dog to be quickly and easily adapted for use with new hardware such as motors, motion controllers, and motion algorithms. As these components change over time (which they more than likely will as technology in this area advances) the same data will run on all versions of the toy. Optionally the language driver and register-map technologies may be employed in the embedded software used to implement the hardware independent motion. This further generifies the embedded software thus cutting down system development and future maintenance time and costs.

Each dog may also employ the secure-API technology to limit the max/min speed that each leg can swing, thus giving the dog's owner much better control over how it runs content. For example, the dog's owner may set the min and max velocity settings for each leg of the dog to a low speed so that the dog doesn't dance at a very high speed. When downloading a ‘fast’ moonwalk, the dog clips all velocities to those specified within the boundaries previously set by the user.

In another example, similar to that of the dancing dog, a set of mannequins may be configured to dance to the same data stream. For example, a life size model mannequin of Sonny and another of Cher may be configured to run a set of songs originally developed by the actual performers. Before running, the user configures the data stream to be sent to both mannequins and to synchronize with the server so that each mannequin appears to sing and dance in sync with one another.

Using hardware independent motion technologies, the same content could also run on a set of toy dolls causing the toys to dance in sync with one another and optionally dance in sync with the original two mannequins. This model allows the purchaser to try-before-they-buy each dance sequence from a store site. Hardware independence is a key element that makes this model work at a minimal cost for both toy and mannequin run the same data (in either stream or script form) yet their internal hardware is undoubtedly different. The internals of each device (toy and mannequin) are more than likely manufactured by different companies who use different electronic models.

A more advanced use of live-update and synchronization involves two devices that interact with one another using a sensor such as a motion or light sensor to determine which future scripts to run. For example, two wrestling dolls named Joe are configured to select content consisting of a set of wrestling moves, where each move is constructed as a script of packets that each containing move instructions (and or grunt sounds). While running their respective scripts containing different wrestling moves, each wrestling Joe periodically sends synchronization data packets to the other so that they wrestle in sync with one another.

While performing each wrestling move each Joe also receives input from their respective sensors. Receiving input from each sensor triggers the Joe (who's sensor was triggered) to perform a live-update requesting a new script containing a new wrestling move. Upon receiving the script, it is run thus giving the appearance that the Wrestling Joe has another move up his sleeve.

When downloading content each toy may optionally be programmed at the factory to only support a specific set of moves—the signature moves that pertain to the specific wrestling character. For example a Hulk Hogan doll would only download and run scripts selected from the Hulk Hogan wrestling scripts. Security Key Filtering is employed by the toy to force such a selection. Attempting to download and run other types of scripts (or even streams) fails if the toy is configured in this manner. This type of technology gives the doll a very interactive appearance and allows users to select one toy from another based on the set of wrestling moves that it is able to download from the content site.

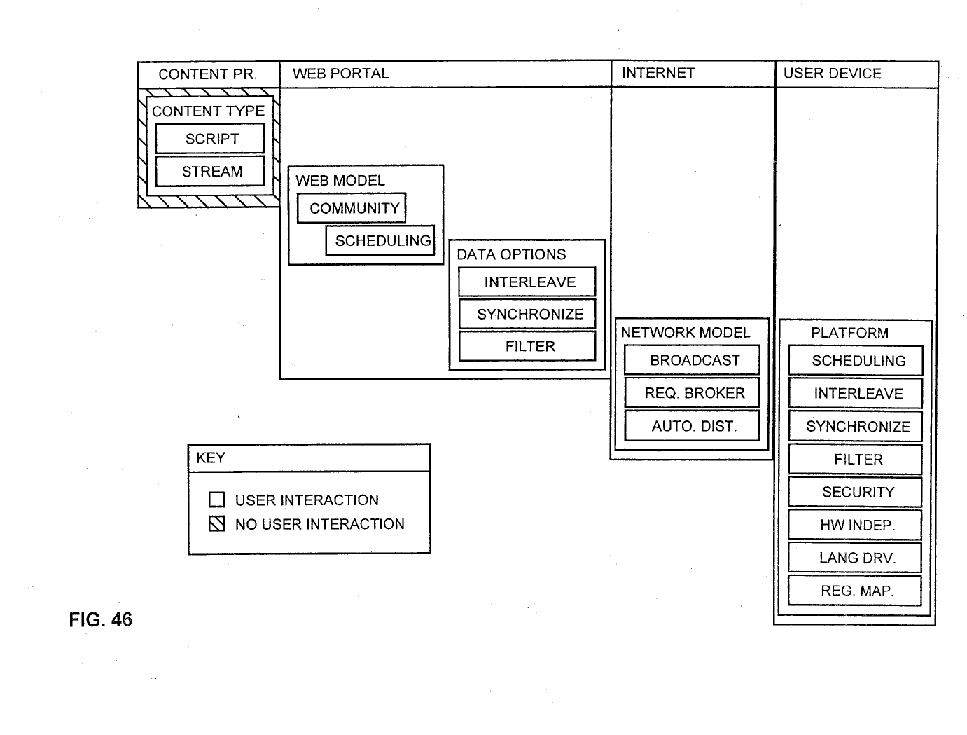

Referring now to FIG. 46, depicted therein is another exemplary configuration for distributing motion data using pre-fabricated applications. Pre-fabricated applications are similar to interactive applications, yet much of the content is pre-generated by the content provider. Unlike the interactive model, where content options are merged into content during the download process, pre-fabricated content has all (or most) options already merged into the data before the download. For example, an interleaved motion/audio data stream is mixed and stored persistently before download thus increasing the download processing time.

In the same light as the Interactive Applications, users still select content from either a community that contains a dynamic content list or a static list sitting on a web site (or other network site). Users may optionally schedule a point in time to download and play the content on their device. For example, a user might log into the content site's schedule calendar and go to the birthday of a friend who owns the same device player. On the specified day, per the scheduled request, the content site downloads any specified content to the target device player and initiates a play session. At the time the data is received the ‘listening’ device starts running the data, bringing the device to life—probably much to the surprise of its owner. Since pre-fabricated content is already pre-built, it is a natural fit for scheduled update sessions that are to run on devices other than the immediate user's device because there are fewer options for the device owner to select from.

One example in this context is a birthday jig example that involves a toy character able to run both motion and play audio sounds. With this particular character, a set of content streams have been pre-fabricated to cause the particular toy to perform certain gestures while it communicates thus giving the character the appearance of a personality. At the manufacturing site, a security key is embedded into a security data packet along with a general rating for the type of gestures. All motion data is mixed with audio sounds so that each gesture occurs in sync with the specific words spoken to the user. The toy also uses voice recognition to determine when to switch to (download and run) a new pre-fabricated script that relates to the interpreted response.

The toy owner visits the toy manufacture's web site and discovers that several discussions are available for running on their toy. A general rated birthday topic is chose and scheduled by the user. To schedule the content update, the user selects a time, day, month, and year in a calendar program located on the toy manufacture's web site. The conversation script (that includes motion gestures) is selected and specified to run when the event triggers.

On the time, day, month and year that the scheduled event occurs, the conversation content is downloaded to the target toy by the web-site, where the web-site starts a broadcast session with the particular toy's serial number embedded as a security key. Alternatively, when the user schedules the event, the website immediately sends data directly to the toy via a wireless network device that is connected to the Internet (i.e. a TCP/IP enabled BlueTooth device) thus programming the toy to ‘remember’ the time and date of the live-update event.

When the time on the scheduled date arrives either the content site starts broadcasting to the device (making sure to embed a security key into the data so that only the target device is able to play the data) or if the device is already pre-programmed to kick off a live-update, the device starts downloading data immediately from the content site and plays it once received.

Running the content conversation causes the toy to jump to life waving its hands and arms while proclaiming, “congratulations, it's your birthday!” and then singing a “happy birthday” song. Once the song completes, the devices enters into a getting to know you conversation. During the conversation, the device asks a certain question and waits for a response from the user. Upon hearing the response, the device uses voice recognition to map the response into one of many target new response scripts to run. If the new response script is not already downloaded the device triggers another live-update session requesting the new target script from the content site. The new script is run once received or if already downloaded it is run immediately. Running the new script produces a new question along with gesture moves.

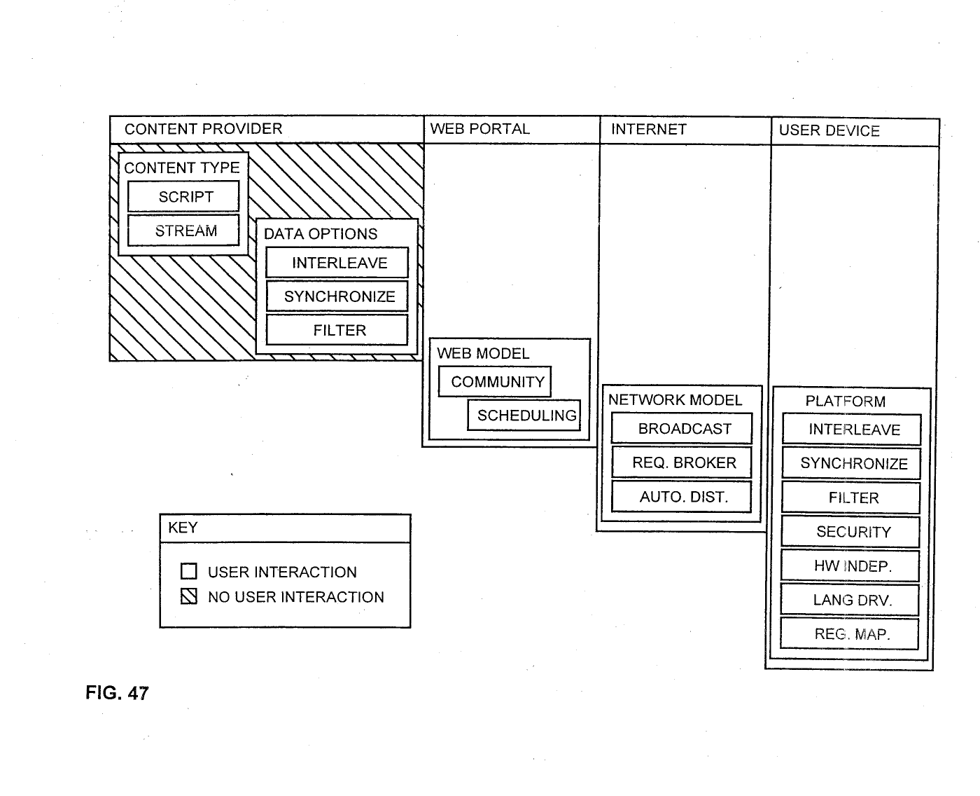

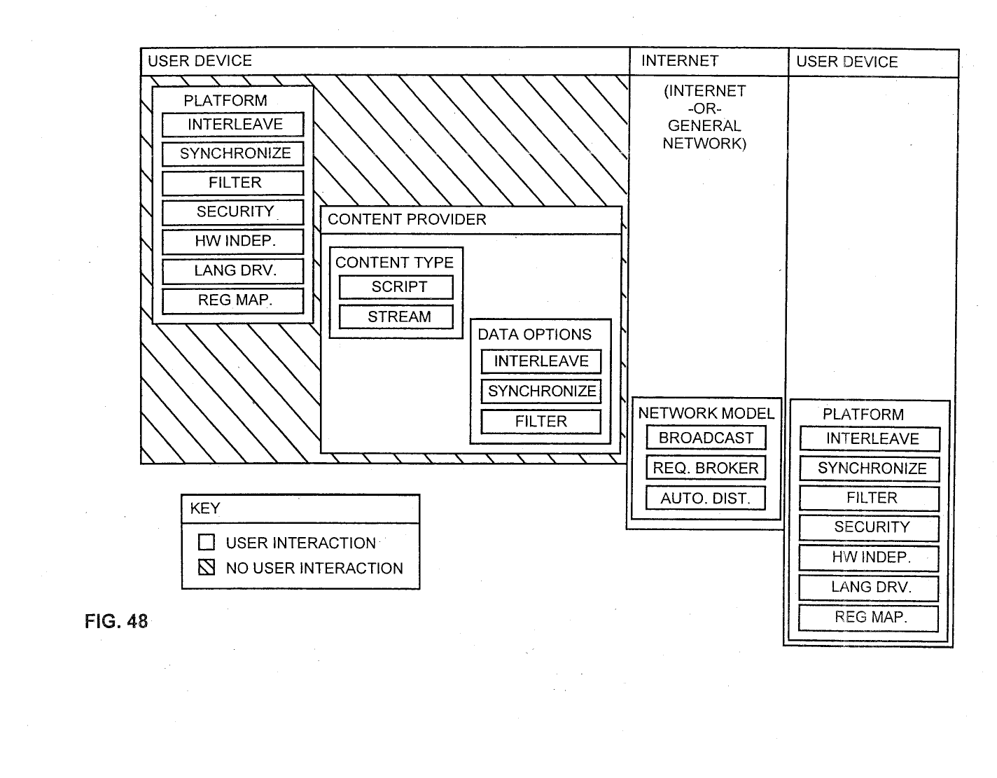

Referring now to FIG. 47, depicted therein is yet another exemplary configuration for distributing motion data over a computer network using what will be referred to as autonomous applications. Autonomous applications involve a similar set of technologies as the interactive applications except that the device itself generates the content and sends it to either a web site (such as a community site) or another device.

The device to web model is similar to the interactive application in reverse. The device generates the motion (and even audio) data by recording its moves or calculating new moves based off its moves or off its existing content data (if any). When generating more rich content motion data is mixed with other media types, such as audio recorded by the device. If programmed to do so, the device also adds synchronization, content filter and security data packets into the data that it generates. Content is then sent whole (as a script) or broadcast continuously (as a stream) to other ‘listening’ devices. Each listening device can then run the new data thus ‘learning’ from the original device.

As an example, the owner of a fight character might train in a particular fight move using a joystick to control the character in real-time. While moving the character, the internal embedded software on the device would ‘record’ each move by storing the position, current velocity and possibly the current acceleration occurring on each of the axes of motion on the character. Once completely recorded, the toy uploads the new content to another toy thus immediately training the other toy.

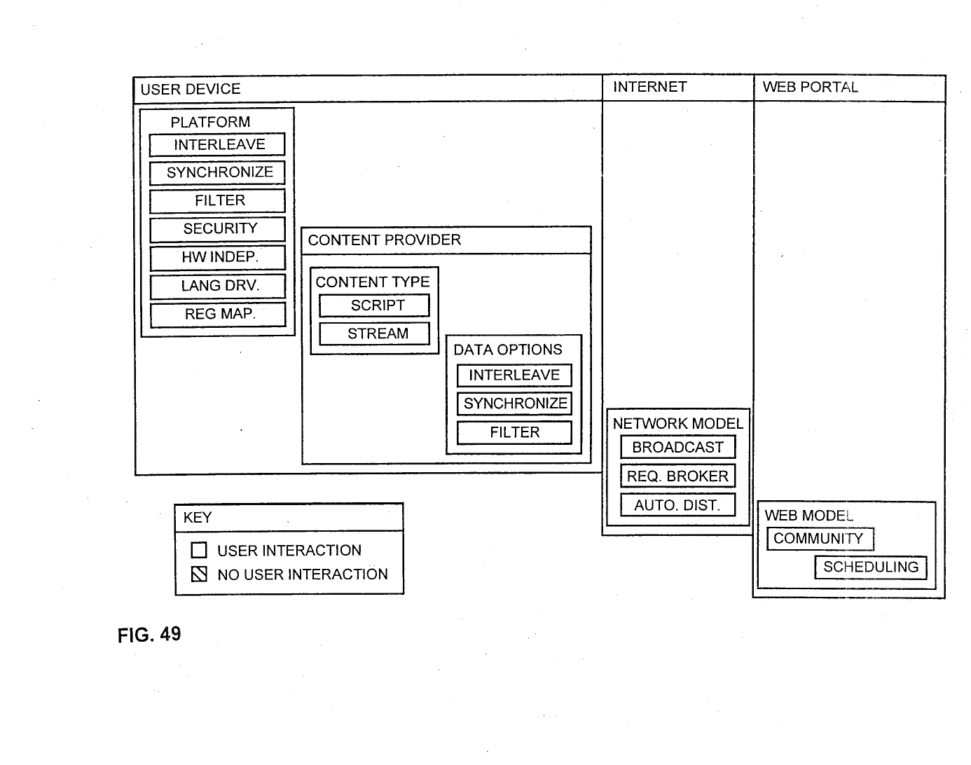

Referring to FIG. 49, the device to web model is graphically represented therein. The device to web model is very similar to the device-to-device model except that the content created by the device is sent to a pre-programmed target web site and stored for use by others. More than likely, the target site is a community site that allows user to share created content.

Using the device-to-web model, a trained toy uploads data to a pre-programmed web site for other's to download and use at a later time.

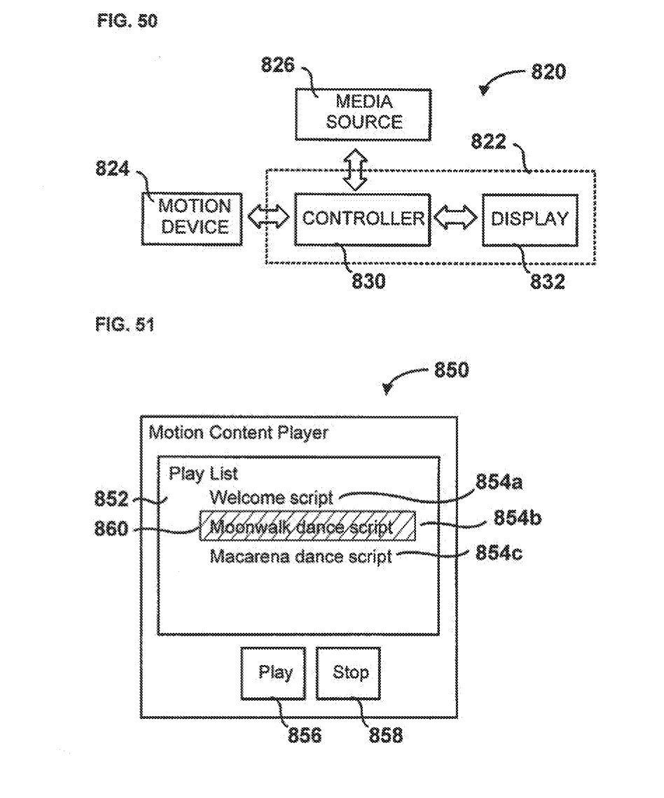

Referring initially to FIG. 50, depicted therein is another example motion system 820 implementing the principles of the present invention. The motion system 820 comprises a control system 822, a motion device 824, and a media source 826 of motion data for operating the motion device 824. The control system 822 comprises a processing device 830 and a display 832.

The processing device 830 receives motion data from the media source 826 and transfers this motion data to the motion device 824. The processing device 830 further generates a user interface on the display 832 for allowing the user to select motion data and control the transfer of motion data to the motion device 824.

The processing device 830 is any general purpose or dedicated processor capable of running a software program that performs the functions recited below. Typically, the processing device 830 will be a general purpose computing platform, hand-held device, cell-phone, or the like separate from the motion device 824 or a microcontroller integrated within the motion device 824.

The display 832 may be housed separately from the processing device 830 or may be integrated with the processing device 830. As such, the display 832 may also be housed within the motion device 824 or separate there from.

The processing device 830, motion device 824, and media source 826 are all connected such that motion data can be transmitted there between. The connection between these components 830, 824, and 826 can be permanent, such as when these components are all contained within a single housing, or these components 830, 824, and 826 can be disconnected in many implementations. The processing device 830 and display 832 can also be disconnected from each other in some implementations, but will often be permanently connected.

One common implementation of the present invention would be to connect the control system 822 to the media source 826 over a network such as the internet. In this case, the processing device 830 will typically run a browser that allows motion data to be downloaded from a motion data server functioning as the media source 826. The processing device 830 will typically be a personal computer or hand-held computing device such as a Game Boy or Palm Pilot that is connected to the motion device 824 using a link cable or the like. The motion device 824 will typically be a toy such as a doll or robot but can be any programmable motion device that operates under control of motion data.

The media source 826 will typically contain a library of scripts that organize the motion data into motion sequences. The scripts are identified by names that uniquely identify the scripts; the names will often be associated with the motion sequence. The operator of the control system 822 selects and downloads a desired motion sequence or number of desired motion sequences by selecting the name or names of these motion sequences. The motion system 820 may incorporate a system for generating and distributing motion commands over a distributed network such as is described in co-pending U.S. patent application Ser. No. 09/790,401 filed on Feb. 21, 2001, and commonly assigned with the present application; the contents of the application filed on Feb. 21, 2001, are incorporated herein by reference.

The motion data contained in the scripts may comprise one or more control commands that are specific to a given type or brand of motion device. Alternatively, the motion data may be hardware independent instructions that are converted at the processing device 830 into control commands specific the particular motion device or devices to which the processing device 830 is connected. The system 820 may incorporate a control command generating system such as that described in U.S. Pat. No. 5,691,897 owned by the Assignee of the present invention into one or both of the media source 826 and/or processing device 830 to allow the use of hardware independent application programs that define the motion sequences. The contents of the '897 patent are incorporated herein by reference.

At least one motion script is stored locally at the processing device 30, and typically a number of scripts are stored locally at the processing device 830. The characteristics of the particular processing device 830 will determine the number of scripts that may be stored locally.

As generally discussed above, the logic employed by the present invention will typically be embodied as a software program running on the processing device 830. The software program generates a user interface that allows the user to select a script to operate on the motion device 824 and to control how the script runs on the motion device 824.

A number of exemplary user interfaces generated by the processing device 830 will now be discussed with reference to FIGS. 51-55.

A first exemplary user interface depicted at 850 in FIG. 51 comprises a play list 852 listing a plurality of play script items 854a-c from which the user can select. The exemplary interface 850 further comprises a play button 856, a stop button 858, and, optionally, a current play indicator 860. In this first exemplary interface 850, the play list 852 is loaded by opening a file, or downloading the play-list from a network (or Internet) site. Once loaded, selecting the Play button 856 runs all items 854 in the play list 852. Selecting the Stop button 858 causes the play session to stop (thus stopping all motion and/or motion programs from running) and returns the current play position to the beginning of the list 852.

The play list 852 is typically implemented using a software element such as a List box, List view, List control, Tree view, or custom list type. The play list 852 may appear on a main window or in a dialog that is displayed after the user selects a button or menu item. The Play List 852 contains and identifies, in the form of a list of the play script items 854, all motion content that will actually play on the target motion device 854.

The play button 856 is typically implemented using a software element such as a Menu item, button, graphic with hot spot, or other hyper-link type jump. The Play button 856 is selected using voice, touch, keyboard, or other input device. Selecting the Play button 856 causes the processing device 830 to cause the motion device 824 to begin running the script or scripts listed as play script items 854 in the Play List 852. Because the script(s) contains or package motion data or instructions, running the script(s) causes the target motion device 824 to move in the motion sequence associated with the script item(s) 854 in the play list 852. In the exemplary interface 850, the script item 854a at the start of the Play List is first run, after which any other play script items 854 in the play list are run in sequence.

The current play indicator 860 is a visible, audible, tactile, or other indication identifying which of the play script items 854 in the play list 852 is currently running; in the exemplary interface 850, the current play indicator 860 is implemented by highlighting the background of the script item 854 currently being played.

The stop button 858 is also typically implemented using a software element such as a Menu item, button, graphic with hot spot, or other hyper-link type jump and may be selected in the same manner as the play button 856. Selecting the Stop button 858 causes the processing device 830 to stop running the script item 854 currently playing, thereby stopping all motion on the target device 824. The position of the current play indicator 860 position is typically moved to the first script item 844 in the Play List 852 after the stop button 858 is selected.

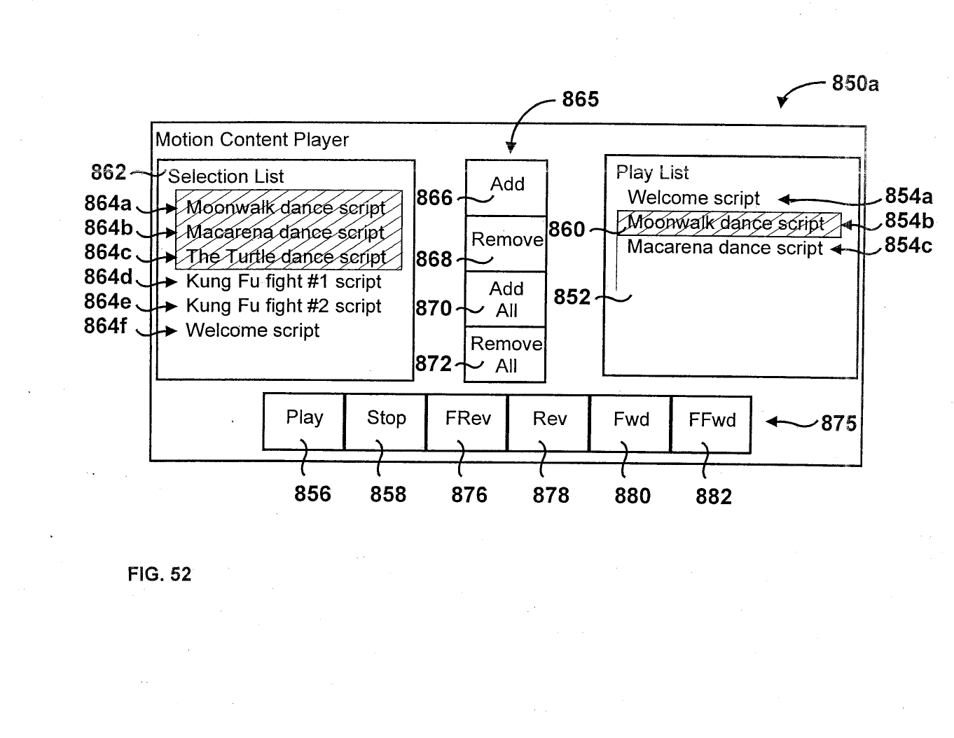

Referring now to FIG. 52, depicted therein is yet another user interface 850a that may be generated by the software running on the processing device 830. Like the user interface 850 described above, the user interface 850a comprises a play list 852 listing a plurality of play script items 854a-c, a play button 856, a stop button 858, and, optionally, a current play indicator 60. These interface components 852, 854, 856, 858, and 860 were discussed above with reference to the user interface 850 and will be described again below only to the extent necessary for a complete understanding of the interface 850a.

The interface 850a is more full-featured than the interface 850 and uses both the Selection List 862 and the Play List 852. Using the Add, Add All, Remove and Remove All buttons the user can easily move items from the Selection List over to the Play List or remove items from the Play List to create the selections of content items that are to be run. Using the content play controls, the user is able to control how the content is run by the player. Selecting Play causes the content to start playing (i.e. the end device begins moving as specified by the instructions (or data) making up the content. Selecting Stop halts any content that is currently running. And FRev, Rev, Fwd, FFwd are used to change the position where content is played.

The user interface 850a further comprises a selection list 862 that contains a plurality of selection script items 864a-f. The selection script items 864 are a superset of script items from which the play script items 54 may be selected.

Play script items 854 are added to and removed from the play list 852 using one of a plurality of content edit controls 865 comprising an add button 866, a remove button 868, an add all button 870, and/or a remove all button 872. These buttons 866-872 are typically implemented using a software element such as a Menu item, button, graphic with hot spot, or other hyper-link type jump and selected using a voice, touch, keyboard, or other input device.

Selecting the Add button 866 causes a selected selection item 864 in the Selection List 862 to be copied into the Play List 852. The selected item 864 in the selection list 862 may be chosen using voice, touch, keyboard, or other input device and is typically identified by a selection indicator 874 that is or may be similar to the play indicator 860. One or more selection items 864 may be selected and the selection indicator 874 will indicate if a plurality of items 864 have been chosen.

Selecting the Remove button 868 causes the selected item in the Play List 852 to be removed from the Play List 852. Selecting the Add All button 870 causes all items in the Selection List 862 to be copied into the Play List 852. Selecting the Remove All button 872 causes all items in the Play List 852 to be removed.

The interface 850b further comprises a plurality of content play controls 875 comprising a Frev button 876, a Rev button 878, a Fwd button 880, and a FFwd button 882. These buttons 876-882 are also typically implemented using a software element such as a Menu item, button, graphic with hot spot, or other hyper-link type jump and selected using a voice, touch, keyboard, or other input device. The content play controls 875 control the transfer of motion data from the processing device 830 to the target motion device 824 and thus allows the user more complete control of the desired movement of the motion device 824.

Selecting the FRev button 876 moves the current play position in the reverse direction at a fast pace through the content embodied in the play script item 854 identified by the current play indicator 860. When the end of the identified script item 854 is reached, further selection of the FRev 876 button will cause the current play indicator 860 to move to the next script item 854 in the play list 852. Depending upon the capabilities of the motion device 824, the motion device 824 may move at a higher rate of speed when the FRev button 876 is selected or may simply skip or pass over a portion of the motion data contained in the play script item 854 currently being played.

Selecting the Rev button 878 moves the current play position in the reverse direction at a slow pace or in a single step where each instruction (or data element) in the play script item 854 currently being played is stepped in the reverse direction. Selecting the Fwd button 880 moves the current play position in the forward direction at a slow pace or in a single step where each instruction (or data element) in the play script item 854 currently being played is stepped in the reverse direction. Selecting the FFwd button 882 causes an action similar to the selection of the FRev button 876 but in the forward direction.

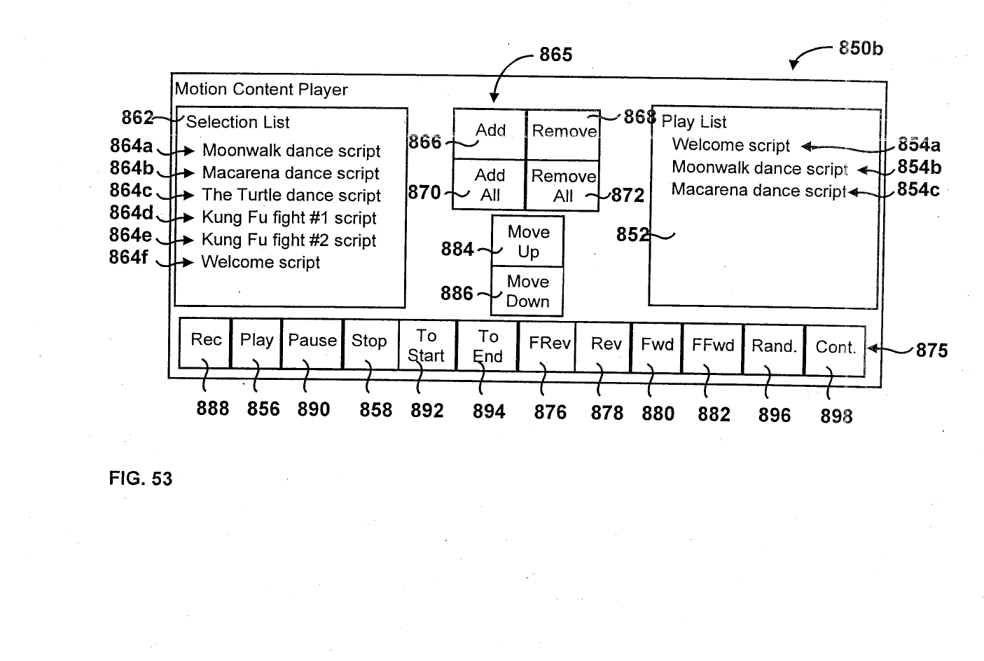

Referring now to FIG. 53, depicted therein is yet another user interface 850b that may be generated by the software running on the processing device 830. Like the user interfaces 850 and 850a described above, the user interface 850b comprises a play list 852 listing a plurality of play script items 854a-c, a play button 856, a stop button 858, and, optionally, a current play indicator 860. Like the interface 850a described above, the interface 850b comprises content edit controls 865 comprising buttons 866-872 and content play controls 875 comprising buttons 876-882. These interface components 852-882 were discussed above with reference to the user interfaces 850 and 850a and will be described again below only to the extent necessary for a complete understanding of the interface 850b.

Like the interface 850a, the interface 850b uses both the Selection and Play Lists. In addition, the Add, Add All, Remove and Remove All controls are used as well. Two new controls, used for editing the play list, are added to this layout: the Move Up and Move Down controls. The Move Up control moves the currently selected item in the play list to the previous position in the list, whereas the Move Down control moves the currently selected item to the next position in the play list. These controls allow the user to more precisely set-up their play lists before running them on the target device.

In addition to the Play, Stop, FRev, Rev, Fwd and FFwd controls used to play the content, six new controls have been added to this layout.

The Rec, Pause, To Start, To End, Rand. and Cont. buttons are new to this layout. Selecting the Rec button causes the player to direct the target to start recording each move and/or other move related data (such as axis position, velocity, acceleration, etc.) Selecting the Pause button causes any currently running content to stop running yet remember the current play position. Selecting Play after selecting Pause causes the player to start playing at the play position where it was last stopped. To Start and To End move the current play position to either the start or end of all items in the content list respectively. Selecting Rand directs the player to randomly select items from the Play List to run on the target device. Selecting Cont causes the player to continuously run through the Play List. Once the last item in the list completes, the first item starts running and this process repeats until continuous mode is turned off. If both Cont and Rand are selected the player continuously selects at random each item from the play lists and plays each. When running with Rand selected and Cont not selected, each item is randomly selected from the Play List and played until all items in the list have played.

The content edit controls 865 of the exemplary interface 850b further comprise a Move Up button 884 and a Move Down button 886 that may be implemented and selected in a manner similar to any of the other buttons comprising the interface 850b. Selecting the Move Up button 884 causes the current item 854 selected in the Play List 852 to move up one position in the list 852. Selecting the Move Down button 886 causes the current item 854 selected in the Play List 852 to move down one position in the list 852.

The content play controls 875 of the exemplary interface 850b further comprise a Rec button 888, a Pause button 890, a To Start button 892, a To End button 894, a Rand. button 896, and a Cont. button 898. Selecting the Rec button 88 causes the processing device 830 to begin recording content from the target device 824 by recording motion instructions and/or data into a script that can then be replayed at a later time.

Selecting the Pause button causes the processing device 830 to stop running content and store the current position in the script (or stream). Subsequent selection of the Play button 856 will continue running the content at the stored position in the script.

Selecting the To Start button 892 moves the current play position to the start of the first item 854 in the Play List 852. Selecting the To End button 894 moves the current play position to the end of the last item 854 in the Play List 852.

Selecting the Rand. button 896 causes the processing device 830 to enter a random selection mode. When running in the random selection mode, play script items 854 are selected at random from the Play List 852 and played until all of the items 854 have been played.

Selecting the Cont. button 898 causes the processing device 830 to enter a continuous run mode. When running in continuous run mode and the last item 854 in the Play List 852 is played, the current play position is reset to the beginning of the Play List 852 and all content in the list 852 is run again. This process repeats until continuous mode is turned off. If random mode is enabled when the Cont. button 898 is selected, play script items 854 are continuously selected at random and run until continuous mode is turned off.

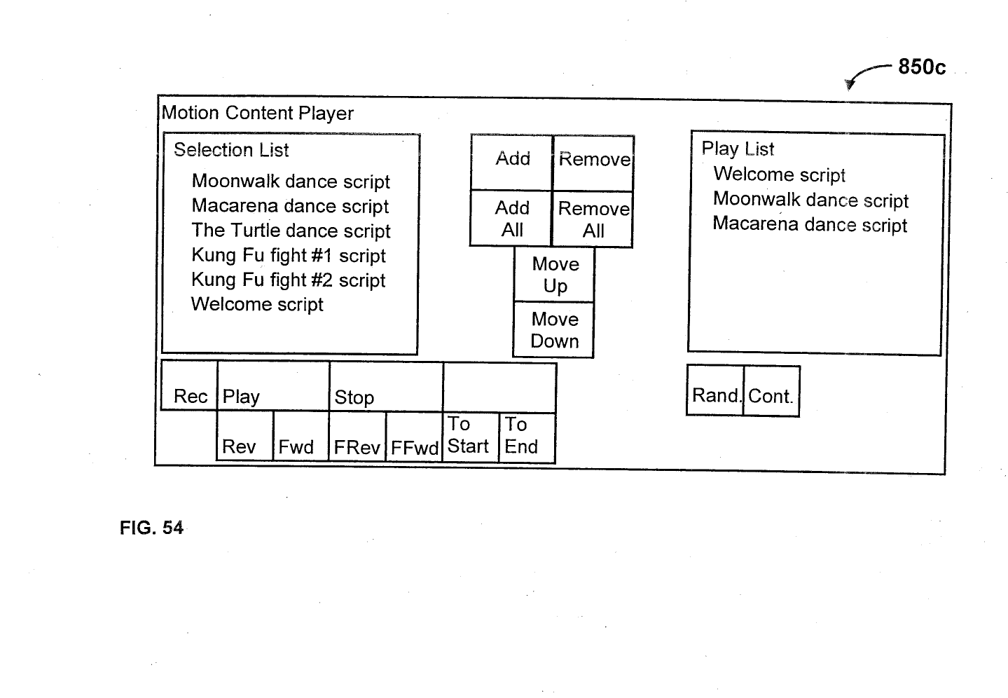

Referring now to FIG. 54, depicted therein is yet another exemplary interface 850c that is similar to the interface 850b described above but the control buttons have been rearranged in a different configuration that may be preferable under some circumstances.

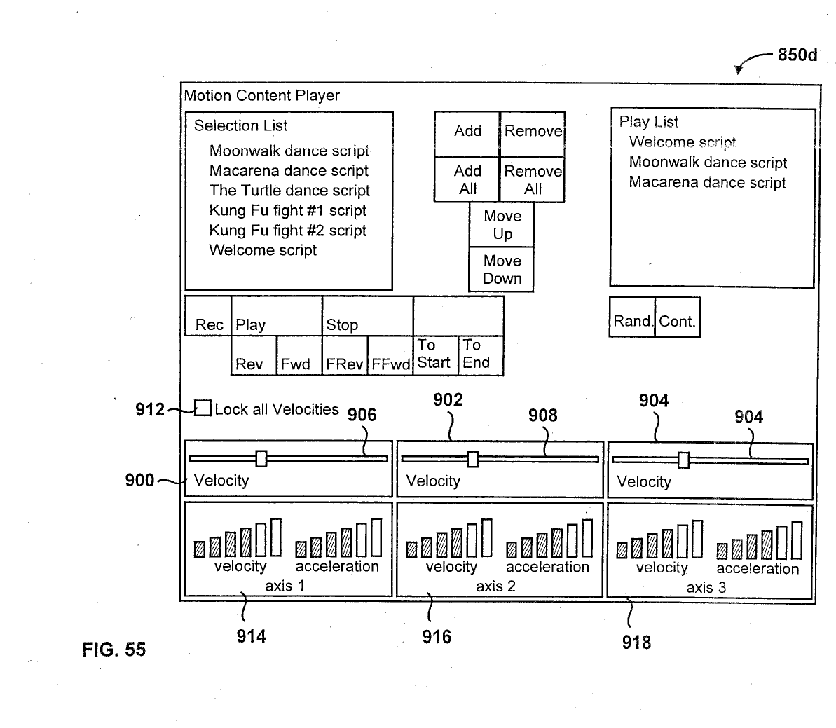

Referring now to FIG. 55, depicted therein is yet another exemplary interface 850d that is similar to the interface 850b described above but further comprises several additional controls 900, 902, and 904 at the bottom thereof. These controls 900, 902, and 904 comprise sliders 906, 908, and 910 that are used to change attributes associated with the content that is run from the Play List 852. Velocity controls are provided to alter the velocity of a specific axis of motion or even all axes at the same time.

Instead of using single controls for each axis, a single master velocity control may also be used to control the velocity on all axes at the same time, thus speeding up or slowing down the current item being played from the play list. Another way of achieving the same ends is with the use of a velocity lock control 912. When selected all velocity controls move in sync with one another regardless of which one the user moves.

Below the velocity controls are the status controls 914, 916, and 918 that display useful information for each axis of motion. For example, status controls may be used to graphically depict the current velocity, acceleration, deceleration, position, or any other motion related property occurring on each axis.

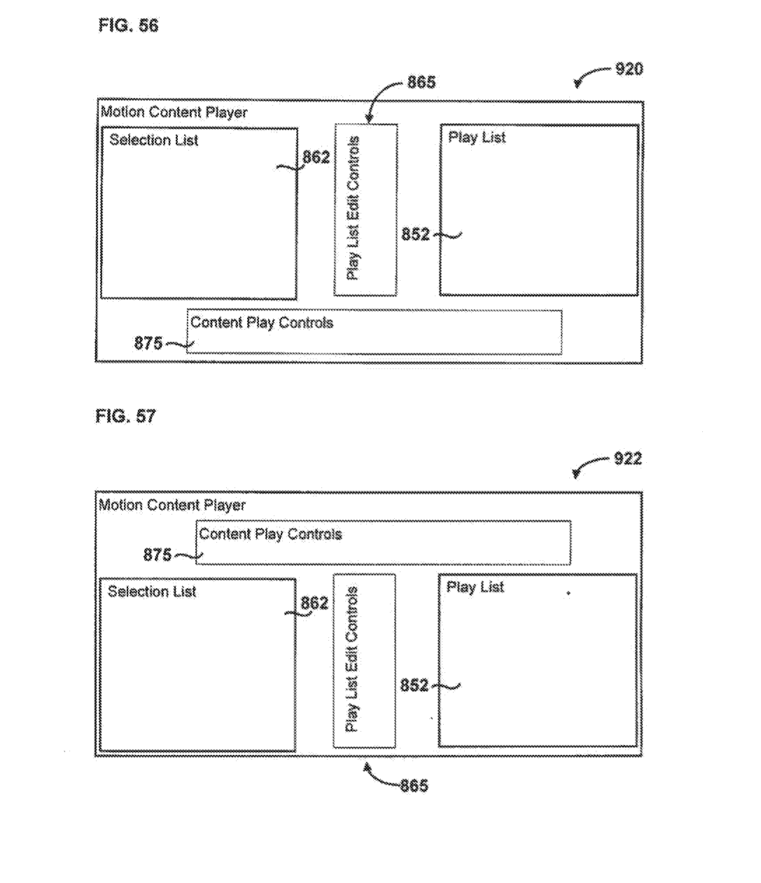

Referring now to FIGS. 56-65, somewhat schematically depicted therein are interface layouts 920, 922, 924, 926, 928, 930, 932, 934, 936, and 938. Each of these layouts 920-938 comprises a selection list 862, a play list 852, play list edit controls 865, and content play controls 875 as described above. The exact content and format of these lists 862 and 852 and controls 865 and 875 may vary from implementation to implementation.

The layout 920 of FIG. 56 corresponds to the layouts of the interface 850a described above.

The layout 922 of FIG. 57 arranges the Play List Controls 865 on top.

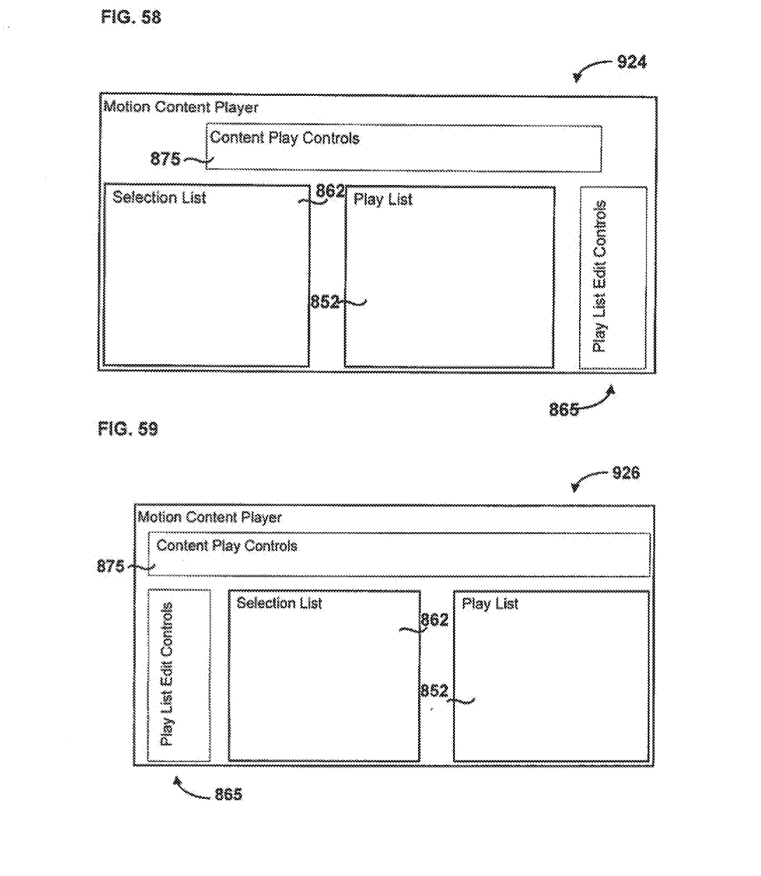

The layout 924 of FIG. 58 arranges the play list controls 865 to the right and the content play controls on top.

The layout 926 of FIG. 59 arranges the Play Controls 875 on Top and the Edit Controls to the left.

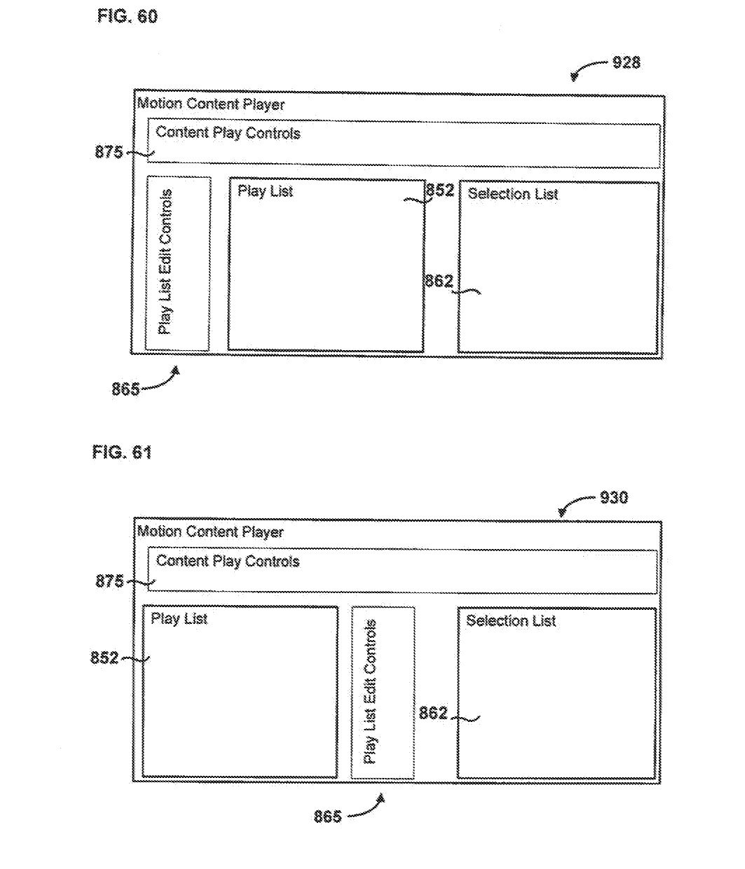

The layout 928 of FIG. 60 arranges the Play Controls 875 on Top and the Edit Controls 865 to the Left, with the positions of the Play List 852 and Selection Lists 862 reversed.

The layout 930 of FIG. 61 arranges the play controls 875 on top, the play list 852 at left, and the selection list 862 at right.

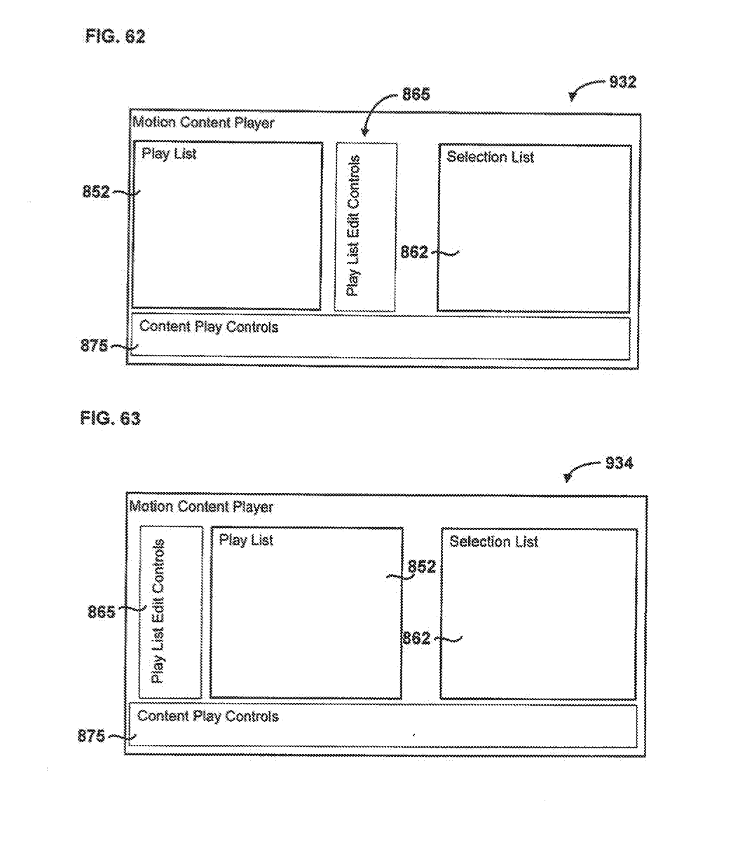

The layout 932 of FIG. 62 arranges the Play Controls 875 on the bottom, the Play List 852 on the left, and the Selection List 862 on the right.

The layout 934 of FIG. 63 arranges the Play Controls 875 on the bottom, the Edit Controls 865 on Left, the Play List 852 next, and the Selection List 862 on the right.

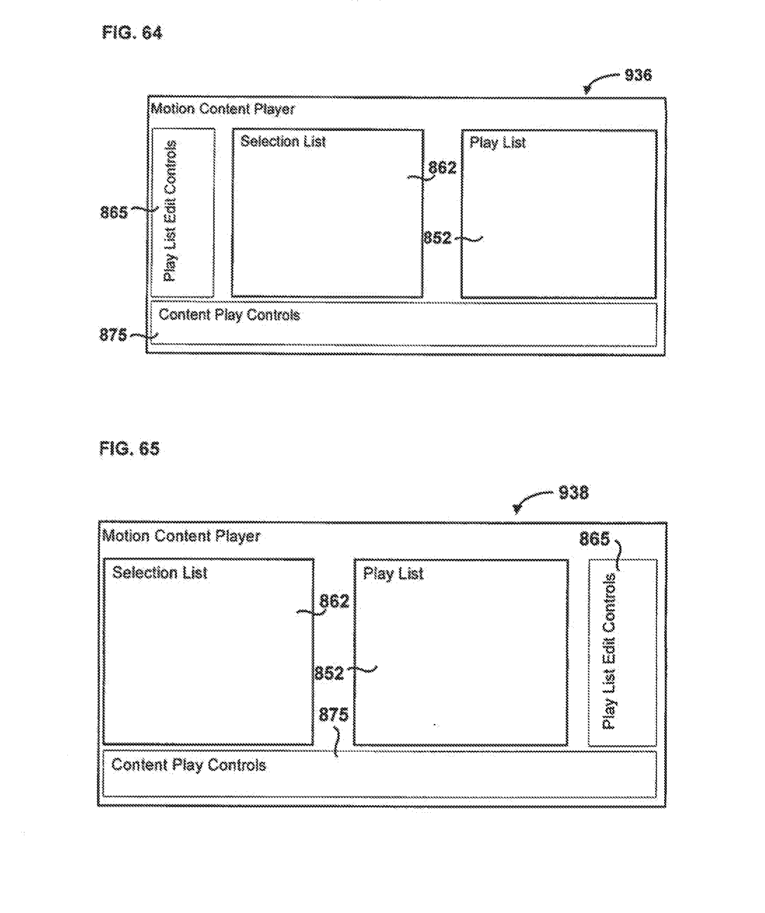

The layout 936 of FIG. 64 arranges the Play Controls 875 on the bottom, the Edit Controls 865 on the left, the Selection List 862 next, and the Play List 852 on the right.

The layout 938 of FIG. 65 arranges the Play Controls 875 on the bottom, the Selection List 862 on the left, then the Play List 852, and the Edit Controls 865 on the right.

These examples have been provided to show that as long as the controls provided all support a common functionality their general layout does not change the overall player's functionality other than making the application more or less intuitive (and or easier) to use. Certain of these layouts may be preferred, however, depending on a particular set of circumstances.

What is claimed is:

1. A motion system for allowing a person to cause a desired motion operation to be performed by at least one of first and second motion machines capable of performing motion sequences, where the first motion machine performs motion sequences using a first configuration of motion hardware using a first electronic model and the second motion machine performs motion sequences using a second configuration of motion hardware using a second electronic model, where the first and second electronic models are different, comprising:
a network;
a speech to text converter that generates a digital representation of a spoken motion message spoken by the person;
a message protocol generator that generates a hardware-independent digital motion command based on the digital representation of the spoken motion message, generates an instant message including the hardware-independent digital motion command, and causes the instant message including the hardware-independent digital motion command to be transmitted over the network;
an instant message receiver that receives over the network the instant message including the hardware-independent digital motion command generated by the message protocol generator; and
a motion services system operatively connected to the instant messenger receiver, where the motion services system causes at least one of the first and second motion machines to perform the desired motion operation based on the at least one hardware-independent digital motion command of the instant message received by the instant message receiver by mapping the hardware-independent digital motion command transmitted from the instant message receiver to at least one of at least one machine motion command appropriate for the first electronic model of the first configuration of motion hardware used by the first motion machine, and
at least one machine motion command appropriate for the second electronic model of the second configuration of motion hardware used by the second motion machine.

2. A motion system as recited in claim 1, in which digital representation generated by the speech to text converter is in a binary format.

3. A motion system as recited in claim 2, in which the binary format is at least one of ASCII text and XML.

4. A motion system as recited in claim 1, in which the motion services system determines whether the hardware-independent digital motion command transmitted by the instant message receiver is associated with movement and, if the hardware-independent digital motion command received by the instant message receiver is not associated with movement, does not cause the motion machine to move.

5. A motion system as recited in claim 1, in which the motion machine is an industrial motion machine.

6. A motion system as recited in claim 1, in which the desired motion operation performed by the motion machine causes results in movement of an object.

7. A motion system as recited in claim 1, in which the desired motion operation alters a state of the motion machine.

8. A motion system as recited in claim 1, in which the desired motion operation causes the motion machine to generate status data indicative of a state of the motion machine.

9. A motion system as recited in claim 1, in which the motion services system forms a part of the instant message receiver.

10. A motion system as recited in claim 1, in which the motion services system forms a part of the motion machine.

11. A motion system as recited in claim 1, in which the instant message receiver and the motion services system form a part of the motion machine.

12. A method of allowing a person to cause a desired motion operation to be performed by at least one of first and second motion machines capable of performing motion sequences, where the first motion machine performs motion sequences using a first configuration of motion hardware using a first electronic model and the second motion machine performs motion sequences using a second configuration of motion hardware using a second electronic model, where the first and second electronic models are different, comprising the steps of:
generating a digital representation of a spoken motion message spoken by the person;
generating a hardware-independent digital motion command based on the digital representation of the spoken motion message;
generating an instant message including the hardware-independent digital motion command;
transmitting the instant message containing the hardware-independent digital motion command over a network;
receiving the instant message containing the hardware-independent digital motion command over the network;
mapping the hardware-independent digital motion command contained by the instant message received over the network to at least one of
at least one machine motion command appropriate for the first electronic model of the first configuration of motion hardware used by the first motion machine, and
at least one machine motion command appropriate for the second electronic model of the second configuration of motion hardware used by the second motion machine; and
causing at least one of the first motion machine and the second motion machine to perform the desired motion operation based on the at least one machine motion command.

13. A method as recited in claim 12, further comprising the step of determining whether the hardware-independent digital motion command is associated with movement.

14. A method as recited in claim 12 in which performance of the desired motion operation results in movement of an object.

15. A method as recited in claim 12, in which performance of the desired motion operation alters a state of the motion machine.

16. A method as recited in claim 12, in which performance of the desired motion operation causes the motion machine to generate status data indicative of a state of the motion machine.
